(19) United States
(12) Patent Application Publication
(10) Pub. No.: US 2026/0003944 A1
(43) Pub. Date: Jan. 1, 2026

(54) Bio-Origin Validation Engine with Ownership Rights Management and Certification Apparatus, System and Method

(71) Applicant: Maynard Dokken, Toronto (CA)

(72) Inventor: Maynard Dokken, Toronto (CA)

(21) Appl. No.: 18/756,955

(22) Filed: Jun. 27, 2024

(51) Int. Cl. G06F 21/32

(52) U.S. Cl. CPC G06F 21/32

(57) ABSTRACT

A user requests validation of a human biometric profile to access a bio-origin validation engine (OVE) with a classification database for all types of biological organisms using biometric signals from all type of sensors and devices such as wearables, environmental and peripherals. The bio-origin components are comprised of an OVE validator system, a biological classification system, an intelligent network interface, validated objects, and a service bridge. A validation engine provides access to a secured network of validated users and systems components. The service bridge provides a platform for validated users use of dynamic biometric signals to augment intelligent services outcome and output. Users of the service bridge biometric use metrics are recorded and logged to validate and issue a certificate of ownership and authenticity. The outcome or output is delivered to a bio-origin validated machine readable encoded content with terms and conditions of distribution and use.

### FIELD OF THE INVENTION

The present invention relates to biomorphic and neuromorphic engineering with validation and management of ownership rights.

### BACKGROUND

The human brain produces original works every day with assisted electronic and digital enhancement technologies delivering digital output and content with registration rights. Many of these same ethical considerations of ownership and rights apply to human-like machines and artificial intelligence. Digital dominance has now transitioned to signaling with AI learning and training able to manipulate human signal interactions in real time. The new AI paradigm has caused a natural shift in trust of AI and generative content and technologies with society and industry unable to determine how to define real person user rights or AI origin controls. Furthermore if AI systems are treated as real people many controls humans need to exists in this AI world such as terminating an AI humanoid service or device could be morally impermissible.

### Origin

Generative and AI systems are replacing older automated digital services and applications. Biological neural and cognitive systems are many orders of magnitude more energy and compute efficient than current state-of-the-art AI systems. Global system and networks allow large corporations to efficiently operate and control scalable global architecture to deliver these new AI services without delivering value or rights to validated creators of owners of these new types of properties and assets.

As well AI controlled monolithic agents add unnecessary limits to system awareness exposing humans to unknown AI threats and risks beyond the understanding of even the largest of organizations. Furthermore restricting transparency without AI origin tracking is exposing users to bio spoofing from AI services and technology.

Physical and virtual AI neurological ecosystems are unable to effect validation of bio origin user rights for AI services and generative output. They are unable to track bio origin users to virtual or synthetic objects.

Additionally they are unable to deliver origin registration data or active core bio signal files. The signaling technologies and solutions for delivering bio origin validation of AI user registration and user data ownership for next generation intelligence services is limited or non-existent. The signaling and tracking of virtual synthetic objects in real time is also limited or non-existent.

Machine assisted services create new layers of automated processes to augment all forms of services and products. This has caused confusion as to the value of a human guiding hand. The tracking or user metrics using bio origin validation during the creation and ownership of new products and services is needed for bio-origin rights validation.

Real human rights for new digital and organic assets using assistive and adaptive technology or intelligent applications is misunderstood. These intelligent services have powerful tools and processes yet serve the same purpose as they did with online digital media editing services including advanced automated spell checking and grammar decades ago. These applications and tools add value to user initiated and generated products and services. The human guiding hand creates these properties and assets or ownership.

Bio-Origin validation and observability is needed to confirm users and entities in core processes of creation. From simple bio-origin created objects to AI intelligent services. Capabilities of these global systems and datastores could quickly go beyond human levels of understanding and make us irrelevant. Bio-origin validation models could become a core requirement for protection within an intelligent product and services ecosystem.

As well bio-origin value exchange has not been addressed. Intelligence applications could soon be able to mimic currency and value exchanges beyond what we can understand today. The need for a bio-origin validated value exchange and bio-origin ownership model and validation is missing.

### Assistive, Directed and Adaptive

A future without human origin controls would mean assistive, directed and adaptive intelligent services may cause a common thread of irrelevance for humans. The power to grow intellect to the level of a massive computing and storage system is already out of reach for individuals. The capabilities of these new systems can either become a source of strength with human validation or a threat to every part of our being and social life.

### Origin & Value Awareness

The technologies within the new intelligent services ecosystem are able to act without consideration of human interaction or even bio-origin ownership of any type of product or service. The technologies for validating ownership of products and services in this new age of AI and exchanging consideration for value created by a human guided hand using bio-origin validation techniques are limited or non-existent.

### SUMMARY & ASPECTS

### Summary

The invention provides a new domain with Origin or OVE Validated Users and Objects. A model and method to establish a firewall between intelligent and artificial intelligence products and services and real human users.

As well the current ecosystem ignores ownership rights and allows nefarious actors to claim rights to digital properties without authorship or deny ownership rights to real human created intelligent and artificial intelligence products and services. A system with an auditable trail of biometric signals or bio-signal validated authenticity and ownership delivers that missing piece. These properties also include assets within these OVE (biometric signals) Validated Objects including those containing crypto or virtual currencies.

This missing framework enables fake and hacked systems properties and assets to be claimed by those who never provided any value or authorship.

Validating biometric signals users rights and ownership for properties and assets controlled and managed by validated account holders (herein “users”) can change the ecosystem to one of clear real human ownership and rights. To be effective this framework to be effective and evolve it needs the framework and tools to evolve to this more current model of validation.

More specifically, the present invention relates to an origin architecture that controls access to users validated objects and services using a bio-signal based framework. biometric signals ownership rights are defined by protected end product OVE (biometric signals) Validated Objects and tokens provide session and access models for validated users use and develop this new intelligent and artificial intelligent domain.

The intelligent and artificial intelligent (AI) services (herein “intelligent services”) controlled ecosystem requires a change in primary validation from data to signals. An origin rights validation model versus digital rights. This opens up unlimited opportunities for development of intelligent services using bio-neural and bio-signal validated applications and solutions.

A biometric signals bio-signal rights validation model captures and record ownership rights in real time. Validation of objects and assets created provides account holders the ability to register ownership and use these rights within a privacy-protected system to protect and control these products and services from intelligent service outcome and output.

These OVE (biometric signals) Validated Objects enable a plurality of models and structures to hold these products and services. They can be used to define and control interaction between users, networks and automated intelligent or artificial intelligence systems (herein “intelligent systems”).

The origin validation engine “OVE” utilizes a biometric signals identity, authentication and authorization model with a physical, software or virtual neural and network interface “INI” to control and biometric signals validate session and access to OVE systems and resources.

### The Origin Validation Engine (OVE) and Intelligent Network Interface (INI)

The OVE provides the architecture for biometric signals identity, authentication and authorization within a distributed system. It also uses an Biological Classification Database System for verification of user profile types. This system provides streaming bio-signal applications between users and service providers.

A localized biometric app framework creates an anonymous biometric signals signature updated in OVE from INI. This anonymized biometric signals certificate is a UPID or Unique Phenotype ID for initiation of authentication and authorization for system wide access to user defined and authorized resources.

This OVE issues an encrypted token or privacy-protected object to validate biometric signals users access using the INI gateway and provides a neural and network interface for biometric signals session and access control.

The privacy-protected object provides access to OVE defined resources using an INI session and access control system with a record of OVE validated users assets within a product listing stored on the OVE product directory servers. The listings can be recorded within a publicly available repository or privacy-protected OVE Distributed Data File System (DDFS) file system.

INI providers a hardware and software session and access solution for validated biometric signals users including OVE validation of ownership with terms of use information within the origin aware service bridge.

OVE combined with the INI gateway and services bridge enables end-to-end biometric signals biometric signals tracking and recording of activities and events. As well the services bridge platform provides tools to create and customize intelligent services end products.

The INI gateway and Service bridge provider bridge provides a hardware and software solution including advanced software on chip (SoC) program controls for INI and services bridge based on-device solutions. These solutions include INI “Heterogenous AI Chipsets” for multi-channel parallel Biological Classification Database Systemssing for machine learning and training.

The INI interface and services bridge use the OVE validation engine and privacy-protection token and keys stores and INI for origin rights tracking and validation of services bridge biometric signals intelligent products and services. This provides a model to detect and verify the device and environment session and access ID against the biometric signals validated user profile to assure only validated users are permitted access OVE secure network environments. Validated users system and network environment can be any form including physical, virtual, and augmented node.

This model provides identification using an origin classification engine “Biological Classification Database System” with OVE authentication and authorization for INI and services bridge services access. It also uses an authority or confidence level system including to determine level of services available for each biometric signals user.

As well OVE holds a public directory of services for intelligent services providers (hereinafter “product”), wherein the product may be provided on a service providers platform and syndicated by the user based on the intelligent agent services (hereinafter “service providers”) terms and parameters. As well the intelligent services product may be interactive and require future users access to these products of services using the services bridge platform.

An anonymized biometric signals signature and end product validation is encoded on the end product in a machine readable format to protect origin rights terms and conditions of use.

An services bridge interactive bridge core provides an interactive services bridge SDCE platform between users and service providers. Each product and service is created within an OVE (biometric signals) Validated Object including terms and conditions of use. The bridge core models, modules and templates are built for production and distribution by users and service provider agents.

The functions and services recorded from each users participation in the end product and activity within the services bridge platform are anonymized and recorded in a global repository and each parties OVE account within the DDFS file system. This includes recording of shared datastore and computing resources use whether autonomous, manual, hybrid or all.

The origin awareness neural and network interface (“INI”) provides: real human biometric signals user connection and dynamic interaction between OVE validated users and services providers; advanced multi channel Biological Classification Database Systemsses for machine learning and bio-signal activities; OVE and INI session and access controls; monitoring of the local and distributed global OVE network for compliance with terms and conditions of use; validation parameters for authentication and authorization of tokens and privacy-protected objects; session access to feedback channels during creation of the product or service; threat detection and protection during use of OVE and INI interface services.

The OVE INI gateway and services bridge platform with service provider models can be used separately using an end-to-end OVE INI privacy-protected object model with assets; or an end-to-end OVE identity, authentication and authorization model with INI gateway services and services bridge platform and service providers with real time biometric signals. sync for creation and augmentation of end products and services.

An origin aware neural and network interface “INI” gateway controls bi-directional access to bio-signal streams and OVE. It also provides bi-directional access and control to intelligent services using INI and the services bridge platform. INI provides multi-channel multi-modal bio-signal machine learning framework and provides network wide controls for the OVE mesh, fog, edge, resource constrained device (RCD), IoT, cloud and other network and computing models. Network and system resources include the use of vector symbolic architecture or hyperdimensional computing (VSA/HDC).

### Apparatus

The Origin Aware Neural and Network Interface “INI” provides a gateway for control and validation of OVE system wide sessions and access control between users and intelligent services. Intelligent service providers utilize the INI to protect and validate biometric signals from OVE Users within a privacy-protected system including the services bridge platform for real time interaction between Users and services.

The default INI architecture utilizes CPU/GPU heterogeneous hybrid computing architecture for device based applications and services. An advanced multi channel provide parallel Biological Classification Database Systemssing of bio-signal and biometric signals functions and services.

Machine learning locally or within a remote cloud datastores enable advanced resource constrained device (RCD) computing resources access to OVE system resources with real time machine learning and training for OVE including the use of cloud edge based VSA/HDC.

A mesh architecture further provides OVE an automated multi-user multi-modal framework for delivery of services to users including groups or organizations. It provides a framework for control and management of intelligent agents. Intelligent agents (herein “agents”) include but are not limited to physical, artificial, augmented and virtual profiles.

### System

The OVE biometric signals validation ecosystem provides a protected environment for users of intelligent and artificial intelligence products and services. A secure network connection for OVE validated users and objects using INI for session and access control. Providing users and intelligent service providers confidence that validated activity occurs from OVE validated users, systems and resources.

To assure a more accurate identity of the biometric signals user or object an classification engine “Biological Classification Database System” provides user biometric signals classification. This also provides a model to detect user profile anomalies and includes behavior classification Biological Classification Database Systemsses with a Bio Aware Access Controls “BAAC” service to protect against nefarious activity and bio-spoofing. A machine learning classification and hybrid system validates and registers identifiable biometric signals profile types for validation or identifies unverified OVE profile types.

Using INI Virtual Network Functions within a Software Defined Network (VNF/SDK) or using Programmable Cloud Node Controllers OVE provide networks tracking and observability of OVE validated users biometric signals.

An alternative embodiment includes Quantum NGAN waves technology including utilization of newly discovered Quantum waves and signals protocols are enabled for a complete frequency and neuro spectrum operation for the raw biometric detection and conditioning of biometric signals for OVE and INI biometric signals operations.

In the event of a classification profile is unverifiable or non-existent the object is isolated and classified as an unknown identity type. This information is shared with 3^{rd} party providers as potential threats to protect the OVE and INI systems and resources as well external networks and systems. If the profile is later confirmed it is then moved back to the Biological Classification Database System and used for classification of new validated biometric signals users and objects unless otherwise compromised or deemed unverified.

The OVE and INI system session and access controls provide the origin aware service bridge (services bridge) with a secure bio-signal environment for connectivity to shared datastores and computing environment resources between users and intelligent services agent providers (ISAP).

OVE encoding instructions provides objects and assets within OVE ownership rights data including terms and conditions of use. biometric signals encoding of OVE (biometric signals) Validated Objects provides a method for recording ownership of biometric signals properties and assets. A human account holder holds a default validated phenotype and genotype profile.

The services bridge shared datastores and computing environments “SDCE” uses telemetry and observability services to record each parties activity within the services bridge platform and INI network. The recorded interactions create a user log and report with analytics for registered parties. These activity and event recordings provide a validated record of biometric signals use and ownership including the use of session and access controls from OVE and INI.

Edge, Fog, Cloud Network with Distributed Computing Environment (DCE) or Distributed Data File System (DDFS) provides a public repository of products and services created within the services bridge platform. Using this model with an OVE validated biometric signals secure network this provides secure access for all users to contents and media generated by the services bridge platform. This content and media can be downloaded or automated for update to user and service provider repositories for unrestricted access.

### Flow

OVE provides a model to qualify biometric signals objects utilizing multi-modalities of classification and detection. User validated resources and system inter-connectivity enable human account holders to control OVE (biometric signals) Validated Objects and agent properties.

Registered intelligent services agent providers “ISAP” (herein “service providers) utilize services bridge to connect and record interaction with OVE validated Users. The interaction between registered service providers and biometric signals OVE validated users enables the “services bridge” to provide real time shared biometric signals interaction and service data of activity to all users based on permission granted from the Roles Based Access Controls (RBAC).

services bridge functions and services identify and record use metrics to validate ownership and outcomes for output from the services bridge platform. These metrics are recorded within services bridge and updated to OVE Distributed Data Files Storage (DDFS) to provide biometric signals validated rights and update ownership encoding.

The OVE metrics threshold settings provide the validated User with a range of services bridge bio-signal activity enabling the OVE to assess user services industry and commercial metrics of similar platforms to either certify ownership rights or rate authenticity based on a range of confidence of rights. If the activity warrants ownership rights based on data received from services bridge OVE then a certificate of ownership is issued with rights and terms and conditions of use as provided by user and service providers of the OVE system and services bridge platform.

The OVE machine readable encoding records end-to-end network and biometric signals data activity of all types during operation during the OVE validation Biological Classification Database Systems. Activity includes biometric signals data to and from the INI gateway and to and from the services bridge platform. The tracking and monitoring of biometric signals validation enables protection and validation for OVE and services bridge network and systems.

Human interactive devices, detectors and sensors using the Human Guiding Hand (Service Bridge User Devices) sensors and devices provide interactive streaming of bi-directional biometric signals interaction with the services bridge shared datastore and computing environments (SDCE).

As an example of automated and feedback loop biometric signals activity tracking and physiological and psychological modeling services bridge with INI utilizes real time biometric signals of users with manual, automated, and hybrid interactive methods of feedback validation. This modeling provides bio-signal interaction with service providers and user details of resources for each product or service Biological Classification Database Systems. This data is used to establish ownership of generated content.

The services bridge core SDCE provides a platform for interpretation of user biometric signals with services bridge services and service providers agents. Registered service provider agents (herein “agents”) can be in any form or type of service. The service provider agents deliver the ISAP service to the services bridge. ISAP are OVE validated agents and utilize the services bridge biometric signals platform for interaction with OVE validated users.

The OVE system with INI and services bridge records biometric signals and biometric signals interaction with dynamic feedback. This activity provides data for thresholds metering. The threshold metering provides real time displays of activity and ranges of confidence. Threshold metering also provides data for validation of ownership. Combined this data is used for certification of service bridge user devices user outcomes and services bridge output ownership. It can also be used for establishing certification metrics for governing authorities.

Service bridge user devices provides biometric signals sensor and detector modalities or signaling voltage and biometric models tracking ranges in pulse and other biometric signals tracking stress levels. These factors are used to communicate an emotion type to the service provider and augment the outcome of the services bridge generated content.

These biometric signals interactions generate a feedback loop alert to confirm the emotion type. This hybrid model utilizes an interactive biometric signals interference ingestion by the services bridge and services providers combined with manually created emotion templates to augment outcomes during operation of services bridge ISAP services with Service Bridge User Devices.

The anonymized emotion modeling and template storage within the OVE DDFS file system utilizes automated, manual and hybrid settings. When an services bridge ISAP generates an outcome or output from the ISAP agent and the user Service Bridge User Devices biometric signals are not recognized the system requests either a manual or hybrid response based on settings of the user. The manual response creates an emotion profile signature template which is monitored and tracked during interaction with the services bridge and ISAP agent. If the user requests automated interaction the service provider creates settings responses or service provider modules to automatically select the criteria and emotion based on type of Service Bridge User Devices device and modalities of the user. A similar Biological Classification Database Systems for users creates an anonymous emotions feedback scoring model for response to the Service Bridge User Devices biometric signals of the user.

The visual response and alerts from the services bridge UI and modalities to the Service Bridge User Devices user includes setting of emotion type to event system origin aware language bridge “OALB” bridge display for interpretation of Service Bridge User Devices biometric output and feedback to NLP models. The types of modalities are limited only by the Service Bridge User Devices devices and biometric signals response.

A template and record created with confirmation from the personalized OALB settings is displayed based on user preferences. The types of response and preferences can be in any form of modality or modalities available within the users systems and devices. Display on a GUI or UI of the OALB can be in any phonetic or non-phonetic form.

An Service Bridge User Devices biometric signals emotions interpretation enables templating and fingerprinting of emotion based outcomes and outputs from the Service Bridge User Devices user and augments the Service bridge providers interaction to the products and services.

Emotions from happy to sad and accept or reject. The emotional models fingerprints and templating models for services of each User and service provider are recorded and stored within the OVE profile in a privacy-protected anonymous Distributed Data File System (DDFS) system for personalizes use during access and sessions with the services bridge platform and services provider. These datastores include local INI on-device based datastores and applications.

INI and services bridge service outcomes or output can use any type of ISAP OVE User validated agent including physical, virtual, augmented and hybrid.

### Threat Protection

A threat detection engine combined with 3^{rd} party services provides a comprehensive threat protection system and model. Combined with SybilGuard and algorithms such as Locality-Sensitive Hashing (LSH) ATDE can detect and protect against anomalies of unknown and unverified biometric signals signature types and profiles including status within the biological classification database system.

OVE further provides an INI validated device service to validate operational integrity of OVE network and system resources and authorized circuit and firmware models.

Threat detection and protection combined with INI creates a session and access control management system that discovers and alerts users to threats and isolates unknown unverified biometric signals profiles and objects.

It identifies, classifies, blocks, patches and removes corrupt components within the OVE system including INI and services bridge. The combination of ATDE and biological classification threat detection protects OVE systems with an advanced threat protection solution including against existential AI threats such as bio-spoofing.

INI also utilizes a quantum level encryption protocol to assure updated OVE systems and resources including VNF/SDK and programmable cloud system nodes and devices are not compromised by outside services or threats.

### Personalized Medical Platform

As an example a personalized medical platform for biometric signals validated Users provides a plurality of medical applications and services including the ability to register know and unknown organism related to known conditions. An OVE human users validated permission based systems provides a validated source of anonymized bio-signal data to a privacy-protected global repository. Treatment models based on a global datastore of user data is invaluable for understanding trends and discovering potential harmful medical conditions.

The OVE Personalized Medical Platform with biometric signals anonymized data used to learn and train using OVE global DDFS datasets. Queries developed provide results for subsets of user types, geographic and other bio-signal and other bio-diversity and bio-culture generated data.

A personalized medical portal (PMP) with OVE privacy-protected and anonymous biometric signals OVE validation provides validated users solutions to current and future physiological and psychological challenges. It may also provide data for harmful conditions that may be unknown to OVE validated Users or medical professionals.

This privacy-protected model for medical communities can develop new emergent treatment methods and models using machine learning and related intelligent services.

### Personalized OVE Services Bridge Platforms

Exemplary types of OVE services bridge customized platforms include but is not limited to:
i. origin validated objects with non-default (other than human such as environmental) OVE validated biometric signals assets;
ii. origin validated objects with properties or assets including fiat or crypto currency value;
iii. services bridge platform with multi-user multi-device multi-service, or any combination thereof, accounts;
iv. Service Bridge User Devices multi-user multi-device multi-service, or any combination thereof, accounts for authorship tracking of generative and creative services;
v. any customized type of platform or system combinations thereof.

The invention addresses several issues for biometric signals ownership validation and control of biometric signals and intelligent services interaction. Core services include: origin validation engine “OVE” biometric signals validation with origin classification engine “Biological Classification Database System” classification; creation and management of privacy-protected tokens and objects; origin aware neural and network interface “INI” session and access control interface for networks and systems; “services bridge” platform for user and intelligent service providers; biometric signals validated properties and assets; Service Bridge User Devices threshold ownership and validation of services bridge biometric signals interaction; validation of services bridge services outcome and output ownership.

The combined platform provides control and validation of user biometric signals products and service ownership rights for objects created within the OVE system.

services bridge intelligence services platform provides manual and automated production of intelligent services generated products and services. With the use of the services bridge shared datastores and computing environment “SDCE” the platform delivers a comprehensive environment to protect, manage and deliver biometric signals validated biometric signals applications and services.

Human assisted intelligent services create a challenge for standardization of ownership rights. With services bridge and Human Guiding Hand “Service Bridge User Devices” threshold metering services bridge validates biometric signals ownership with standardized models including the use of a shared datastore and computing environment “SDCE.”

The intelligent services agent provider “ISAP” (herein “service providers”) use the services bridge platform and API to integrate into an OVE validated users environment. ISAP types are unlimited in scope and include: artificial; virtual; robotic; environmental; quantum; and other intelligent service and device profiles.

Typically an ISAP wishes to receive compensation for services. One type of payment is machine learning and training data. This helps service providers create pre-built models, modules or other AI products or services (hereinafter called “services”). Other types of service providers may require more traditional methods of payment or in addition to machine learning and training data including robotic services. Service providers would likely wish to restrict the use of these services unless the agreed consideration is provided or agreed upon including terms and conditions accepted by the user. The OVE authenticity and ownership system provides a solution for delivery and consideration of these products and services based on services bridge use agreements and SDCE. Service Bridge User Devices provides the ownership and biometric signals activity validation.

With the needs of validating human users (hereinafter “users”) origin rights enabled the OVE system to provides a system to sync dynamic and intelligent user agents with human validated OVE users in real time and deliver intelligent products and services with ownership and authenticity validation.

Human controlled intelligence services can use OVE and origin awareness neural network interface (INI) gateway as a neural and network interface to the services bridge for advanced control of biometric signals biometric signals and to validate ownership rights. This includes the creation of privacy-protected objects for exchange of goods and services such as terms and conditions for use of product created within the services bridge.

The INI multi channel biometric signals aggregation and raw biometric capture Biological Classification Database Systemsses creates dynamic anonymized bio-signal streams and biometric signals signatures for interaction within the SDCE or shared datastores and computing environment.

OVE encodes system activity and bio-signal streams to protect ownership rights including terms and conditions of use. OVE also uses encoding to establish and protect rights including compensation for use. The product encoding is machine readable. The biometric signals encoding is a two layer privacy-protected system with anonymization at the local device level and OVE system validation. OVE uses many privacy-protection models and methods including distributed data files systems (DDFS) which stores datasets in many dataset locations using distributed ledger technology (DLT).

In a first aspect, there is provided an Origin Validation Engine (OVE) system with an Origin Classification Engine (Biological Classification Database System). A biometric signals rights validation engine using an Intelligent Network Interface “INI” for session and access controls to OVE systems and Intelligent Service Agent Providers (ISAP) “services bridge.”

OVE with INI can validate access to privacy-protected objects and systems network. Combined with the services bridge intelligent service OVE can provide a platform to create an end product with biometric signals integration and biometric signals service validation.

The OVE system comprising: a token validation or validator system; a neural and network interface with container and device ID system; a privacy-protected object validation model; a privacy-protected token and key store; a privacy-protected token and key store controller; a token status and encoding system; a distributed protected datastore for OVE data; a distributed end product token and status datastore and directory; a distributed neural and bio origin signature and certificate validation and datastore; a biometric signals signature validation for certificate issuance; a neural and network interface for dynamic and interactive biometric signals bio-signal services; a neural and network interface with biometric signals and origin rights validation controllers and stores; a neural and network interface and programmable services bridge with dynamic pluggable and programmable modules; an OVE and services bridge API for integration of OVE authentication and authorization services with or without a physical INI interface; a privacy protected service bridge with biometric signals rights and validation stores; a privacy protected service bridge with dynamic pluggable and programmable service gateways.

In one of more embodiments, encoding and classification the OVE mesh uses an the Origin Validation Classification Engine (‘Biological Classification Database System’) including for known definitions of real human users to validate enrollment. THE Biological Classification Database System also provider definitions of biometric signals validates assets within privacy-protected objects.

In one or more embodiments, the Biological Classification Database System encoding provides transmission data, media and services a transparent OVE repository ownership record with access terms and conditions for validated ISAP's and users. It provides a flexible platform for publicly available and permissioned access controls as well authentication including registering information on production formats and controls. Publicly accessible models also provides users of OVE and Biological Classification Database System intelligent human identity and encoding classification sub classes to a plurality of taxonomy and genotypes for biometric signals validated assets within privacy-protected objects.

In one of more embodiments, the raw biometric signature and timestamp Biological Classification Database Systems records and updates a protected OVE or local datastore upon device and bio-signal capture. An anonymization of the biometric signals signature and certificate is updated within a local datastore and anonymized signature recorded in OVE DDFS for session access and control using INI.

In one or more embodiments, the neural and network interface and services bridge may manage bio-signal input and output thereof.

In one or more embodiments, the neural and network interface with services bridge may provide access controls to products and services by adding or removing OVE biometric signals validated authentication and authorization users.

In one or more embodiments, the service bridge may include a gateway for user agents including but not limited to: artificial intelligence; intelligent services; machine learning; neural networks; neuromorphic; biomorphic; quantum; and other intelligent agent providers and program modes and models that autonomously create and deliver end products goods and services with minimal or unsupervised instruction sets thereof.

In one or more embodiments, the service bridge end products delivered may be influenced and controlled by a biometric signals validated neural and network interface and/or services bridge users real time biometric signals interaction thereof.

In one or more embodiments, the origin rights may include but is not limited to creative and intellectual ownership of AI and intelligent products and services initiated and influenced by biometric signals validated end users thereof.

In one or more embodiments, a self sovereign identity (SSI) model protects against unwanted actors such as AI agents combined with Hyperledger Fabric permissioned channels to allow OVE users and ISAP's to use and develop any type of application or service environment with protected OVE real human identity and validation.

Combined OVE Biological Classification Database System SSI allows users to keep identities anonymous with publicly available OVE validated credentials for OVE system access. SSI access is limited to one account or project to protect against identity bio-spoofing and bio-masking.

In one or more embodiments, Biometric Verification, Enrollment & Login with Origin Validation Engine (OVE), IdP, Distributed Data File System (DDFS), Certificate Authority (CA) Sever with issuance of OIDC SSO JWT Tokens for global OVE authentication and authorization is the default OVE embodiment. With DID DDFS the OVE Users Account Data is protected including for digital assets such as OVE (biometric signals) Validated Objects.

In one or more embodiments, the OVE and Biological Classification Database System Service Bridge User Devices can delivers participants multi-modal information on each user including real time bio-signal validation and activity threshold meters. Biological Classification Database System also provides validation for real human conferencing of participants using multi-user multi-device multi-service accounts. Combined with OVE (bio-origin) Validated Objects and OVE Distributed Ledge Technology (DLT) the OVE automatically or manually creates OVE records for new and existing OVE (bio-origin) Validated Objects OVE DLT digital assets.

In one or more embodiments, the OVE enrollment and registration Biological Classification Database Systemsses confirms the biometric signals of the user as a real human in default mode. It also provides ISAP's with core agent models reviewed and rated by communities and tested by ML algorithms. The system also provides custom model development for new SaaS, PaaS, IaaS and other registered ISAP's platform segments and providers.

In one or more embodiments, algorithms capture and classify device sensor data, detection, drivers and updates as well policies for users and ISP's using OVE, Biological Classification Database System, INI, Services Bridge, SDK and API's. Algorithms are publicly available on the Biological Classification Database System as well classification updates for sensor biometric signals data and biometric signals signature models.

In one or more embodiments, OVE and services bridge biometric signals biometric frameworks permits recognizable proof of biometric signals activity including behavioral and physiological attributes modeling.

In one or more embodiments, the INI is designed to use a Virtual Network Function (VNF) Software Defined Network (SDN) with Istio Virtual Machine computing environment for organic protected growth of infrastructure and provisioning of resources to deliver OVE Mesh, Biological Classification Database System, INI, BAAC, and services bridge protected system operation.

In one or more embodiments, the INI smart devices detection and sensors system captures user biometrics and origin data. The Service Bridge User Devices provides real time manual, automated and system feedback from users which also helps defines unique signatures, and enables continuous secure authentication in the OVE system and INI system using Bio Awareness Access Control (BAAC) and Awareness Threat Detection Engine (ATDE) models.

In one or more embodiments, combining machine learning (ML) models, DLT blockchain, and smart microservices delivers a threat protection and origin aware platform for OVE users and ISAP's in a secure layer within a bi-directional network. As well within the INI BAAC deep learning algorithms continuously monitor and validate streaming human bio-signal and digital feedback inferences.

In one or more embodiments, the platform captures streaming human behavioral and biometric data attributes to create unique digital signatures, and stores them as immutable records on the OVE DDFS blockchain using Controllers or Users with unique Phenotype ID (UPID). Storing on the DDFS protects privacy and provides control of this data for the Controller or User.

In one or more embodiments, ML inference algorithms continuously test and authenticate validation models used from Biological Classification Database System public repositories. These models behavioral and biometric attributes protect ISAP based systems account or projects using the OVE validation Biological Classification Database Systems and secure network.

In one or more embodiments, the OVE mesh encoding keys for digital assets also provides a private public record model to register OVE (bio-origin) Validated Objects and OVE Distributed Ledge Technology (DLT) projects and assets for reference in the OVE and services bridge. The private permissioned information is accessible by an OVE validated Controller or User. The public OVE digital and organic asset encoding key system provides status and conditions of OVE (bio-origin) Validated Objects and OVE Distributed Ledge Technology (DLT) assets including active or inactive.

In one or more embodiments, blockchain and DLT public ledger validation from OVE to services bridge ISAP production make it possible to extract and encode OVE signatures for users on all services including streaming media. The OVE Mesh Istio is provisioned to deliver this encoding service. It also creates access for the Biological Classification Database System to anonymized information of digital assets and delivery for transmission of data, media and/or services or OVE (bio-origin) Validated Objects and OVE Distributed Ledge Technology (DLT) creation or exchange.

In one or more embodiments, API's and proxy sidecar controllers provide observability of all network services and devices including underlying components with metrics needed to optimize and deliver OVE services. The OVE ecosystem with validation in the services bridge and for OVE (biometric signals) OVE (bio-origin) Validated Objects and OVE Distributed Ledge Technology (DLT) deliver a next generation intelligent digital ecosystem.

In a second aspect, there is provided an OVE biometric signals and biometric signals objects and token validation system, comprising: determining whether an object or token enables the requesting user to activate the service in the manner sought, the object or token and biometric signals rights validator accesses data on the neural and network interface and services bridge, such data being selected from a group consisting of: an identification of the interface or bridge container or device particular details and conditions thereof; a privacy-protection object or token and key store with controller particular details and conditions thereof, an identification of biometric signals object or token particular details and conditions thereof, a token controller and state store particular details and conditions thereof, an anonymized biometric signals origin rights certificate and signature particular details and conditions thereof, a user agent particular details and conditions thereof, an interface and bridge application(s) and/or module(s) to be employed to activate the service particular details and conditions thereof, a system clock; and combinations thereof.

In one or more embodiments, the token controller and biometric signals validator may run in a protected environment such that the user is denied access to such biometric signals validated object or token if any parameter is unverifiable for protection of the secure OVE validated objects and users network.

In one or more embodiments, the local privacy-protection object or token key store may employ a shared secret to decrypt sub claims or index in the authentication and authorization of object or token used in the validation system thereof.

In one or more embodiments, the privacy-protection key may decrypt the protected service activation object or token sub claims or index when the neural biometric signals and end product biometric signals validation determines that the object or token rules may in fact enable the requesting user to activate the requested service in the manner sought thereof.

In one or more embodiments, the neural and network interface and OVE end product token controller may refuse to issue a valid object or token if the privacy-protection biometric signals and object or token is not current or token state is invalid or blocked, and wherein the method may comprise: checking object or token status; checking raw biometric and biometric signals object(s) or token(s) status; requesting a current biometric signals and/or access object(s) or token(s) from a privacy-protection controller and OVE validation system(s); generating and installing the requested valid object(s) or token(s) in the privacy-protection object or token key store and OVE systems; receiving the valid object(s) or token(s), the biometric signals and access object(s) or token(s) being valid and active; updating the object(s) or token(s) state in datastore and sub claims or index data; updating the object or token in datastore with valid biometric signals rights; updating biometric signals signature and certificate status system for issuance of anonymized OVE biometric signals signature certificate; reading a machine readable object or token encoding to confirm access terms and parameters are valid.

In one or more embodiments, the privacy-protection object or token key store controller may provide for one or more object or token on the neural and network interface and service bridge thereof.

In one or more embodiments, the local privacy protection object or token key store may provide access to one or more services separately from the requested service for production of the end product thereof.

In one or more embodiments, each object or token in the object or token store may be removed or blocked therefrom, and wherein the state store may also maintain state and transactional information corresponding to each object or token formerly in the object or token store including the object or token biometric signals rights signature and certificate including machine readable encoding.

In one or more embodiments, the neural and network interface and services bridge may provide access controls to object or token by adding or removing biometric signals validation methods including not limited to object or token and encryption with or without multi-modal and multi-factor properties for authentication and authorization.

In a third aspect, there is provided an Origin Awareness neural and network interface (INI) apparatus, comprising: A validation engine comprising one or more OVE computing formats providing, but not limited to, at least one or more neural signals and feedback channels of a visual, audible, tactile and other modes and modalities in communication with a printed circuit board or software interface or bridge: wherein the interface and/or bridge provides hardware, software or API service authentication and authorization platforms for operation of the origin validation engine (OVE) thereof, wherein includes at least one control chip and Biological Classification Database Systems or functions thereof, wherein a multithreaded Biological Classification Database Systemssing of simultaneous signaling data from multiple sources concurrently may be used thereof, wherein GPU Biological Classification Database Systemssing of simultaneous signaling data from multiple sources concurrently may be used thereof, wherein simulated Quantum signaling and Biological Classification Database Systemssing of simultaneous neural network signaling data from multiple sources concurrently may be used thereof, wherein the interface or bridge modules include and are not limited to applications or other control instructions using software on chip (SoC) and application; wherein a circuit interface includes an heterogenous AI chipset using an application binary interface (ABI) thereof, wherein a network, wired or wireless interface transmits and receives signals to and from peripheral as well as environmental devices, wherein at least one of stored, passed through, and Biological Classification Database Systemssed, by the neural and network interface and/or a services bridge thereof, wherein an onboard storage or remote storage controller with enough memory to store, Biological Classification Database Systems and retrieve the neural and network interface and/or a services bridge data thereof; wherein the origin control and access using a privacy-protected key store and token for origin validation for at least one or more datastores within the system, and combinations thereof, wherein the origin controller privacy-protected token and key store can reside in one or more datastores thereof, wherein the origin controller and privacy-protected token and key store can access the origin validation engine (OVE) and validator to send and receive access data to one or more datastores within the system, and any combinations thereof, wherein module(s) and application(s) of at least one or more peripheral and environmental neural or biometric signals and feedback systems of the neural and network interface and/or services bridge provides connection conditions and rules thereof, wherein a graph or vector database datastores provides ad hoc programming models and modules for graph or vector database datastores; wherein module(s) and application(s) of at least one or more peripheral and environmental neural or biometric signals and feedback systems of the neural and network interface and services bridge provide meta-data and signaling modalities thereof, wherein a neural and network interface and/or services bridge API is provided for interactive control and management of user services and user agents; wherein an intelligent services end product management API is provided for interactive control and management of user services and user agents; wherein the interface includes an OS agnostic mesh platform architecture for biometric signals access and validation thereof, wherein real time tracking and recording includes interaction of real human biometric signals and user agent events including for origin rights validation; a system clock; and combinations thereof.

In one or more embodiments, the neural and network interface and/or services bridge provide biometric signals and signaling service controls on the INI printed circuit board including: advanced peripheral bus (APB); direct memory access (DMA) slave and controller; special functions registers (SFR); GPU and shared CPU controls; multi channel advanced peripheral bus (MC-APB); custom software on chip SoC solutions and controls.

In one or more embodiments, multiple INI API's provide development framework for intelligent services and end product management and UI development. They also provide controls for interactive application and OVE, INI, Service Bridge User Devices and services bridge UI IDE development for OVE, INI, Service Bridge User Devices and services bridge systems and applications.

In one or more embodiments, the distributed origin awareness neural and network interface (“INI”) provides: monitoring of the distributed and local AI ecosystem for compliance with terms and parameters of authentication and authorization set by the intelligent service; and real human biometric signals user connection and dynamic interaction including feedback during creation of the product.

In one or more embodiments, the INI interface includes an OS agnostic n-tier platform architecture and integration framework including mesh. This architecture provides INI interface integration with almost all platforms and operating systems. The OS agnostic mesh integration includes functions and services for user agents such as artificial, virtual, robotic, environmental, quantum, AI sensor devices and multi channel bio-signal modalities.

In one or more embodiments, the INI privacy-protected token and key system creates an anonymous biometric signals token layer with privacy-protected signature validation in the OVE and for connection to OVE and INI services. This access token layer terms and conditions authorize interaction between the neural and network interface and services bridge and initialize connection with the service provider.

In one or more embodiments, service initiation Biological Classification Database Systems can be done directly with the neural and network interface using a custom service bridge developed by service providers. These custom service bridges can be proprietary or open source and include interactive control and feedback layers developed using the neural and network interface API's.

In one or more embodiments, the product object or token store of the OVE server uses the interactive origin bridge signal core (hereinafter “bridge core”) INI technology to interact with the intelligent services human initiated intelligent and artificial intelligence products and services agent to create and deliver bio-object validated and goods and services.

In one or more embodiments, the neural and network interface, services bridge or API may be configured by the services bridge and services gateways applications and modules to: wherein a raw biometric signature and timestamp is recorded and then updated in the protected datastores upon device and bio-signal capture, then a biometric signals signature and certificate is created and updated in the biometric signals certificate status datastore; wherein utilize a bio-signal auto-tuning dynamic noise reducer, a biometric signature extractor, and a classifier including for ad hoc polymorphic graph and vector database optimization; wherein creates a pipeline for training data input into the service providers knowledgebase; wherein deliver a service bridge evaluation Biological Classification Database Systems for recognizing neural bio-signal patterns that are leveraged and shared with the service bridge stores and knowledgebases; wherein deliver personalized and optimized biometric signals and OVE services data for resource constrained devices (RCDs); wherein provide interactive sensor signaling and articulator feedback modalities for user agents including artificial, virtual, robotic, environmental, quantum, and AI; wherein utilize machine learning storage models for shared pattern recognition, classification and personalization that operates while the neural and network interface and services bridge are not connected to a network, with machine learning acting as one or more of an auto-tuning dynamic noise reducer, a biometric signature extractor and a ML classifier including for graph database optimization; wherein machine learning training is applied when the neural and network interface and service bridge is connected to the network to create an individualized classifications for shared data stores including for graph and vector database optimization wherein derived outputs of an machine learning training being stored in a shared knowledge base and cloud storage or on a mobile computing device having at least one of a wireless connection and a wired connection and within wireless network range including for ad hoc polymorphic graph and vector database optimization.

In one or more embodiments, the origin awareness neural and network interface (“INI”) can provide: monitoring of the distributed and local AI ecosystem for compliance with terms and parameters of authentication and authorization set by the intelligent service; and real human biometric signals user connection and dynamic interaction including feedback during creation of the product.

In one or more alternative embodiments, a Cirq Quantum VM and Device Interface or QSimSimulator support GPU execution of circuits, with qsim compiled on a device with the CUDA toolkit and run on a device with available NVIDIA GPUs.

In a fourth aspect, there is provided a biometric signals validated biometric signals threshold management system or human guiding hand “Service Bridge User Devices” apparatus using the INI for session and access control and protection, within an platform comprising: a biometric signals device comprising one or more resource constrained formats providing, but not limited to, at least one or more neural signals and feedback channels of a visual, audible, tactile and other modes and modalities in communication with a printed circuit board or software interface or bridge; an intelligent service by which an end product is created; a neural and network interface and services bridge biometric signals events tracking and recording system; wherein the interface and/or bridge provides hardware, software or API service authentication and authorization platforms for operation of the human guiding hand (Service Bridge User Devices) devices thereof, wherein includes at least one control chip and Biological Classification Database Systems or functions thereof, wherein a multithreaded Biological Classification Database Systemssing of simultaneous signaling data from multiple sources concurrently may be used thereof, wherein Biological Classification Database Systemssing of simultaneous signaling data from multiple Service Bridge User Devices devices and sensors concurrently may be used thereof, wherein simulated Biological Classification Database Systemssing of simultaneous signaling data from multiple sources concurrently may be used thereof, wherein the interface or bridge modules include and are not limited to applications or other control instructions using the Service Bridge User Devices application; wherein a threshold manager logs and reports shared datastore and computing environment resource usage; wherein the Service Bridge User Devices includes and are not limited to settings or other control instructions for limitations for service providers applications and services; wherein a network, wired or wireless interface transmits and receives signals to and from a peripheral as well as environmental devices, wherein at least one of stored, passed through, and Biological Classification Database Systemssed, by the neural and network interface and/or a services bridge thereof, wherein an onboard storage or remote storage controller with enough memory to store, Biological Classification Database Systems and retrieve the neural and network interface and/or a services bridge data thereof, wherein the origin control and access using a privacy-protected key store and token for origin validation for at least one or more datastores within the system, and combinations thereof, wherein the origin controller privacy-protected token and key store can reside in one or more datastores thereof, wherein the origin controller and privacy-protected token and key store can access the origin aware neural and network interface (INI) and verify session and access authorization to send and receive biometric signals access data to one or more datastores within the system, and any combinations thereof, wherein module(s) and application(s) of at least one or more peripheral and environmental neural or biometric signals and feedback systems of the neural and network interface and/or services bridge provides connection conditions and rules thereof, wherein a graph or vector database datastores provides ad hoc programming models and modules for or vector database datastores; wherein module(s) and application(s) of at least one or more peripheral and environmental neural or biometric signals and feedback systems of the neural and network interface and services bridge provide meta-data and signaling modalities thereof, wherein a neural and network interface and/or services bridge API is provided for interactive control and management of user services and user agents; wherein an intelligent services end product management API is provided for interactive control and management of user services and user agents; wherein the interface an OS agnostic mesh platform architecture for biometric signals access and validation thereof, wherein real time tracking and recording includes interaction of real human biometric signals and user agent events including for origin rights validation; a system clock; and combinations thereof.

In one or more embodiments, one or more Biological Classification Database Systemssors of bio-signal feedback channels may use a visual, audible, tactile and other biometric signals modalities from multiple sources to deliver dynamic interactive bio-signal data for services to intelligent and artificial intelligence service users and user agents.

In one or more embodiments, the neural and network interface may aggregate multiple neural directional and bi directional sensors and bio-signal stimuli thereof.

In one or more embodiments, the neural network interface may combine dynamic multi-channel bio-signal capture and assembly for creation of neural and biometric signals rights signatures thereof.

In one or more embodiments, the dynamic multi-channel bio-signal capture and assembly may create anonymized virtual raw biometric signals signatures for user and user agents and biometric signals rights validation thereof.

In one or more embodiments, an anonymization layer for bio-signal neural data may connect multiple external services to the neural and network interface, services bridge or authentication and authorization service integration thereof.

In one or more embodiments, the bio-signal data may be Biological Classification Database Systemssed and analyzed in real-time.

In one or more embodiments, an Origin Awareness Services Bridge (‘services bridge’) with OVE mesh architecture delivers a system to confirm biometric signals for users of different intelligent and artificial intelligence systems and services. The validation starts from the user enrollment to biometric signals validation. OVE tracks service interactions and biometric signals adaptive Biological Classification Database Systemsses for outcomes and output.

In one or more embodiments, services bridge is an important part of the model to help us understand our interaction and impact on intelligent services. The origin to awareness, awareness to service model provides real human users interactive measurement of Controller or User Input using a Human Guiding Hand (Service Bridge User Devices) and Intelligent Service Agent Providers (ISAP) architecture.

In one or more embodiments, OVE authentication and authorization combined with the OVE Mesh services bridge Human Guiding Hand (‘Service Bridge User Devices’) and services bridge User and ISAP UI provide dashboards to modify and manage system resources and create new projects and accounts. The OVE Mesh also provides an Origin Awareness Language Bridge (OALB) to detect and translate biometric signals feedback types and Controllers or Users based on privacy settings.

A virtualization Biological Classification Database Systems allows the Service Bridge User Devices UI User to select or change the product or services requested using the Service Bridge User Devices multi-modal biometric input dialog. The inputs including manual and Service Bridge User Devices automated bio-signal feedback allows selective decision Biological Classification Database Systemsses during production.

This virtualization Biological Classification Database Systems within the services bridge enables ISAP development of new functions, services and modules.

In one or more embodiments, the Service Bridge User Devices and ISAP console dashboards provide multiple OVE validation services for the users and ISAP's from Profile with Biological Classification Database System templates to vertical focused projects for multiple OVE users and ISAP's. The multimodal multi-profile multi-device capabilities are part of the OVE Mesh Istio XCP architecture.

In one or more embodiments, the OVE Mesh is designed to use encoding of tracks and records interactions and ownership for products and services. The encoding and tracking combined with transmission, data and streaming channels provide services bridge with core graph and vector model change functions for real time production and output adaptive Biological Classification Database Systemsses.

In one or more embodiments, the OVE Mesh utilizing the Istio architecture with XCP microservices scalability enables the OVE Mesh to deliver seamless and customizable clusters and virtual machines in real time. Along with an integrated coding environment for creation of Istio, OVE (bio-origin) Validated Objects, and ISAP custom applications, modules, extensions and model delivers the granular data controls for Service Bridge User Devices Threshold Rate Limit Services (TRLS) and delivers Istio XCP Mesh services framework for OVE and services bridge systems management.

In one or more embodiments, the application or module by which the service is requested and Biological Classification Database Systemssed may use a neural and network interface, services bridge or authentication and authorization API service integration and gateway thereof.

In one or more embodiments, the neural and network interface, services bridge and API may be configured to: generate at least one of visual, audible, tactile and other neural or haptic biometric signals types and modalities feedback; Biological Classification Database Systems detectable neural bio-signal wave frequencies, thereby facilitating mapping of biometric signals to feedback biometric signals; alter the neural bio-signal data with metadata from other sensors and data sources; alter the feedback with the metadata from the other sensors and data sources; synchronize biometric signals from multiple sensors with a real-time clock; stimulate user's bio feedback wherein the stimulating includes bio feedback confirmation; optimize graph and vector database ad hoc polymorphic datastores programming modes and models for biometric signals biometric signals interactive feedback; access system, user and service provider models, modules and templates in a distributed computing environment (“DCE”) or DDFS with OVE access control; to enable interactive user agent signaling and articulator feedback with multi-channel modalities; and any combinations thereof.

In one or more embodiments, multiple dynamic modules and applications may manage multiple bio-signal channels and types from multiple sources including peripheral, IoT and neural networks thereof.

In one or more embodiments, multi biometric signals modules may Biological Classification Database Systems or send fusions of raw, conditioned or hybrid raw biometric and bio-signal data, to another Biological Classification Database Systems or service thereof.

In one or more embodiments, a biometric signals signature in the validation system may enable end user tracking and recording of origin rights data and events lookup with an biometric signals validation objects unique tracking and version numbering in a machine readable privacy-protected object encoding thereof.

In one or more embodiments, the origin interface agnostic core integrates with any type of technology or systems validation requirements for raw, conditioned or hybrid signals and signals data solutions. It provides a solution for all types of signal modulation and modalities within a pluggable module templates for development and delivery of any type of DCE or DDFS signal service and data architecture.

In one or more embodiments, a graph and vector database programming solution provides ad hoc programming models and optimized polymorphic graph databases. These datastores use a distributed data file system (DDFS) and DCE computing environment with mesh platform to provide OVE system resources with access to privacy-protected real time updated datastores. This model also provides a repository for pre-built models, modules and templates. This distributed repository for OVE and INI system modules and models includes user and service provider terms and parameters provides OVE with details of default OVE access parameters for users of these products and services during biometric signals validation and access setup.

In one or more embodiments, an anonymized biometric signals signature and end product validation is encoded on the end product in a machine readable format to protect origin rights. This can also monitor use of the encoding with the INI using cloud and IoT infrastructure, which enables INI and services bridge to acquire new biometric signals for users.

In one or more embodiments, ML derived intelligence learning and training data shared knowledge base in cloud storage containers of one or more devices may be used to generate individualized executable classifier raw biometric bio-signal streams updates onto at least one or more neural and network interface or service bridge remote storage, or the mobile computing device via at least one or more of wireless connection and a wired connection between the network and a interface or bridge storage for offline usage without network dependencies including for ad hoc polymorphic graph database optimization.

In one or more embodiments, the Biological Classification Database Systemssing module may have different modes that include at least one of a raw, conditioned or hybrid mode, a Biological Classification Database Systemssed mode, and combinations thereof.

In one or more embodiments, the apparatus may include a plurality of modes, wherein the raw, conditioned or hybrid mode sensor stream of neural and biometric signals data Biological Classification Database Systemssing locally or on a neural and network interface remotely, or on a services bridge in a cloud via a mobile or internet connected device may filter, recognize, or interact with the full aggregated sensor stream of neural origin biometric signals data including within ad hoc polymorphic graph or vector database datastores modes and models.

In one or more embodiments, a time domain signals data may be appended to raw, conditioned or hybrid raw biometric signals data, in order for the system to Biological Classification Database Systems data streams from multiple raw biometric bio-signal data sources and ensure all bio-signal data streams are synchronized including within ad hoc polymorphic graph or vector database datastore modes and models.

In one or more embodiments, metadata from sensors and data sources may be appended to all data types including raw, conditioned or hybrid service bridge modules and applications for raw biometric signals and bridge core synthesis with intelligent services and OVE (biometric signals) Validated Objects creation including ad hoc polymorphic graph and vector database datastores modes and models.

In one or more embodiments, the services bridge functions and services include modules or extensions from developers. The INI services bridge Independent Development Environment (IDE) and API system with polymorphic polyglot database and model development provides a complete development stack to build customized services bridge platforms including custom OVE multi-user, multimodal, multi-device platforms.

### Alternative Embodiments

On one or more embodiments, a plurality of signaling applications or solutions including waves and nano frequencies work within the architecture of this technology. CPU/GPU heterogeneous Biological Classification Database Systemssing of simultaneous signaling data from multiple sources concurrently using non-quantum Biological Classification Database Systemssing simulated Quantum models for signaling and Biological Classification Database Systemssing of neural network signaling provides accelerated Biological Classification Database Systemssing and intelligence. The Biological Classification Database Systemsses for Quantum computing would apply for Quantum Biological Classification Database Systemssing systems with or without the use of simulated computing models.

On one or more embodiments, the OVE code libraries including SDK and API's controls provide: immutable capture to store models for individual OVE and ISAP identities, credentials, and asset records; build and debug algorithms; adds learning and training databases for ML models; build new intelligent services automatically; and provide a development environment for the OVE community.

On one or more embodiments, the services bridge Istio manages deployment of containers including the use of software (SDN) and virtual function defined (VNF) with GPU nodes with Quantum Key distribution for security and protection against man-in-the-middle MITM attacks and new AI Quantum encryption deciphering.

On one or more alternative embodiments, a Quantum Key Distribution (‘QKD’) is used for protection of all communication and data. This protection combined with ZKP creates a future ready model for protection against future AI and Quantum systems. The QKD can detect changes in keys in transit. The QKD also protects the OVE and INI against Man-In-The-Middle (‘MITM’) attacks from unauthorized network activity which drops questionable Biological Classification Database Systemsses until they are re-validated and OVE determines the activity is authorized by a real human user.

The OVE System and Platform has many configuration possible. This is a generalized outline of the systems and components.

### OVE Validator System—Biometric Validation, Authentication and Authorization

### Components

Biometric validation security for account setups includes:
Voice Recognition
Fingerprint Scanning
Facial Recognition
Iris Recognition
Heart-Rate Sensors

### OVE Validation System:

IdP Identity Provider (OIDC JWT)
JWT Secure Token Server (STS) or OASIS WS-Trust
Certificate Authority (Server)
Encoding & Decoding Server and Services
Distributed Ledger Technology (DLT)
Content ID (CID) Services
with
Biological Classification System
and
Intelligent Network Interface System

The IdP is a central identity provider in the OVE. It creates, maintains and manages identity information of OVE users and service providers. The STS or secure token server creates, and manages tokens for the OVE system. It is part of the single sign-on infrastructure used by the OVE system. The certificate authority server issues digital certificates with registered information including biometric signatures, ownership and authenticity, and validation of public keys of owners in the public key infrastructure system.

The encoding & decoding server and services provide efficient transmission and storage of media and data. OVE uses either the Java or Python form and is a method of representing data in a different format to efficiently transport through a network or web. In python encoding represents a unicode string of bytes. Decoding transforms this string of bytes back into a unicode string. This happens when you receive a string of bytes from a disk file or network.

DLT and blockchain are a secure was of conducting and recording transfers of digital assets. A distributed ledger is a system whereby replicated, shared and synchronized digital data is geographically spread (distributed) across many sites, countries of institutions. A decentralized database by multiple participants, across multiple nodes.

This model provides the platform for CID's. The IP file system (IPFS) or distributed data file system (DDFS) use a hashing algorithm including multihash. CID's contain the hash and code of the data. A CID can represent a string or simple binary format. The Biological Classification Database Systems is to compute a cryptographic hash of the block data combined with code information about the block. This includes a hash, code and base on how the hashed data is encoded. These hash functions check for file integrity.

Biological Classification System (previously Biological Classification Database System)

### Components

the classification database has an ingestion and validation model
a search index for queries
ingestion of:
i. phenotype taxonomy directory uses an Open Tree of Life taxonomy
ii. unique taxonomy phenotype profile database as the database key
iii. microservice & microBiological Classification Database Systemssors database and specifications
iv. using biological taxonomy with related microservices & microBiological Classification Database Systems or sensor biometric signaling definitions for scoring validity;
v. microservices & microBiological Classification Database Systemssors sensor biometric signaling definitions profile level scoring
the classification system can uses one of two or both types or modes of data storage: a graph based database with edges and nodes for bi-directional referential models; and the object oriented database for objects to query;
the purpose of having two types of databases is the object database set of classes is the biological taxonomy classification and is application independent and therefore the API is universal for ingestion and;
a hybrid mode or HyperGraph a combination of object-oriented and graph node edge based model or schema treats the objects as a payload and is an option with custom built queries;
the graph database allows the query to transverse the edge and node relationships or edge types and directions without loading the full nodes properties and attributes.
The biological classification database also includes related data stores that provide validation of the taxonomy or biological classification which include:
i. unique taxonomy phenotype profile database as the database key;
ii. microservice & microBiological Classification Database Systemssors database and specifications;
iii. related biological taxonomy to microservices & microBiological Classification Database Systems or sensor biometric signaling definitions;
iv. the microservices & microBiological Classification Database Systemssors sensor biometric signaling definitions assist in phenotype profile level scoring;
the combined object-oriented and graph data schemas provide solutions for queries and for storage of data.

An example of an OVE query upon biometric authentication would use the follow attribute data, operators and queries:

### Attributes

ordinal attribute which ranks value
nominal attribute provides descriptive information
interval attribute ranks order and absolute difference
ratio attribute ranks order and absolute difference

### Data

integers
float or real decimal number
text or string
date

### Boolean Algebra Query Operators

OR
AND
NOT

### Databases

Hierarchical
Relational
Geodatabases

The combination of these components provide the biological classifications database with the structure to determine from any type of query and result the scoring for each taxonomy or phenotype.

### Query.

### Attributes

ordinal attribute which ranks value being type of microservice or microBiological Classification Database Systems or biometric signaling
nominal attribute provides descriptive information about the microservice or microBiological Classification Database Systems or biometric signaling
interval attribute ranks order and absolute difference between the accuracy of the user phenotype to microservice or microBiological Classification Database Systems or biometric signaling
ratio attribute ranks order and absolute difference between microservice or microBiological Classification Database Systems or biometric signaling

### Data

integers
float or real decimal number
text or string
date

### Boolean Algebra Query Operators

does the phenotype match microservice or microBiological Classification Database Systems or biometric signaling OR
AND does the phenotype match microservice or microBiological Classification Database Systems or biometric signaling
if NOT then decline the login or account creation

### Databases

hierarchical taxonomy database;
relational for phenotype and microservice or microBiological Classification Database Systems or biometric signaling;
geodatabases location of login or account creation with device lookup in microservice or microBiological Classification Database Systems or biometric signaling database and verification of valid geo location and biometric authentication;

The datastores can reside on any of the OVE datastore and computing systems including IPFS, DDFS and DCE. The API is accessible for any OVE validated accounts.

Intelligent Network Interface System with OVE Session and Access System

### Components

The intelligent network interface (INI) provides session and access controls based on OVE validation and object or token status. If the user is not permitted access the system does not allow access into the secure OVE network or systems. This security and control blocks all replies and response and requests until OVE has updated the status for session and access.

The session access controls are conditional upon the access token being valid for the particular device or network node and service bridge device with biometric signaling session control permitted. Enforced restrictions include application, browser and other network and devices session access to the OVE secured network with continuous access evaluation for anomalies using the INI machine learning system.

The intelligent network interface (INI) has several different forms including machine learning and training on physical circuit and cloud based machine learning and training. The basic forms and types are as follows:
heterogeneous OVE INI chipsets with CPU and GPU
heterogeneous OVE INI chipsets within mobile devices
microservices with INI cloud based services
microBiological Classification Database Systemssors with INI cloud based services
INI virtual network functions with software defined network nodes
cloud based INT networks

The Intelligent Network Interface (INI) System uses an integrated machine learning and training architecture within a hardware and software based framework. The OVE INI chipset core chipset is provided in FIG. 6. This can be integrated into any device circuit with a profile and services that can support this type of heterogeneous chipsets.

The INI support is further provided for nodes and devices within the OVE system. This includes software and hardware profiles with virtual network functions with software defined network nodes. This also supports cloud based INI network for OVE. This INI model using cloud based service provides machine learning and training models for all data used within these nodes and microservice and microBiological Classification Database Systems or RCD or resource constrained devices.

### Services Bridge System

### Components

OVE System
Intelligent Network Interface (INI)
Container
User INI
Service Provider INI
Shared Datastore & Computing Environment
User Devices

### Object and Token Status Encoding System

### Components

OVE System
Intelligent Network Interface
Encoding Decoding Server
Encoding Decoding Services
Observability and Telemetry Services
Reporting Services
Update Services (checking with OVE system)

The encoding & decoding server and services provide efficient transmission and storage of media and data. A token status and end product encoding system; a network and storage object encoding system;

OVE uses either the Java or Python form and is a method of representing data in a different format to efficiently transport through a network or web. In python encoding represents a unicode string of bytes. Decoding transforms this string of bytes back into a unicode string. For example this happens when you receive a string of bytes from a disk file or network.

Objects include: network objects, storage objects, and objects that hold computing environments that hold application code and dependencies such as binary code, libraries, and configuration files for easy deployment across different computing environments.

### Services Bridge User Device System

### Components

OVE validation
intelligent network interface (INI) API
services bridge API
service provider API
wearables such as smart watches, jewelry, fitness trackers, clothing, glasses, earbuds, contact lenses, and implantables;
peripheral devices and sensors include internal and external that sends and receives biometric data;
IoT sensors and devices such as smart speaker, watch, phone, alarm, refrigerator, vehicle, fitness mirror, lamp, lock, and toys.
IoT environmental deices collecting data such as air quality, temperature, and humidity levels
real-time data from various sensors and devices

### Ownership and Authenticity Tracking and Logging System for Shared Datastore and Computing Environment

### Components

service bridge device metrics management system
i. threshold tracking and logging
ii. observability
iii. telemetry
iv. analytics
v. meta data
vi. biometric data
usage frequency
time spent using service bridge
time spent using services bridge devices
service bridge product use
service bridge feature use
service bridge and devices use trends
all service bridge use and traffic metrics

The ownership and authenticity tracking and logging system for the services bridge shared datastore and computing environment sends a report to the OVE validation engine after completion of each session. If the parameters allow or permit issuance an authenticity and ownership certificate is issued to the OVE account holder. The authenticity and ownership certificate issued by the OVE certificate authority and be any type of OVE permitted image or link to the CA server for validation.

### BRIEF DESCRIPTION OF THE DRAWINGS

To provide a more complete understanding of the exemplary embodiments, reference is now made to the appended drawings. These drawings should not be construed as limiting but are intended to be exemplary only.

FIG. 1, is a simplified diagram of the Simple Diagram of OVE, Intelligent Network Interface & Services Bridge for Development and Delivery of Intelligent Services of the invention in accordance with various embodiments described herein.

FIG. 2, is a simplified diagram of the On-Device OVE App with Biometric Validation of the invention in accordance with various embodiments described herein.

FIG. 3, the simplified diagram of the OVE Biometric Biological Classification Database components of the invention in accordance with various embodiments described herein.

FIG. 4, is a simplified overview of the OVE Account Setup & System Access and Services Bridge Biometric Authentication, IdP, DLT & SSO systems and access control components of the invention in accordance with various embodiments described herein.

FIG. 5, the simplified overview of the Custom OVE Biological Classification and Profiles Scoring & Threat Protection components of the invention in accordance with various embodiments described herein.

FIG. 6, a simplified diagram of the OVE Intelligent Network Interface (INI) Heterogeneous ML Chipset & Device with Multi-Channel Signals Processing using Advanced Bus & Controllers of the invention in accordance with various embodiments described herein.

FIG. 7, the OVE & INI Authentication & Authorization Systems with Secure OVE Network Flow components of the invention in accordance with various embodiments described herein.

FIG. 8, the simplified diagram of the OVE Account and Mesh Manager Components & Services of the invention in accordance with various embodiments described herein.

FIG. 9, the simplified overview of the OVE (Bio-Origin) Validated Objects Creation and Registration components of the invention in accordance with various embodiments described herein.

FIG. 10, a simplified diagram of the Mobile OVE (bio-origin) Validated User App Setup & Services Bridge Data Flow of the invention in accordance with various embodiments described herein.

FIG. 11, is a simplified diagram of the Services Bridge Control Layers Services, Access & Controls components of the invention in accordance with various embodiments described herein.

FIG. 12, is a simplified diagram of the User and ISAP Agent Profile Creation Environment of the invention in accordance with various embodiments described herein.

FIG. 13, a simplified diagram of the OVE Intelligent Services Provider Registration and Activation Flow of the invention in accordance with various embodiments described herein.

FIG. 14, is a Generalized Diagram of the Service Bridge Devices Validated User Connect & Biometric Signal Acquisition Flow of the invention in accordance with various embodiments described herein.

FIG. 15, the simplified overview of the Services Bridge User Devices Bio-Signals Controls and GUI/UI components of the invention in accordance with various embodiments described herein.

FIG. 16, a simplified diagram of the User Device Biometric Signals Physiological and Psychological Module Setup of the invention in accordance with various embodiments described herein.

FIG. 17, is a simplified diagram of the Services Bridge User Stress Detection and Feedback Loop Emotions Modeling of the invention in accordance with various embodiments described herein.

FIG. 18, the simplified overview of the OVE Services Bridge User Devices Threshold Manager Service & Settings components of the invention in accordance with various embodiments described herein.

FIG. 19, the simplified overview of the Services Bridge Project and Custom Workplace IDE components of the invention in accordance with various embodiments described herein.

FIG. 20, the simplified diagram of the Services Bridge Custom Platform and Virtual Machine (VM) Provisioning components of the invention in accordance with various embodiments described herein.

FIG. 21, the simplified diagram of the User and ISAP Roles Based Access Controls (RBAC) components of the invention in accordance with various embodiments described herein.

FIG. 22, is a simplified overview of the a OVE Syndication and Licensing with Authenticity & Ownership Certificate Issuance components of the invention in accordance with various embodiments described herein.

FIG. 23, the simplified overview of the Custom Services Bridge Media Development Platform with Ownership Tracking components of the invention in accordance with various embodiments described herein.

FIG. 24, the simplified overview of the OVE Services Bridge Multi-User Multi-Modal Multi-Device Management Platform components of the invention in accordance with various embodiments described herein.

FIG. 25, is a simplified diagram of the Custom OVE Public Datastores with Anonymized Bio-Signal Graph Management of the invention in accordance with various embodiments described herein.

### DETAILED DESCRIPTION OF DRAWINGS

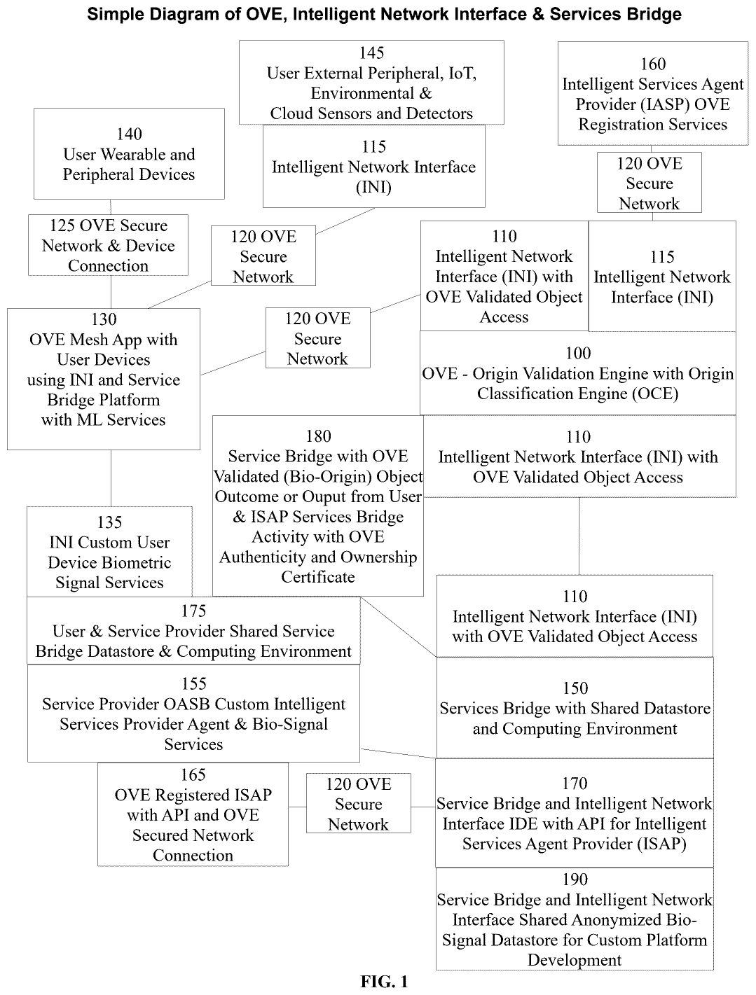

Referring to FIG. 1 is a simplified diagram of the Origin Validation Engine (OVE) System with Intelligent Network Interface (INI) and Services Bridge Platform for Development and Delivery of Intelligent Services of the invention in accordance with various embodiments described herein.

This simplified model and preferred embodiment provides OVE validated user (bio-origin) or OVE validation with biometric signal and biometric feedback stimuli and detection devices and systems with end-to-end secure biometric signals data acquisition and conditioning.

It should be obvious to those skilled in developing of identity, authentication and authorization models this can be many different models and forms depending on network and computing configuration and requirements. The following embodiments are exemplary and can be configured in many different forms and architecture. In no way is the following description limiting in scope or architecture.

This initial account creation provides an understanding of how the OVE system uses these traditional biometric profile creation models as a default account type for creation of OVE, INI and services bridge frameworks to deliver biometric signals services and connections to OVE validated user (bio-origin) validated users.

During this default account creation biological classification databases several components of the OVE privacy-protected and public datastores components are created. The default account creation biological classification databases uses protected datastores provisioned for use by OVE for updating OVE validated user (bio-origin) and biometric signals signatures and fingerprinting.

The OVE system and its components are protected by an INI OVE validated user (bio-origin) validation gateway. OVE validated (bio-origin) users and validated devices and software are protected within OVE and used by INI and services bridge biometric signal sessions for dynamic creation of products and services.

Connections between OVE system nodes and components use encrypted private networks. The Intelligent Network Interface “INI” resides in many different forms and architecture to provide system and network management and nodes. This closed system for OVE (bio-origin) validated user only devices and connections narrows the attacks scope and type and provides a more secure environment when interacting with intelligent services and service providers including agents in any form.

The services bridge uses a publicly available datastore to record and provide details on content generated using intelligent services. A syndication and distribution system with OVE validated user (bio-origin) validated ownership and rights with a machine readable encoding for terms and conditions of use. As well the OVE with service bridge user devices enabled bi-directional dynamic and real-time biometric signals activity tracking using observability and telemetry.

Authenticity and ownership rights are based on normal rates of activity versus online editing and automated services without ML. This biological classification databases provides a model to issue authenticity and ownership certificates using OVE validation and requirements from organizations that provide and enforce intellectual property rights.

The INI with services bridge and service bridge devices data include observability and telemetry using the OVE Mesh platform.

During interaction with the intelligent services agent provider (ISAP) in the services bridge shared datastore and computing environment biometric data and signals provide feedback for multimodal activity. Delivery of user biometric signals augments services bridge service provider generated outcomes or output.

The interaction can be any form of biometric signals or waves from any form of OVE validated user (bio-origin) biological classified and defined organism.

OVE creates a OVE validated user (bio-origin) OVE validated network and storage objects. An example is the OVE (bio-origin) validated object which holds a OVE validated user (bio-origin) profile of an environmental organism such as a tree. This type of OVE (bio-origin) validated object can be used to create environmental services such as carbon extraction footprints tracking using services bridge. OVE (bio-origin) validated object can hold the tree identity and receive data on it impact on the environment. As well this model could be used to protect forest blocks such as in the amazon and give to a charity as a donation.

Any type of phenotype taxonomy, genotype or any other taxonomy such as phylogenetic classification tree can be used by the biological classification database for an OVE account validated profile using a phenotype key.

As well OVE (bio-origin) validated objects can be used to securely exchange between OVE validated parties using the OVE protected and validated distributed ledger. It can also include terms of use or other parameters required for exchange. The OVE (bio-origin) validated object can include content generated in the services bridge including the type of outcome of output. Both OVE (bio-origin) validated object types can include ownership rights and details information with types of exchange platforms allowed. This includes for listing on public libraries.

Multi-channel multi-modal biometric signal machine learning framework for raw and conditioned biometric signals from OVE validated user (bio-origin) users within the mesh managed peripheral, wearable, IoT, cloud and other computing environment creates a multi-faceted global system for protected biometric signals data.

As an alternative embodiment a biometric signals global repository and vector symbolic hyperdimensional computing architecture can be used to deliver potential emergent behavior outcomes which could reveal new models and new system opportunities.

The OVE Mesh Platform Origin Validation Engine (OVE) with Biological Classification Database System 100 provides Bio-Authentication, Bio-Validation, and Bio-Authorization. INI 120 & 125 provides OVE System Session and Access Controls. These services protect access to the OVE Mesh platform using INI physical, virtual and network interfaces system controls. This provides validated users with a secure network for validated users only. As well the Intelligent Network Interface (INI) provides OVE Validated Object Access 110 115.

A Secure Distributed & Fragmented Bio-Data & Bio-Assets Storage system with OVE IdP, STS, CA & Content ID Services: IdP OIDC OpenID Connect; Secure Token Server (STS); Certificate Authority (CA) and Encoding & Content ID (CID) Manager delivers a flexible and comprehensive platform to protect biometric signals data including OVE App for on-device storage of raw biometric data.

The on-device and node OVE App 130 provides a CPU and GPU circuit model for use of machine learning and advanced biometric signal functions within the INI. This provides an On-Device Generative Heterogenous Chipset for a complete OVE, INI and services bridge application services and storage model for local biometric signal services and data in a privacy-protected storage.

Protection of the User provides the OVE Mesh Manager with INI OVE Account a Roles Based Access Controls “RBAC” for the OVE validated Users of the services bridge 150. Combined with the Origin Neural and Network Interface “INI” the services bridge can create OVE validated assets with user devices (service bridge devices) biometric signals connection and validation of use and activity with threshold metering.

A biological classification database with INI network functions and daemons using the INI 115 ML Pattern and Matching validation protect system enrollment and login bio-validation 130.

A transparent phenotype, signaling and microservices and microprocessors directory delivers a publicly accessible biological classification database 100. These open directories allow users to define new OVE models and profiles with the real human control of Individual or Group hereinafter defined as “OVE Account” Profiles for multi-user, multi service provider architecture.

### Intelligent Services & Providers

An Intelligent Service Agent Provider (ISAP) 165 users the services bridge Platform with OVE validated user (bio-origin) validated User an interactive environment for creation of product and services or more technically outcomes and output. This platform provides service providers custom built intelligent services with biometric signal integration and delivery of services 155. This privacy-protected services bridge platform provides an API and development environment IDE for service providers 170 to customize delivery and provision offerings.

User external peripheral, IoT, environmental & cloud sensors and detectors 145 provide the service bridge with biometric signals connections to the shared datastore and computing environment in the services bridge.

The services bridge utilizes a shared datastore and computing environment “SDCE” 150 & 175 for exchange or outcomes and output between the user and service provider. This can include the use of a user devices service bridge tracking model 135 to validate ownership of products and services generated within the services bridge platform.

The OVE Mesh 130 observability and telemetry system tracks metrics of use on the services bridge platform. This data and analytics provide information on user contribution to the service bridge outcome and output. OVE Mesh App with User Devices using INI and Service Bridge Platform with ML Services 130.

The services bridge can be designed to model work with many different types of modalities and types of biometric signal feedback interaction. The preferred embodiment includes emotion modeling using a wristband with sensors. The types of sensors are not limited to current health and sports watches and can include any form of biometric signals device. The acquisition and response to biometric signals can be any form of wired, wireless or hybrid including waves.

The service bridge users devices delivers the raw or conditioned biometric signal data.

The setting of automated emotion profiling involves user feedback based on selected modality modeling and signature set by either the user or service provider.

Emotion modeling is exemplary and does not limit the types and use of modalities, sensors, or interactive biometric signals response of the OVE system and services bridge platforms.

### OVE Validated User (Bio-Origin) Objects

OVE and services bridge create OVE validated user (bio-origin) network and storage objects 100 110. These objects can be in many forms and type of structure. An example is the OVE (bio-origin) validated object can hold the OVE validated user (bio-origin) profile of a account holder. Any type of taxonomy including phenotype and genotype such as phylogenetic to classify a tree could be the OVE validated assets within the OVE (bio-origin) validated object.

The OVE (bio-origin) validated object can be used as an object of exchange between OVE validated parties using the OVE distributed ledger technology for OVE validated users only. It can include terms of use or other parameters required for exchange of services bridge products and services. OVE (bio-origin) validated object can include content generated in the services bridge including the type of outcome of output. OVE (bio-origin) validated object types can include ownership rights and other OVE validated user (bio-origin) rights details information including types of exchange platforms the object is provisioned.

The simplified diagram and flow provides a simplified architecture of OVE and INI services bridge framework. It should be understood that OVE is a OVE validated user (bio-origin) classification and biometric signals management platform with an INI gateway to provide OVE validated user (bio-origin) validated session and access controls. The services bridge with service bridge devices provides advanced OVE validated users and services providers with advanced interaction within a protected platform and human wearable devices for biometric signals detection of metrics that can augment or change the outcome of the service provider product or service.

Service Bridge and Intelligent Network Interface IDE with API for Intelligent Services Agent Provider (ISAP) 170 provides the platform and API for custom development of the OVE services bridge. Service Bridge and Intelligent Network Interface Shared Anonymized Bio-Signal Datastore for Custom Platform Development. The Service Bridge and Intelligent Network Interface Shared Anonymized Bio-Signal Datastore for Custom Platform Development 190.

User & Service Provider Shared Service Bridge Datastore & Computing Environment 175 with INI Custom User Device Biometric Signal Services 135.

Service Bridge with OVE Validated (Bio-Origin) Object Outcome or Output from User & ISAP Services Bridge Activity with OVE Authenticity and Ownership Certificate from OVE+INI+service bridge devices+services bridge threshold use activity validation data 180.

This transparent model provides anonymized permissioned biometric signals datastores for development of Personalize Medical Repositories & Applications (PMRA) 190. These platforms includes data from all OVE validated user (bio-origin) validated users who allowed updating of this global datastore for medical professionals.

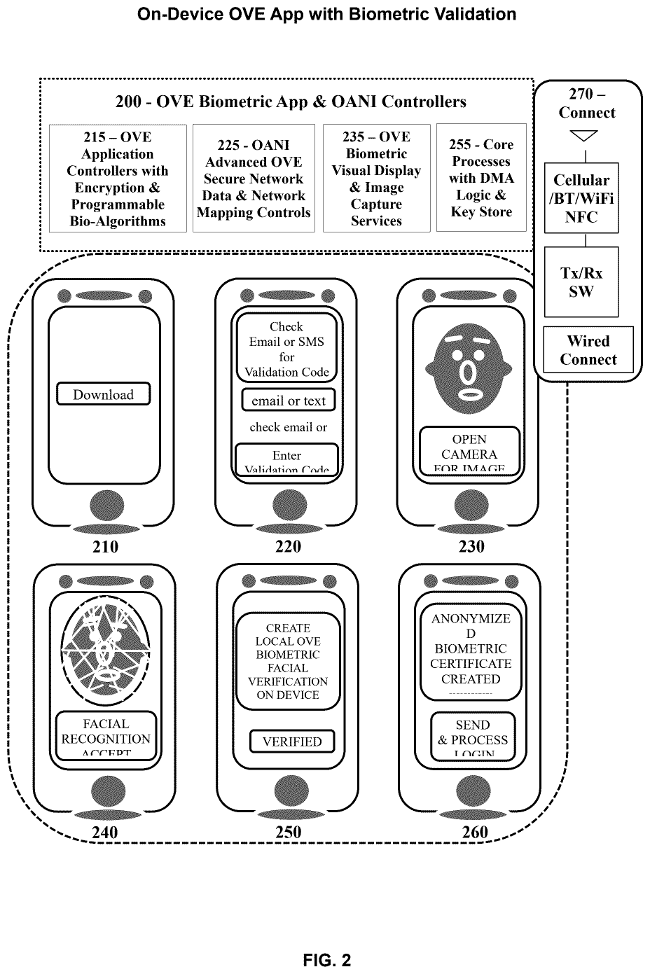

Referring to FIG. 2 is a simplified diagram of the OVE App Biometric Account Creation and Login Component of the invention in accordance with various embodiments described herein.

### Biometric Account Creation

Create a default biometric users account and Unique Phenotype ID “UPID”.

The OVE validated user (bio-origin) identity and authentication utilizes a classification engine (biological classification database) combined with a BAAC confidence scoring system to provide the necessary data for defining entry permission profiles into the OVE system and network.

The OVE identification and classification framework creates user privacy-protected security objects. Security objects can include tokens and other types of network and storage objects that securely validate users.

OVE validated user (bio-origin) users can be any phenotype or genotype of organism. A default human profile is used for OVE validated user (bio-origin) human account holders.

Privacy-protected objects or OVE validated user (bio-origin) Validated Objects (OVE (bio-origin) validated object) can include any form of digital or digitally linked information to objects identifying properties or assets excluding default human.

The OVE system creates an end-to-end biometric signals connection within OVE validated user (bio-origin) validated systems and network. This model provides a real time biometric signals connection for interaction between the user and Intelligent Network Interface (INI) and gateway.

This real time network connection enables exchange of biometric signals between users and intelligent service providers. It also adjusts latency and removes noise from these connections for the highest quality bi-directional biometric signaling data possible.

These network connections can be encrypted private network or virtual private network VPN services mapped by INI gateway nodes and devices.

This validation model is based on an event driven data flow.

### OVE Validated User (Bio-Origin) User Authorization

An OVE validated user (bio-origin) type can be any type of taxonomy classification including phenotype and genotype. A OVE validated user (bio-origin) profile can be part of a privacy-protected object or within token claims.

The OVE validated user (bio-origin) classification provides intelligent service providers with information about the users of their services. The account holder and user of intelligent services can be different. A privacy-protected object can have a definition of almost any OVE validated user (bio-origin) defined profile. The intelligent services provided can be almost any type of service the OVE validated user (bio-origin) profile.

The scope of the OVE platform includes personalized medicine and treatment development such as preventative health suggestions.

The OVE authorization of validated OVE validated user (bio-origin) users uses a permissioned based system. The OVE account holder requests the service providers product or service and based on the type of registration the service provider automatically or manually accepts or approves access based on pre set or trained criteria.

### 200—OVE INI Biometric App

In this embodiment we used a facial verification system embedded in a mobile app. This biological classification databases is part of enrollment or verification of identity including during login in the OVE and to keep the users raw bio-data private. A bio-authentication application python facial verification engine with living facial recognition framework. The bio-authentication app may be used for any number of methods or combinations including but not limited to fingerprinting, iris and voice. The application after verification sends an OpenID Connect bio-authentication certificate to initiate the biological classification database creating the ID and Access Tokens for access to the OVE Mesh Manager and OVE resources. The bio-authentication certificate has a limited lifetime based on threat management and bio awareness access control threat management and scoring.

210—The User downloads the OVE Biometric Authentication App. The system loads the application and creates the INI Advanced OVE Secure Network Data & Network Mapping Controls 225.

220—The User enters their credentials and initiates the biometric authentication biological classification database.

230—The INI Biometric Visual Display & Image Capture Services 235 is activated by the Application OVE Accounts with Encryption & Programmable Bio-Algorithms 215 which opens the camera for multiple images with characteristics of features. The images are biological classification database and stored in the a protected registry using the direct memory access (DMA) 255 and secure special function bus (SFR).

240—The facial verification and recognition application extracts 27 major landmarks into a 2-dimensional facial image. It then creates a 3-dimensional facial learning data compiled as a 3-dimensional portrait by extracting the major landmarks. This is biological classification database uses multiple images created during camera capture. The facial verification capture is authorized by User. The comparable living facial template is registered in the mobile protected zone 255 on the device. A protected memory with multiple facial verification images are saved on the device datastore for living facial verification.

250—The mobile biometric application then creates a bio-authentication certificate for the biometric data validation biological classification databases and stores it in the protected key zone 255 for delivery to the OVE Manager using the device Connect services 270. A mutual TLS connection is created and keys exchanged to provide a secure channel to record the certificate in the OVE IdP.

260—The mobile biometric authentication application sends the “bio-authentication certificate” 270 along with device specific data to OVE to initiate the authentication and validation biological classification databases for OVE login and SSO access using a protected wireless connection and OVE secure network.

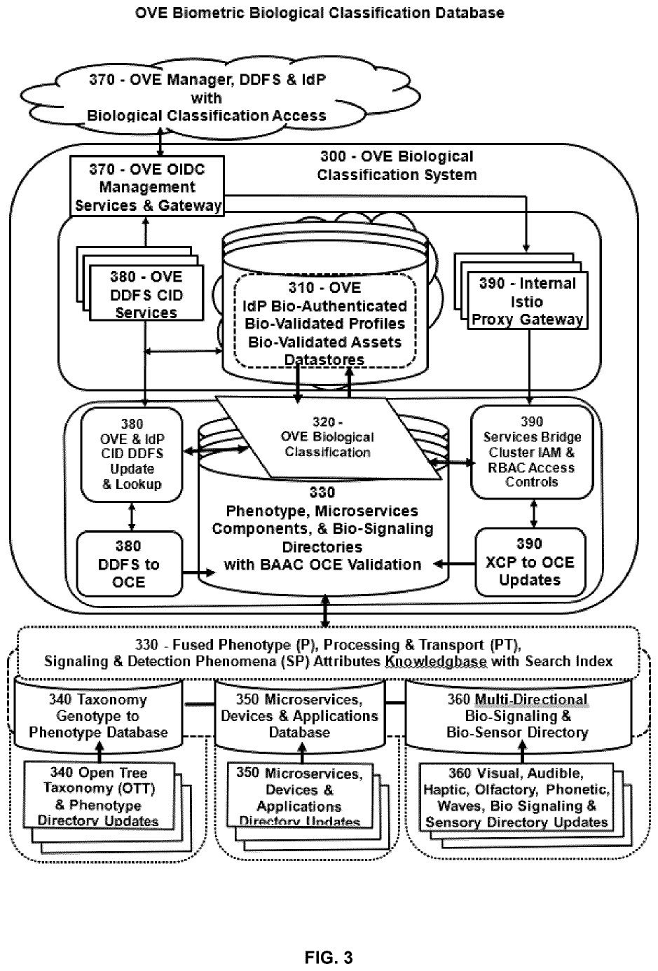

Referring to FIG. 3, the simplified diagram of the OVE Biometric Biological Classification Database components of the invention in accordance with various embodiments described herein.

This embodiment is a OVE Validated User (bio-origin) Biometric Biological Classification Database for Authentication and Verification of Identities within the OVE Mesh and Services Bridge System. The controls and types of frameworks available are limited only by the needs of the Users.

The Biological Classification Database System 300 is an event based engine with a public directory used by OVE 380 and services bridge 390 services & components. Combined with the INI daemons and machine, deep learning and threat protocol this provides flexibility in defining OVE Users. OVE integration also provides validation scoring with real time INI observability. It also provides an underlying inference and learning and training model for the OVE Systems services bridge DCE Cloud-Fog-Edge Hub, Node Datastores.

The OVE Components 310 utilizing the biological classification database include: OVE IdP Bio-Authenticated Bio-Validated Profiles and Bio-Validated Assets Datastores. The Biological Classification Database System 320 syncs data from the community based biological classification database data for validated OVE Users and services providers. Phenotype, Microservices and Microprocessor Components with Biometric Signaling Directories provide Validation & Scoring 330 use the biological classification database Fused Phenotype (P), Biological Classification Database & Transport (PT), Signaling & Detection Phenomena (SP) Attributes Knowledgebase with Search Index for scoring of Bio Awareness Access Controls Enrollment and Login Validation. Scoring data. Anonymized bio-data is used and exported to OVE protected learning and training data lakes OVE validated user (bio-origin) inference & classification optimization.

In this embodiment the biological classification database directory is divided into three segments: Taxonomy Genotype or Phenotype; Microservices & Microprocessor Devices and Applications; & Multi-Directional Device and Sensor Biometric Signaling 360.

The genotype taxonomy to phenotype directory 340 provides the default profiles for the Unique Phenotype ID (UPID) profiles used by the OVE Manager during enrollment. The microservices, devices & applications directory 350 pulls from the XCP sensors and devices datastores and available and update feeds. A combined phenotype, microservices components & multi-directional biometric signaling & bio-sensor directory and database 360 provides a directory for biological classification database default profiles of Users updated in real time including by community OVE validated Users 370.

The phenotype taxonomy directory uses an Open Tree of Life Taxonomy 340 to provide a deep genotype database hierarchy. Phylogenetic trees are ranked, aligned and merged and can be updated or edited by OVE authorized community datastore Users.

The biological classification database public or community based datastore phenome and phenomics directory includes API connections for personalized medicine application and datastores with OVE protected and validated users.

### Personalized Community Medicine Forum

The community based model with protected User data provides phenotype biological classification database models for OVE to create anonymous Users with observable characteristics or collection of traits. Personalized Medicine requires OVE with Input Validation for manual update of biological classification database Directories.

The phenomics are used to figure out which genomic variants the User profiles in the OVE Mesh services bridge are connected and can identify things like health, disease, and evolutionary fitness. Phenomics forms a large part of the Human Genome Project. The biological classification database is designed to deliver multiple applications and services for personalized medicine including drug therapy.

Using phenomics this protocol also has applications in agriculture including to create more durable GMOs.

A primary key in the biological classification database directory is the biological classification database Phenotype including base phenotypic genetic variation. The biological classification database model uses phenotype as an attribute for enrollment and validation scoring. A default enrollment and login Unique Phenotype ID (UPID) profile is created during provisioning of initial services activation with creation of the default OVE services bridge platform access controls and permissions.

All taxonomies assign ranks to their nodes, the seven main ones being domain, phylum, class, order, family, genus and species. The phenome would be the material basis of the phenotype, just as the genome is the material basis of the genotype

The default genotype taxonomy to phenotype has a genotype environmental interaction field available for OVE and services bridge when used in the field of medicine.

genotype (G)+taxonomy/environmental (E)+Genotype & Environmental Interaction (GE)→Phenotype (P)

The microservices, device and applications directory provides the device and transport definitions for the biological classification database event.

microservice (M)+device (D)+application (A)→Biological classification Database & Transport (PT) Attribute

The multi-directional biometric signaling & sensor directory provides the communication and biometric sensory material definitions.

biometric signal (B)+biometric sensor (S)→Signaling & Detection Phenomena (SP) Attribute

The polymorphic ad hoc community directory and database used by biological classification database then takes a combination of these attributes and calculates the value for the OVE enrollment and validation system. The example below has been simplified and can contain a plethora of different definitions from one or a combination of directories.

Directory Score (1 is yes)
Phenotype (P) 1
Biological classification Database & Transport (PT) Attribute
Facial Verification Characteristics “≥25” 1
Multi-Imaging Raw Datastore 1
Signaling & Detection Phenomena (SP) Attribute
Living Facial biometric signaling 0
Total 3
Number of Attribute Categories & Records 4

The score is between 0 and 1 is to optimize the application of machine and deep learning for the OVE & biological classification database. The total of the categories in this example is 3 and the number of attributes in each was 4 so the value for scoring is ¾ or 0.75 or a validation score of 75%. If the threshold is above 66% this would allow the enrollment and activation biological classification databases to biological classification databased. OVE Biological Classification Database System would optimize the scoring based on the OVE knowledgebase and threat protection matrix.

This directory and algorithmic structure provides flexible application of User OVE Mesh profiles and environmental attributes for granular modeling of User health and wellness. It also provides the combination of environmental+phenomena metrics data with the Microservices and Components Directory. It also provides a fusion of Taxonomy/Phenotype & Microservices/Components with biometric signaling for creation of sub-class phenotypes within the Open Tree Taxonomy OTT and related taxonomy referenced databases other taxonomies including plant.

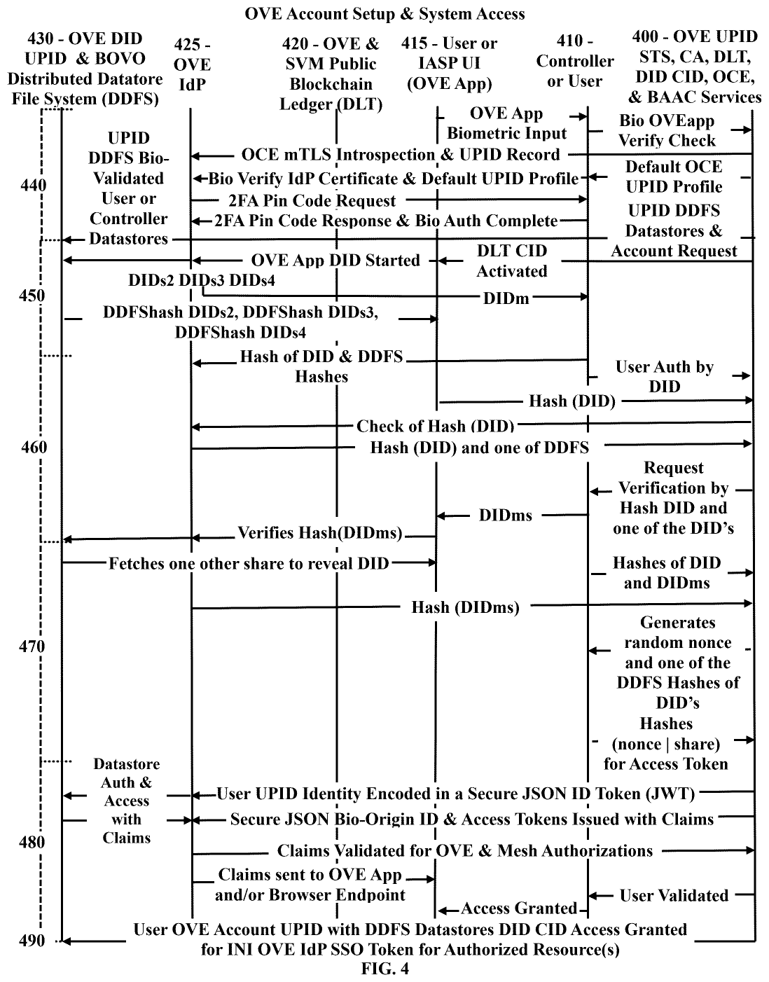

Referring to FIG. 4 is a simplified overview of the OVE Mesh and services bridge bio-authentication, IdP, DLT & SSO systems and access control components of the invention in accordance with various embodiments described herein.

This embodiment is an OVE Mesh and services bridge access control system for services and components of the OVE ecosystem including SVM. The controls and types of frameworks available are limited only by the needs of the Users.

Biometric Verification, Enrollment & Login with Origin Validation Engine (OVE), IdP, Distributed Data System and issuance of OIDC SSO JWT Tokens for global OVE authentication and authorization of the invention in accordance with various embodiments described herein.

The OVE Unique Phenotype ID, Secure Token Server, Certificate Authority, Distributed Ledger Technology (DLT), Distributed Datastore File System (DDFS), DID, Content ID “CID”, Biological Classification Database System provides the OVE with integrity for all OVE activities 400. The OVE Account or User 410 utilizes the OVE App 415 to enroll and login to the OVE Mesh platform and INI. The OVE & OVE (bio-origin) Validated Object Blockchain Ledger (DLT) 420 provides tracking of all OVE account data and OVE (bio-origin) Validated Object activity including transfers.

The OVE IdP 425 is default IdP which can be integrated into almost any IdP provider. It uses a human taxonomy and is a default taxonomy in the Origin Classification engine (biological classification database) for biometric human device account requests.

The OVE DDFS asset management service creates a proprietary asset file, breaking the encrypted code into tiny “nonsense” shards, and sending these shards to numerous different computing nodes on the decentralized computing network.

It provides the OVE validated Owner with a private key in their SSO Claims and Token to locate in the network the asset and link and how to reassemble or “decrypt” the file.

A distributed ledger is sent to multiple peers collectively adhering to a protocol for inter-node communication and block validation.

The OVE DID UPID & SVM Distributed Datastore File System (DDFS) 2130 provide protected privacy focused datastores for OVE and OVE (bio-origin) Validated Transactions and Services Bridge User Account Assets.

440—Biometric Verification & Authentication, Enrollment and OVE Login

A biometric authentication mobile app with biometric (facial in this embodiment) recognition system embedded and used for initiation User validation, creation and access to OVE Mesh Services Bridge. The bio-authentication biological classification databases starts with downloading the app.

The User provides an Image Capture from the Mobile Device Camera as a Biometric Input of User or OVE Account (User)

The Mobile App creates a Unique OVE validated user (bio-origin) Profile (BOP) Code after Anonymized Biometric Input completed and Sends to OVE for Validation.

biological classification database mTLS Introspection & UPID Record

OVE Utilizes biological classification database to Validate Biometric Input Classification and Creates a Unique Phenotype ID (UPID) File

Default biological classification database UPID Profile Created

### Bio Verify IdP Certificate & UPID Profile Record

A 2FA Pin Code is sent to the Email Address or Mobile Phone by Text

The User Enters the Random Code

FA Pin Code Response & Bio Auth Complete

OVE Confirms Biometric Auth Complete and UPID DDFS Datastores & Account Setup Request for OVE Account

Distributed Ledger Technology (DLT) Content ID Activated

OVE App DID Started

450—Distributed Datastore Identity and Registration Phase for OVE User Access

The unique biometric code is received and a valid identity is created for the user that complies with W3C DID standards. The user distributed data access validation phase begins.

A DID passed to a (1, 3, 4) scheme SSHGenerate to generate four shares (DIDms, DIDs2, DIDs3, DIDs4) as per the OVE App ID Algorithm, out of which the first share is mandatory to regenerate the DID.

The DIDms reveals the DID on combining two of the remaining three shares. The DIDms is kept private and secure in the U (User) OVE account.

The three shares (DIDs2, DIDs3, DIDs4) are stored in the OVE DDFS. These shares can now be accessed with their hash values DDFSHash (DIDs2), DDFSHash (DIDs3), DDFSHash (DIDs4).

Finally, (HASH(DID)∥HASH(DIDms)∥DDFSHash (DIDs2)∥DDFSHash (DIDs3)∥DDFSHash (DIDs4)) are submitted to the Blockchain by the OVEapp.

460—Distributed Datastore Access Authentication & Authorization

In this phase, the User U uses the Decentralized Identity (DID) to setup SSO (single sign-on) access to the OVE Account Data.

U (User) visits OVE App's and using IdP and provides the DID

The OVEapp calculates the Hash(DID) and sent to the OVE

OVE now verifies the Hash(DID) from the Blockchain to confirm the existence of the Hash(DID) U (User)

If the provided DID belongs to the valid U (User), then (Hash(DID)∥OneOf(DDFSHash (DIDs2), DDFSHash (DIDs3), DDFSHash (DIDs4))) is provided by the Blockchain to the Origin Validation Engine (OVE).

OVE now uses OneOf(DDFSHash (DIDs2), DDFSHash (DIDs3), DDFSHash (DIDs4)) to fetch one of the shares from the DDFS.

OVE requests for verification from U (User) by providing (Hash(DID)∥OneOf(DIDs2, DIDs3, DIDs4)).

U(User) now uses the DIDms similar to a private key or password to authenticate and submit the same. The OVEapp calculates the Hash(DIDms) to verify it from the Blockchain.

If the hash is found matching, then the OVEapp fetches one other share from DDFS and performs a combination operation, SSHcombine (DIDms, OneOf(DIDs2, DIDs3, DIDs4), Other(DIDs2, DIDs3, DIDs4))) to reveal the DID as given in OVEapp Access Algorithm.

The U (User) now shares the Hashcalculated (DID)∥Hash(DIDms)) to the OVE Manager.

### 450—(HashNonce+Share) Verified for Access Token OIDC Claims

The OVE Manager now verifies the Hash(DIDms) from the Blockchain and verifies Hashcalculated(DID) by U (User) is same as Hash(DID) it got initially, thus successfully verifying the U (User).

The OVE Manager now generates a random nonce (w) and sends (w∥OneOf(DDFSHash (DIDs2), DDFSHash (DIDs3), DDFSHash (DIDs4)) to the U (User).

The U (User) now uses OneOf(IPFSHash (DIDs2), IPFSHash (DIDs3), IPFSHash (DIDs4), to fetch one of the shares from the IPFS as given by OVE Manager, and (Hash(w+OneOf(Share)) is computed. This computed hash value (HashNonce+Share) is returned to the OVE Manager.

OVE Manager now verifies (HashNonce+Share) and passes along for Access Token OIDC Claims.

480—SSO Access to INI, OVE Mesh, Manager and services bridge Control Panel

User UPID Identity Information Encoded in a Secure JSON ID Token (JWT)

Secure JSON OVE validated user (bio-origin) ID & Access Tokens Issued with Claims

Claims Validated for OVE & Mesh Authorizations

Claims Sent to OVEapp and/or Browser Endpoint

User Validated

SSO Access Granted for OVE Mesh and OVE DDFS Account Data

490—User OVE Account UPID with DDFS Datastores DID CID Access Granted for INI OVE IdP SSO Token for Authorized Resource(s)

Upon successful enrollment or validation the OVE User has access to the OVE Account and Mesh Manager.

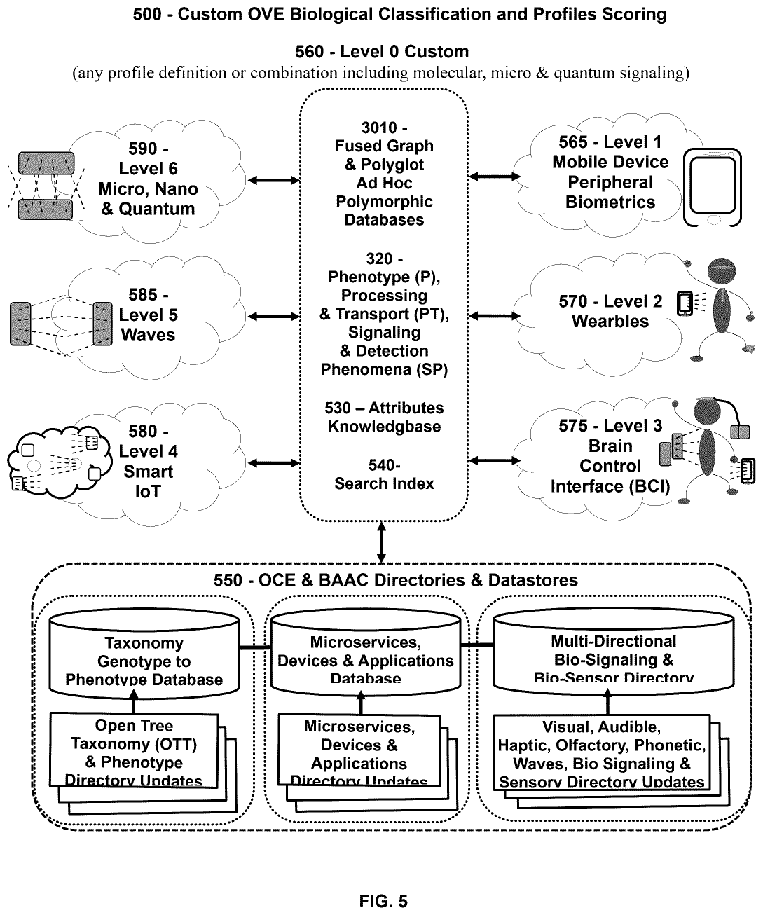

Referring to FIG. 5, the simplified overview of the OVE biological classification database OVE validated user (bio-origin) Profiles with BAAC Scoring & Threat Protection components of the invention in accordance with various embodiments described herein.

This embodiment is an OVE Biological Classification Database System with OVE Validated User (bio-origin) Profiles & Threat Protection Architecture for Services & Components of the OVE Mesh Management System. The controls available are limited only by the needs of the Users.

The OVE biological classification database and OVE Validated User (bio-origin) Profiles utilize the biological classification database datastores to create a default human account profiles for rating validity of OVE validated user (bio-origin) classification for validating and classifying sensors and detectors modeling for selected taxonomy or organism application. The default profile with facial recognition and mobile app is human.

### Human Taxonomy

Domain: Eukaryota
Kingdom: Animalia
Phylum: Chordata
Class: Mammalia
Order: Primates
Suborder: Haplorhini
Infraorder: Simiiformes
Family: Hominidae
Subfamily: Homininae
Tribe: Hominini
Genus: Homo

The default can be changed for creation of any new ISAP profile or OVE (bio-origin) validated object asset such as Plant Taxonomy. The biological classification database datastore 530 utilizes a Phenotype analysis with Phenotype (P) 540, Biological classification Database & Transport (PT) 550, Signaling & Detection Phenomena (SP) 550 directories. A Custom biological classification database OVE Profiles, Scoring & Threat Protection system analyzes and tracks ratings of OVE default profiles including using an Attributes Knowledgebase 530 with Fused Graph & Polyglot Ad Hoc Polymorphic Databases 510.

A Search Index 540 is created for OVE biological classification database operations and biological classification database directories & datastores 550.

### Default Profile Levels and Graph and Vector Datastores Include:

Level 0 Custom 560
Level 1 Mobile Device Peripheral Biometrics 565
Level 2 Wearables 570
Level 3 Brain Control Interface (BCI) 575
Level 4 Smart IoT 580
Level 5 Waves 585
Level 6 Micro, Nano & Quantum 590

The totality of the data sets provides learning and training data for machine learning algorithms to optimize the classification system including the use of:
Phenotype (P) 540
Biological classification Database & Transport (PT) 550
and Signaling & Detection Phenomena (SP) 550

The raw biometric, OVE validated user (bio-origin) data and biometric signals biological classification database datasets provide further validation and threat protection for the OVE System.

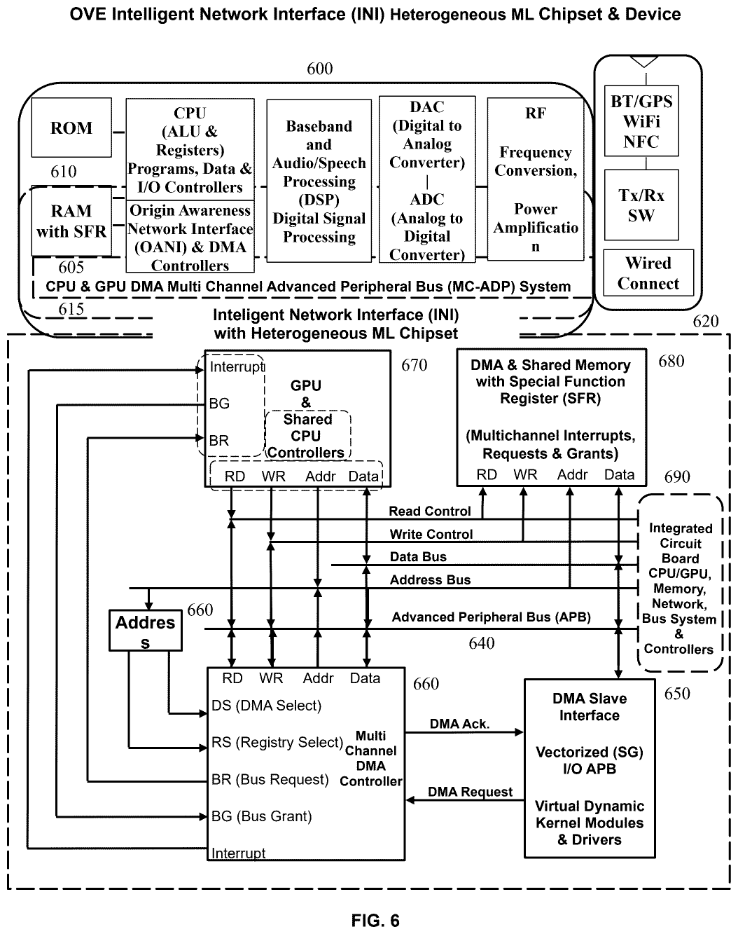

Referring to FIG. 6 a simplified diagram of the OVE Application Origin Awareness Network Interface (INI) with Heterogenous Chipset and Multi-Channel Signals Biological Classification Database System using Advanced Bus & OVE Accounts of the invention in accordance with various embodiments described herein.

This OVE Application embodiment uses a peripheral nervous systems model widely spread in the whole body. Abridge for the transmission of neural signals. Signals from the central nervous system (brain and spinal cord) are transmitted to different parts of the body by the peripheral nerves, while along the way they also feedback all kinds of sensory information. The Intelligent Network Interface (INI) is am n-tier designed biometric signals neural and network interface gateway with service bridge.

Hardware interfaces exist in many components of devices we use today, such as the various buses, storage devices, other I/O devices, etc. A hardware interface is described by the mechanical, electrical, and logical signals as the interface and the protocol for controlling and managing signals and data input and output. For this invention sequencing biometric signals and biological classification Database the raw data to conditioned signaling allows for classification of methods of biometric signal acquisition and models of interaction.

The INI interface decouples the design and introduction of computing hardware, such as I/O devices, from the design and introduction of other components. This architecture allows users and manufacturers flexibility in the implementation of OVE and INI on their computing networks and systems. The INI hardware/software design allows all version of this framework within all forms of computing technology including Quantum.

The hardware and software interfaces protocols are designed to run in and with several electrical connections carrying parts of the data simultaneously or serial where data are sent one bit at a time. This provides a mechanism to biological classification databases OVE validated user (bio-origin) biometric signals in a shared bus architecture and utilize a separate memory store using DMA 650 & 660 and SFR 610. It also provides for the mechanism to store protected data in a DRM protected memory register address 610 & 680.

A software interface version of INI offers a wide range of interface or “levels” from advanced heterogeneous to resource constrained devices (RCD). The purpose of this level of disclosure is to explain the scope of potential applications of INI within the OVE network and system and how it is critical to operation and threat protection.

Using granular controls of signaling and data including secure and operating OS storage an operating system may interface to many pieces of hardware provisioned within this disclosure and n-tier model for the disparate device, software and firmware required for optimized delivery of OVE and services bridge services.

Applications or programs running on the operating system may need to interact via data streams, filters, and pipelines using a hardware component such as INI at its core or INI as the gateway to network access. Using software and hardware interface models and modules provides flexibility and control including use of OVE validated universal system and network devices and operating software defined functions. OVE operates on an API's with agnostic OS framework and OVE mesh platform.

One example of object oriented programs, objects within an application may need to interact via methods such as modules as presented in this preferred embodiment. These objects, modules and applications within an OVE system would have been validated by OVE and secure within the operation of this validation solution.

In reference to the INI the Direct Memory Access (DMA) 605, 650 & 660 combined with an Advanced Peripheral Bus (APB) 615 & 640 provides high-bandwidth direct memory access between the mapped memory and stream-type target peripherals. This also includes high-bandwidth direct memory access within the GPU and CPU management system. An optimized solution for machine learning and training.

Scatter-Gather capabilities offload data movement tasks from the Central Biological classification Database Unit (CPU) 670 in biological classification databasessor-based systems to GPU 670 for quantum modeling. This biological classification databases and design allows the INI to perform high level signaling and data management biological classification database without large drain on battery life for a broad range of technologies and sensor systems including modeling and real time fingerprinting and signatures of time based slices for use with the service bridge user devices and OVE mesh observability and telemetry services for validation of user ownership and biometric signal interaction during creation of content using intelligent services. Below are core functions used for the real time operation and efficient results of outcomes and output during integration with any platform and INI.

### Slave DMA Interface 250

Vectorized (SG) I/O, Peripheral, Devices APB—Virtual Dynamic Kernel Modules & Drivers. Initialization, status, and management registers are accessed through a slave interface.

### Stream Compliant

Scatter/Gather (SG) DMA support. When Scatter/gather mode is not selected the IP operates in Simple DMA mode.
1. Data Re-Alignment Engine
2. Control and Status Streams
3. Keyhole support

### Micro DMA Mode Support

The Scatter/Gather (SG) Vector Addressing or Vectored I/O is a method of input and output by which a single biological classification databasedure call sequentially reads data from multiple buffers and writes it to a single data stream, or reads data from a data stream and writes it to multiple buffers, as defined in a vector of buffers. Scatter/gather refers to the biological classification databases of gathering data from, or scattering data into, the given set of buffers. Vectored I/O can operate synchronously or asynchronously. The main reasons for using vectored I/O are efficiency and convenience.

The APB 640 combined with the SG or Vector Addressing provides biometric signals with Biometric Signature Extractor and Generator services with are biological classification databasessed to create a multi-modal biometric OVE validated user (bio-origin) neural signature profile.

### The Multi Channel DMA 660

1. Supports 16 or more independent channels
2. per Channel Interrupt control of output
3. data realignment engine (DRE) alignment for streaming data time sync
4. 64 MB Buffer Descriptor (BD) transfers for neural origin signature extraction and memory storage.

### Stream Control and Status Streams

This multi channel support combined with the APB 640 delivers the data and biometric signals streams to the Neural Origin Signature Extractor (NOSE).

This allows different streams with different its own descriptor queue and different packet types. This allows granular control of the Origin Awareness Sensor Network (OASN) to gather multiple types of biometric signals including image, voice and text.

Location for biological classification Database and creation of a raw biometric signature upon detection and acquisition of biometric signals provide descriptors for the INI to protect and manage services necessary to validate OVE validated user (bio-origin) human and biological classification database classified OVE validated user (bio-origin) taxonomies.

A direct memory access (DMA) OVE Account comprises a transmit circuit and a data flow control circuit coupled to the transmit circuit.

The transmit circuit is configured to perform DMA transfers, each DMA transfer described by a DMA descriptor is stored in a data structure in memory.

The data flow control circuit is configured to control the transmit circuit's biological classification Database of DMA descriptors for each DMA channel responsive to data flow control data in the DMA descriptors in the corresponding data structure.

DMA APB SFR 610 & 680 The Direct Memory Access (DMA) 605, 650 & 660 peripheral is a byte-wide transfer system copies data from Program Flash Memory, Data EEPROM, General Purpose Registers (GPR) and Special Function Registers (SFR) 610 & 680 to General Purpose or Special Function Registers. The transfer is transparent to the CPU or GPU 670 and can be configured to interleave its transfers with the biological classification databasessor's operations or suspend biological classification databasessor operations until the DMA 605, 650 & 660 transfer is complete.

The INI system capture and controls these functions with DMA 605, 650 & 660 transfers triggered by software and a variety of CIP trigger signals including clocks, timers outputs, comparators, communication peripherals, as well as CLCs. DMA transfers to operate as one-shot transfers or configured to run continuously until stopped by either software intervention or a hardware CIP-based abort trigger.

The following explains the steps during biological classification databases these requests and configuring the DMA 605, 650 & 660 for optimization of peripheral and service bridge devices services 640.

The DMA 605, 650 & 660 can manage the peripheral 615 & 640 streams including:
1. Source and destination memory address;
2. Source and destination message sizes;
3. DMA trigger events;
4. DMA abort events (optional);
5. DMA automation;
6. DMA interrupts (optional);
7. DMA priority and enabling of the overall DMA peripheral;
8. The source and destination memory addresses include both the address and the type of memory;
9. EEPROM, Flash Program Memory or SFR/GPR 610 & 680 data memory.

DMA 605, 650 & 660 can be source data from EEPROM, Flash Program Memory and SFR/GPR 610 & 680 data memory, but can only use GPR/SFR 610 & 680 memory as a destination.

The APB combined with the SG or Vector Addressing model provides the INI 600 & 620 hardware version with biological classification database to create the multi-modal biometric OVE validated user (bio-origin) profile services.

These circuit level signaling controls are used in the service bridge devices physiological and psychological controls necessary for integration into the service bridge and Service Providers applications. The APB or Advanced Peripheral Bus 615 & 640 combined with DMA Slave 650 and DMA 605 & 660 addressing provides Signal level controls depending on whether the signal is active-HIGH or active-LOW for Multi Channel Advanced Peripheral Bus (MC APB) services including Advanced MicroOVE Account Bus Architecture (AMBA) for IoT and distributed computing network AIoT services.

The DMA 605 & 660 combined with DMA Slave 650 and DMA protected registers 610 & 680 provides creation and control for the Privacy-Protected Token and Key Store OVE Account services. The OVE Account provides the Token and Key authentication and authorization controls.

The DMA 605, 650 & 660 combined with DMA Slave 650 and Advanced Bus Architecture (ABA) provides a hardware design to deliver dynamic kernel modules or (DKM) for the neural and network interface and Services Bridge. This service delivers the OVE INI architecture with programmable and pluggable modules for biometric signaling and service bridge integration.

The INI 600 & Printed Circuit 620 also has all the services necessary to deliver API management and access control for both the neural and network interface and Services Bridge for the Service Provider and OASN and Origin Awareness Neural System (OANS).

The GPU 670 configuration is provisioned for creation of a Quantum environment to implement Quantum services including Quantum Awareness (QATD) Threat Detection with the multi-channel heterogeneous chipset and ML functions.

The source and destination sizes can also be controlled and moderated for further granular control of and development of new biometric signaling management and biological classification Database models.

The many number of bytes within network connections require bi-directional synchronization of data and groups of transactions in response to an service bridge devices trigger also considered a message, and a group of messages are considered with a DMA 605, 650 & 660 operation. The size variables refer to the number of transactions that constitute a message. For example;
1. Transferring data from a serial port Rx register to a data buffer would have a source size of one and a destination size equal to the buffer size.
2. Transferring data from a data buffer to a serial Tx register would have a source size equal to the buffer size and a destination size of one.
3. Transferring data from a data buffer to a 16-bit PWM duty cycle register would have a source size equal to the buffer size and a destination size of two.

The DMA trigger event can either be software or a CIP-based hardware trigger, such as timer roll over, comparator output or a group of signals combined in a CLC combinational logic function. The DMA 605, 650 & 660 abort is a similar function with both software and CIP-based hardware options.

This DMA configuration can be configured to operate continuously once enabled or shut down at the end of the DMA operation.

The DMA automation is what happens after the transfer; the source/destination addresses can be post incremented, post decremented or fixed. The automation also refers to which counter rollover, if any, will terminate the DMA operation.

The DMA 605, 650 & 660 peripheral 615 & 640 is also capable of generating up to four specialized interrupts;
1. one at the rollover of the source counter;
2. one at the rollover of the destination counter;
3. one in the event of an abort;
4. and one for an overrun error event.

Individual devices have options specific to that device. This is part of the DKM or Dynamic Kernel Modules System (DKMS) that is designed into this architecture.

Core SFR or CSFR could contain sequenced ABI instructions for CUDA GPU operations in addition to the standard set of SFR 610 & 680 memory locations, an additional copy of select SFRs is available to the DMA system exclusively. This section of SFR 610 & 680 memory contains shadow copies of multiple SFRs. For programmer's convenience, the registers have been placed adjacent to each other to facilitate DMA access.

Once the DMA 605, 650 & 660 core is loaded options of automation of the DMA will be enabled. These include Post Increment/Decrement/Fixed and the termination event for the DMA transfers, the Automation Mode for both the source and destination. Both can be individually configured for post increment, post decrement or fixed operation. The source is configured using the SMODE bits and the destination is configured using the DMODE bits. Both sets of bits are in the DMAnCON1 register.

This architecture enables custom solutions for all devices including the use of OVE mesh for edge and node microbiological classification databasessors. Regarding the DMA 605, 650 & 660 peripheral 615 & 640 generates four interrupts types:
1. Source Count;
2. Destination Count;
3. Abort;
4. and Overrun.

The source counter interrupt generates a system interrupt when the source counter reloads. The destination counter interrupt does the same thing when the destination counter reloads. Together, these two interrupts convey the completion of a DMA message and the full DMA biological classification databases. The determination of which interrupt signifies which event is dependent upon which counter is reloaded from the larger size value.

An abort interrupt is generated whenever a hardware abort signal is received by the DMA 605, 650 & 660 peripheral 615 & 640. An overrun interrupt is generated whenever the DMA peripheral receives a second trigger event while still biological classification Database the first DMA.

These interrupts provide feedback to the controlling software, and CIP signals that can be routed to other peripherals.

The System Arbiter Function(s) (SAF) set Transfer Priority and Enabling Transfers between MicroOVE Accounts. The SAF which contains the DMA peripheral System Arbiter assists in setting relative priority of the DMA service bridge devices peripherals, the interrupts and normal code execution. It determines which function can suspend the other operations to take control of the address and data buses.

The interrupts typically have the highest priority, followed by main code operation and then the DMA peripherals. The main code has control of the buses until an interrupt occurs. The interrupt has control, until the interrupt completes.

Each device has a different number of DMA peripherals and different modes of interrupt operation and therefore it is part of the INI 600 & Printed Circuit 620 to create dynamic kernel modules (DKM) as it is impractical to specify all the possible priority combinations using the System Arbiter.

It would be know by anyone with skills in the art of programming printed hardware, components and interfaces that the controls in the INI circuit board including SoC controls provide granular system and technology design and development for a software version with unlimited controls in a container based on virtual and secure models. This architecture with custom controls and dynamic kernel modules is flexible and can be configured to be autonomous. This framework allows the system to update these kernel modules in almost real time for current and future INI controls of biometric signal data streams biological classification Database and monitoring of biometric signal types and routing.

The INI hardware and software version with neural and network interface (INI) and services bridge architecture provides security for biometric data. The anonymization layer can provide security using a simple neural and network interface only model. It also provides unlimited flexibility for Service Providers to design and service offerings including development of new modules for the INI Service Bridge for managing advanced and new model Service Providers Intelligent Services offerings and advanced and custom biometric signals biological classification Database.

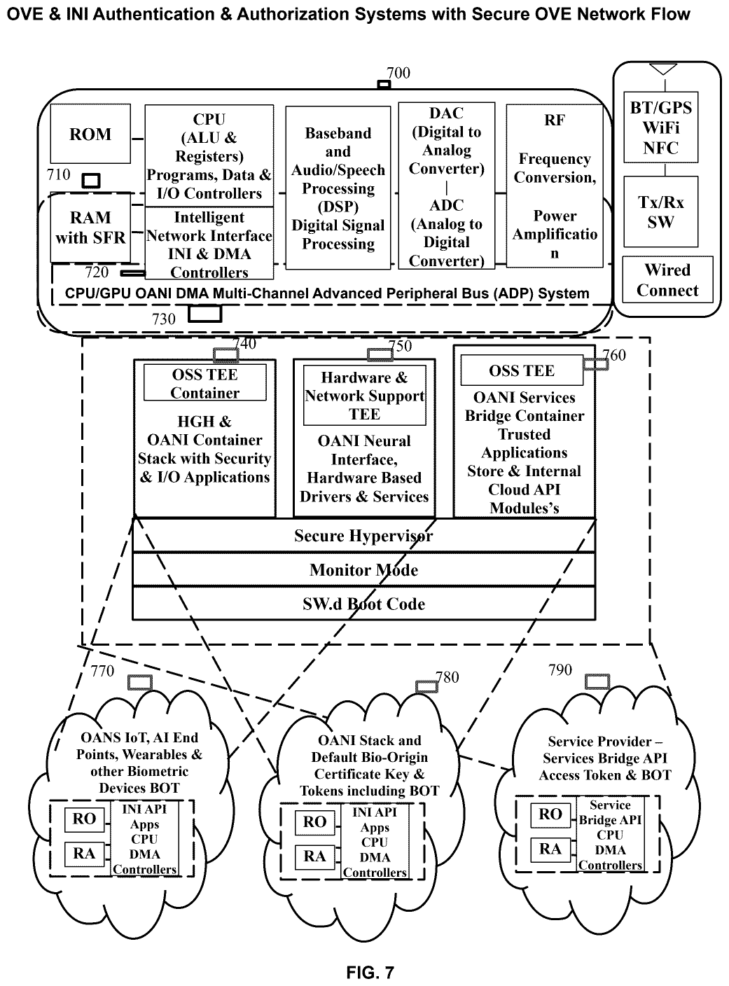

Referring to FIG. 7, the OVE & INI Authentication & Authorization Systems with Secure OVE Network Flow components of the invention in accordance with various embodiments described herein.

This preferred embodiment includes three connected INI formats including: INI Cloud, Stack with Security & I/O Applications 740 and INI neural and network interface with Hardware Based Drivers & Services 750; INI Services Bridge Container Trusted Applications Store & Internal Cloud API Modules's 760.

The Intelligent Network Interface (INI) 700 provides the core circuit controls functions for these embodiments. These include RAM with Special Function Register (SFR) 710 to manage secure memory registers and addresses and INI DMA OVE Accounts 720 to control and manage INI operations including CPU/GPU INI DMA Multi-Channel Advanced Peripheral Bus (ADP) System 730 routing for parallel biological classification Database and controls of signal biological classification Database including for the user devices (service bridge devices) Environmental and Cloud Connections.

### Access and End Product Tokens

The Access and End Product Tokens are used for token-based authentication to allow access to INI services and containers. These objects and containers include OVE Mesh and OVE validated user (bio-origin) Validated Objects End Products and Services using the services bridge and INI API 760 & 790.

The User successfully authenticates themselves using OVE, the OVE then passes the access token as a credential when it calls the Service Provider's Service Bridge or API 790.

The passed token informs the API that the bearer of the token has been authorized to access the API and perform specific actions specified by the terms and conditions set by the Service Provider and granted during authorization.

In addition, the OVE (bio-origin) validated object and End Product Access Tokens 770, 780 & 790 allow users to log access INI containers and resources using the OVE as an Identity Provider (IdP).

This access token allow the User to call the INI API (IdP API) 770. This OVE validated user (bio-origin) Access Token allows access to all registered Service Providers. The IdP can be issued in any format including certificates and by the Local Privacy-Protection Token & Key Store OVE Accounts of the INI.

The INI “Opaque” access tokens are tokens in a proprietary format that contain a OVE validated user (bio-origin) identifier in a DCE OVE server's persistent Token status storage.

To validate an “opaque” OVE validated user (bio-origin) Access Token and the INI OVE validates the service that issued the token including OVE validation in the OANS DCE shared token repositories.

The OVE Token can be used with the /userinfo endpoint Service Provider service to return a user's profile with permission using OVE INI acceptance in a feedback loop.

In this embodiment we used the JSON Web Token (JWT) access tokens to the JWT standard which contain information about an OVE validated user (bio-origin) User or Service Provider in the form of claims.

A Custom OVE validated user (bio-origin) Token or OVE validated user (bio-origin) Validated Object issued requests access to the Services Bridge and Service Provider API registered and follows the JWT standard for universal access to the OVE system and secure OVE network. The basic structure conforms the JWT structure, and contain standard JWT claims asserted about the token itself.

The OVE validated user (bio-origin) Access Token does not contain any information about the User except for the User ID (located in the sub claim or sub index).

To retrieve additional user information the Service Provider must call the userinfo API endpoint or OVE INI with the Access Token to decrypt the Sub Claim or Index using the Privacy-Protection Token and Key Store OVE Account for Key Exchange.

The API for which the Access Token is issued can use the RS256 signing algorithm.

Access token security would follow token best practices when using JWT

The Service Provider can set the Access Token lifetime in the Services Bridge. The INI lifetime is set by the user and monitored for validity by the OVE Secure Token Store for Token Status.

By default most access token using a custom API are valid for 86400 seconds (24 hours).
/userinfo endpoint token lifetime

Access tokens issued strictly for the purpose of accessing the OVE/userinfo endpoint have a default lifetime and can't be changed. The length of lifetime depends on the flow and used of the token. OVE validated user (bio-origin) Validated Objects and Tokens also have a lifetime that is extendable or infinite depending on the settings of OVE, the Service Provide, and the Service Bridge API for their product or service (outcome and outputs).

This model with access control combined with a threat detection engine using anomalies detection algorithms such as Locality-Sensitive Hashing (LSH) and 3^{rd} Party Libraries is designed to protect and secure OVE Validated Users and the OVE system and network.

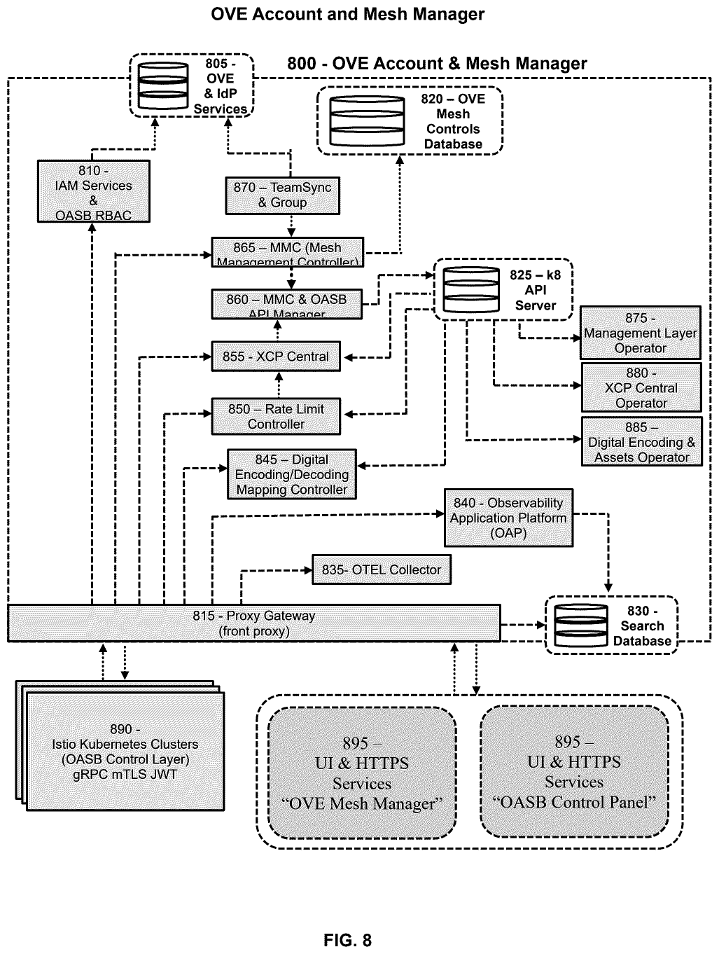

Referring to FIG. 8, the simplified diagram of the OVE Mesh Manager Components & Services of the invention in accordance with various embodiments described herein.

This embodiment is an ISTIO, XCP Platform for the OVE Mesh with Provisions for services bridge Control and Management.

### OVE Mesh Manager

The OVE Mesh Manager provides several flexible and scalable services for efficient operation of the OVE Mesh and services bridge. The Mesh Manager controls access and permissions for the services bridge control layer including using the INI for remote access to service bridge devices peripheral, wearable and environmental devices.

Istio allows organizations to deliver distributed applications at scale. It simplifies service-to-service network operations like traffic management, authorization, and encryption, as well as auditing and observability.

XCP (or) “Universal Measurement and Calibration Protocol” is a network protocol connecting calibration systems to electronic control units, ECUs. It enables read and write access to variables and memory contents of microOVE Account systems at runtime. Entire datasets can be acquired or stimulated synchronous to events triggered by timers or operating conditions. In addition, XCP also supports programming of flash memory.

ServiceEntry enables adding additional entries into Istio's internal service registry, so that auto-discovered services in the mesh can access/route to these manually specified services. A service entry describes the properties of a service (DNS name, VIPs, ports, protocols, endpoints). These services could be external to the mesh (e.g., web APIs) or mesh-internal services that are not part of the platform's service registry (e.g., a set of VMs talking to services in Kubernetes). In addition, the endpoints of a service entry can also be dynamically selected by using the workloadSelector field. These endpoints can be VM workloads declared using the WorkloadEntry object or Kubernetes pods.

There are two operators running in the OVE Mesh and services bridge layers:

OVE services bridge Management Mesh OVE Account (MMC): Operator to manage lifecycle of OVE services bridge components in the management plane.

XCP Central Operator: Operator to manage lifecycle of XCP Central. OVE services bridge Mesh Management OVE Account (MMC) deploys XCP Operator and CRD for this operator, leaving up to them the management of XCP Central

The OVE Mesh components configured and installed by the operator are:

The OVE Mesh Manager 800. The OVE & IdP Services 805 for connection between the OVE and OVE Mesh. The Proxy Gateway (front-proxy) 815: which provides single entry point for OVE Mesh API and UI. IAM Services & services bridge RBAC 810 to authenticate authorization and access the OVE Mesh and services bridge with OVE issued SSO and OVE validated user (bio-origin) validated objects (OVE (bio-origin) validated object) and tokens

The OVE Manager OVE Account Database 820 is a Postgre datastore for OVE Mesh operation. A k8 API Server 825 is responsible for:
1. Managing user-created service mesh configurations
2. Pushing service mesh configurations to control clusters and new clusters with virtual machines
3. Managing cluster information pushed from the control layer to cluster
4. Enforcing authorization of the operations performed by users
5. Storing audit logs of the operations performed

A search database 830 as a store and metrics retrieval service of system and event data. During operations of the Istio, XCP and externally connected services including microservices data is collected using the OTEL 835 and OAP services 840. The OTEL collector is an Open Telemetry Collector that collects the management and control components' metrics and exposes them through a Prometheus metrics endpoint and exports to the search datastore. The Observability Platform (OAP) serves GraphQL queries for the OVE services bridge UI and aggregates cross-cluster metrics.

Digital Encoding/Decoding Mapping Controller 845 OVE Account 845 encodes digital assets for tracking and use validation within the OVE as well the digital assets mapping includes tracking of OVE validated user (bio-origin) Validated Objects (OVE (bio-origin) validated object) within the DLT and OVE DDFS datastores using a CID.

The encoding & decoding server and services provide efficient transmission and storage of media and data. OVE uses either the Java or Python form and is a method of representing data in a different format to efficiently transport through a network or web. In python encoding represents a unicode string of bytes. Decoding transforms this string of bytes back into a unicode string. This happens when you receive a string of bytes from a disk file or network.

The Rate Limit OVE Account 850 provides xDS tracking of thresholds for services including service bridge devices within the Istio clusters, pods, containers and virtual machines. This threshold service OVE Account within the user devices (service bridge devices) UI tracks and logs use variables between services such as biometric signal devices, biometric and feedback loop and Intelligent Agent Services Provider (ISAP) biological classification databases percentages of use for validating service bridge devices ownership of digital assets and validation of issuance of OVE authenticity and ownership certificates.

XCP Central 855 is the central component of the control layer used by the OVE Mesh Manager to distribute configurations to each cluster as well as receive information about the state of each cluster.

MMC & services bridge API Manager 860 and MMC (Mesh Management OVE Account) 865 provide configuration translation component between the apiServer and xcpCentral.

The TeamSync & Group OVE Account 2570 provides services to create Teams and Groups within the OVE Mesh and services bridge to create Multi-User and Multi-Device Workspaces and management platforms including within the Management Layer Operator 875.

The XCP Central Operator is who the OVE and services bridge delegate management of control layer components needed by the OVE Mesh Manager.

The Digital Encoding & Assets Operator 885 provides user interface controls for the OVE Mesh and services bridge. The Istio Kubernetes Clusters (services bridge Control Layer) gRPC mTLS JWT & XCP 890.

The UI & HTTPS Services “OVE Mesh Manager” & “services bridge Control Panel” 895 provides user interfaces for the OVE Mesh including Mobile Applications using INI architecture.

The OVE Mesh provides the services necessary for operation of OVE using INI including services bridge and service bridge devices for biometric signal observability and telemetry tracking recorded to the OVE datastore of the OVE User with a UPID.

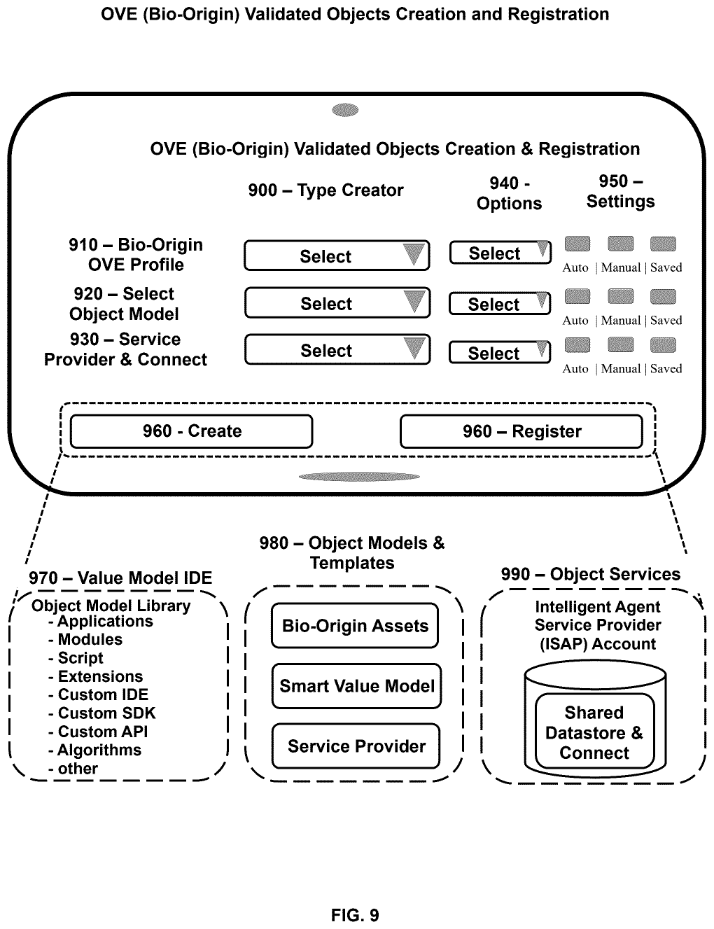

Referring to FIG. 9, the simplified overview of the OVE (bio-origin) Validated Objects Creation and Registration components of the invention in accordance with various embodiments described herein.

This embodiment is an OVE (bio-origin) Validated Objects Creation and Registration for Services & Components of the OVE Mesh and Services Bridge Management System.

This embodiment outlines the manual biological classification databases of creating, registering and managing OVE (bio-origin) Validated Objects including newly created and registered ISAP OVE (bio-origin) validated object from services bridge and INI connected OVE validated systems and devices.

OVE (bio-origin) Validated Objects and Models can created with the Independent Development Environments (IDE) or automatically with the OVE platform. As well it is described how the IDE WASM platform which is an example of the provision of a development environment for OVE and INI IDE using system API's.

Combined with unlimited flexibility for development and control of data, signals and advanced biological classification Database the OVE Mesh Istio XCP platform with OVE (bio-origin) validated object Intelligent Modules and Services provide the OVE Mesh create OVE registered OVE (bio-origin) validated object units in the OVE DLT digital ecosystem.

The OVE INI ecosystem is the neural system transport layer. The OVE Mesh with biological classification database classifies delivers validated OVE validated user (bio-origin) Profiles including with Mobile OVE INI Apps 905.

The OVE validated user (bio-origin) Validated Objects (OVE (bio-origin) validated object) modules provide ML and programmable algorithms for retrieval and extraction of local and global OVE (bio-origin) validated object Intelligence. The OVE (bio-origin) validated object digital assets create value in the OVE (bio-origin) validated object Container.

The shared local global database architecture also delivers a Quantum ecosystem architecture using INI and GPU. As well AI Quantum influence and power threats are remediated by the Bio Aware Access Control “BAAC” [IDS/IPD], ATDE, LSH and SybilGuard with Quantum simulation and acceleration for advanced threat protection.

The OVE (bio-origin) Validated Objects Creation and OVE DLT Registration 960 generates digital assets associated with the OVE validated user (bio-origin) Validated Object (OVE (bio-origin) validated object) and OVE DLT model and framework provide OVE validated user (bio-origin) properties and assets in the OVE DLT with validated Users and Objects within the OVE Secure Network. An example of the registration biological classification databases is as follows:
1. an OVE (bio-origin) validated object OVE DLT validated transfer placed on the OVE DDFS records using the UPID;
2. the OVE from the OVE account DDFS uses the UPID code to identify the Human OVE Account or User;
3. the unique OVE (bio-origin) validated object OVE DLT digital asset link with UPID code is created and placed on the OVE;
4. the unique OVE (bio-origin) validated object OVE DLT digital asset ID and UPID code record the digital asset on the record on the Human OVE Account or User OVE account on the OVE DLT blockchain.
   OVE Validated User (bio-origin) Profile Biological Classification Database System 910

A plurality genotype are available for identification of biological classification database including sub classes such as the taxonomy of plants.

Type of OVE (bio-origin) Validation Object 920

The OVE (bio-origin) validated object types of creators include but not limited to: applications; modules; script; extensions; custom IDE; custom SDK; custom API; algorithms and other coding environments and models including AI.

### Service Provider Connect 930

The types of services of the Intelligent Service Agent Provider (ISAP) include intelligent service to add value of increase awareness of the OVE (bio-origin) validated object. As well Software as a Service (SaaS) to provide user software running on the cloud substructure; Platform as a Service (PaaS) for provisioning tools, libraries, services, modules and models; and Infrastructure as a Service (IaaS) providing networked computing and storage infrastructure.

### Options 940

Options can include sub classes of OVE validated user (bio-origin) profiles, types of SVM and ISAP.

### OVE (Bio-Origin) Validated Object Biological Classification Database Settings 950

These settings include automated, manual and saved intelligence profiles. Automated includes AI Generative and

Create OVE (bio-origin) Validated Object Project on OVE DLT 960 or Exchange Registration 960 Initiating a request to the OVE DDFS database or DLT blockchain to transfer the SVM Unit or SVU in the OVE decentralized DLT and DDFS system:
1. an OVE DLT DDFS storing digital assets and unique digital asset ID codes associated with multiple digital assets;
2. receive a digital transfer proposal with a request to transfer OVE validated user (bio-origin) OVE validated user (bio-origin) Validated Object (OVE (bio-origin) validated object) OVE DLT with a OVE validated UPID Profile and link to the OVE (bio-origin) validated object DDFS CID.
3. the OVE server DDFS generates a UPID code associated with the second party;
4. retrieve, from an encrypted relational database, a DLT code associated with the second party;
5. linking, via the OVE server computer, the OVE (bio-origin) validated object digital asset Unit with the new UPID code;
6. an OVE (bio-origin) validated object OVE DLT created with OVE validated transfer to be placed on the OVE DDFS records using the UPID;
7. transmitting notification to the second party information for accessing the digital asset;
8. transmitting, via the OVE server to a distributed blockchain ledger the OVE DLT ID code and the UPID to record transfer of the OVE DLT digital asset to the second party on a transaction block;
9. receiving the transaction confirmation, transmitting a notification to the second party with a unique key with a hashed address to the OVE DLT token.

Value Model IDE and OVE (bio-origin) validated object Model 970 can include but is not limited to: applications; modules; script; extensions; custom IDE; custom SDK; custom API; algorithms and other coding environments and models including ML.

### OVE (Bio-Origin) Validated Object Service Providers 990

OVE (bio-origin) validated object Models & Micro Business Templates 980 can include a plurality of types of digital assets.

The types and models of the OVE validated user (bio-origin) Validated Object (OVE (bio-origin) validated object) Models is limited only by the requirements of the User and Service Provider. They can be registered on any OVE validated DLT blockchain.

Terms and conditions of registration are based on the organization and service provided requirements. OVE DLT compliant blockchains can be created and activated using the services bridge Platform and Secure OVE Gateways.

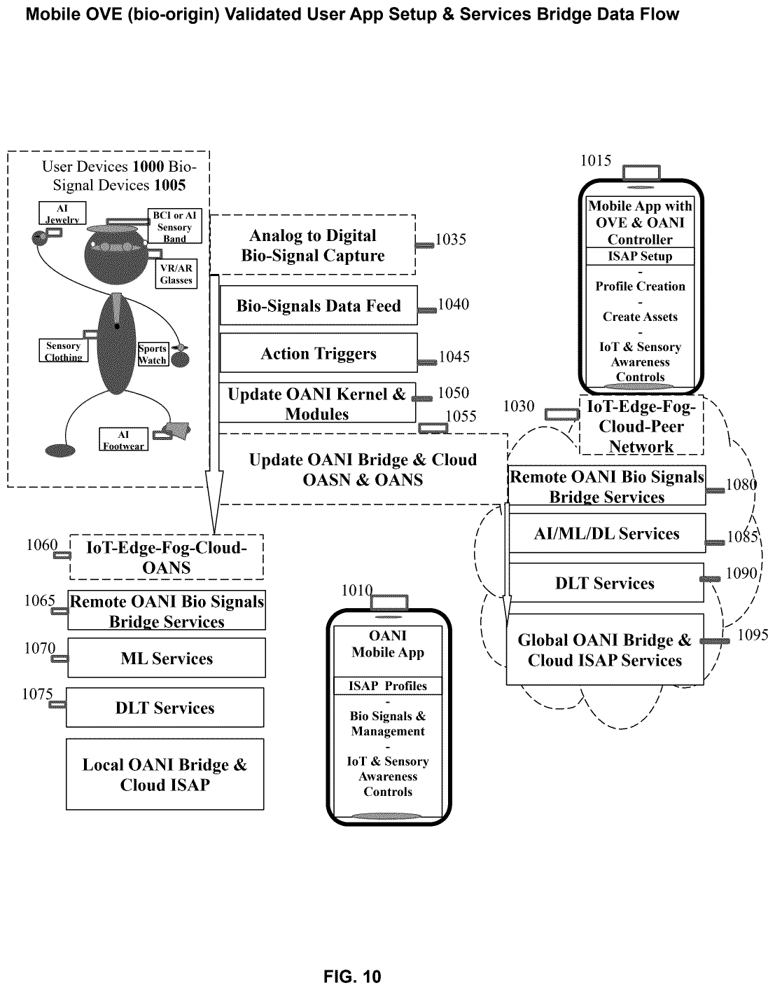

Referencing to FIG. 10 a simplified diagram of the Mobile OVE (bio-origin) Validated User App Setup & Services Bridge Data Flow of the invention in accordance with various embodiments described herein.

The N-Tier framework with API server provides an agnostic multiple device connection system for devices, peripherals, IoT, AIoT, AI endpoints, wearables and other interactive bio sensory and detection systems and devices using the OVE Intelligent Network Interface (INI) System.

The N-Tier framework and architecture also provides connection to all types of application and operating system devices including but not limited to gaming and interactive devices such as VR/AR glasses.

A Watch and Glasses Bio Signals Flow comprises a human user 1500, bio signal device sensors 1005, a mobile application 1010, an INI & services bridge Bio Signals Bridge Integration 1015 Machine Learning Capture and Modeling 1020 DLT data privacy protection services 1025 that may be performed in an IoT, edge, fog, cloud, or peer network 1030 including local and global DCE data pools and lakes 1035. The bio signal sensors may capture data that is sent for analog-to-digital and the digital signal may be used for intent detection 1040 resulting in an action trigger 1045 to an Service Provider or INI 1050 and update local and global DCE network and ML 1055. The digital data may further be sent raw for biological classification Database and storage within the local and global graph and vector database 1055, and may be used as training data for training and data analysis within the INI 1040 and training and data analysis within the Global ML DCE 1035 for inference and human feedback machine learning parameters 1060 including for use in real time and services bridge intent detection and feeds data 1065. The INI Neural biometric signal Interface and Service Bridge 1070 may determine placement and timing of Inference and service bridge devices Human Feedback alerts 1505, which may be used in an augmented, virtual or alternative reality environment depending on the ISAP Profile 1080 used for system wide and User alerts and notice.

The invention may use inputs using a computer, mobile or other device. The AI Watch 1005 and Glasses 1010 flow diagram 1000 for a user wearing any nonverbal and verbal multi-input and feedback devices and/or sensors. As a result of this being a looped bio signals and feedback system with sensory communication and control records biometric and stimulation time-based frequencies, and tags with metadata in real-time as the analog data is digitized.

Reinforcement learning us used for rapid development of biological classification database including for ML graph dataframe and modeling techniques to develop and record base models for real time bio signal data feeds in the services bridge Marketplace.

The merging of bio signal and context awareness metadata, vocabulary tracking, and and action logic into the data store and universal INI Neural biometric signal and Services Bridge for signal acquisition and data biological classification Database helps reduce latency with DCE and IoT-Cloud-Edge-Fog DCE ML programmable algorithm stores.

The AI Watch 1005 showing multimodal, multi-sensory system communication and control for nonverbal and verbal multi-input and feedback comprises multimodal, multi-sensory systems for communication and control including infrared and wireless signaling for neck and head tracking with Glasses 1010 including for wireless brain tracking and evoked potentials.

The AI Watch 1005 and Glasses 1010 use multimodal, multi-sensory systems for communication and control for peripheral EMG, EOG, ECG, and others and analog to digital signal biological classification Database of data from the INT Bio Signals Bridge 1025 and OVE Account 1020.

The OVE Account 1020 collector subsystem can communicates through a wireless serial streamer with a microOVE Account, mobile or other computing system. The peripherals subsystem generates audio feedback, haptic feedback, and OLED visual feedback from and for the user

The analog to digital subsystem 1030 and sensor service subsystem 1035 manage output from the analog to digital signal biological classification databasessor and analog to digital signal biological classification databasessor. Output to digital subsystem is sent to the local INI 1040 and global shared privacy-protected DCE storage 1045.

The Remote INI Neural biometric signals and services bridge Service Bridge subsystem 1025 communicates with the serial streamer from sensor for data, and data from sensing devices using INI serial I/O and DMA controls.

All forms of metadata including geolocation data sourced from systems such as GIS or GPS data or WIFI data, or manually personalized geofencing in the application personalization settings would determine if the user is “at home” or “away from home”.

The metadata may play a role in identifying the language and context of environment and weather of the user using geo location and proximity data.

The system may collect and biological classification databases historical data from the sensory devices, system, subsystems, and output actions to improve the performance and the INI Neural biometric signals Interface and Services Bridge including for personalization of the system, subsystems, and sensory devices.

The container uses intelligent algorithms and automated schema evolution with polymorphism and graph programming to provides a low profile on the remote OVE Account device and high availability storage with a distributed computing environment (DCE) Mesh architecture. This delivers both the computing power and storage needed for the global DCE.

The Remote INI connects to the Hubs, Fog OVE Accounts and ISAP Service Bridge and Provider Nodes delivers data, network, streaming and privacy protection services using Machine Learning (ML) Services for optimization and Distributed Ledger Technology (DLT) for data protection and OVE DLT transactions.

The DLT ML algorithms of the system to track non-malicious as well as malicious activities. The data cleaning and mapping component provides extraction to the graph knowledgebase and for a Secure OVE Network for the INI Local and Remote ISAP services bridge Containers including Virtual Machines (VM).

The system can use a plurality of configurations dependent on the type of CPU/GPU, OS, DMA and other configurations of and containers. Integrated and operating within the n-tier architecture with remote deep learning Origin Neural and Network Interface (INI) architecture of the embodiments of this invention.

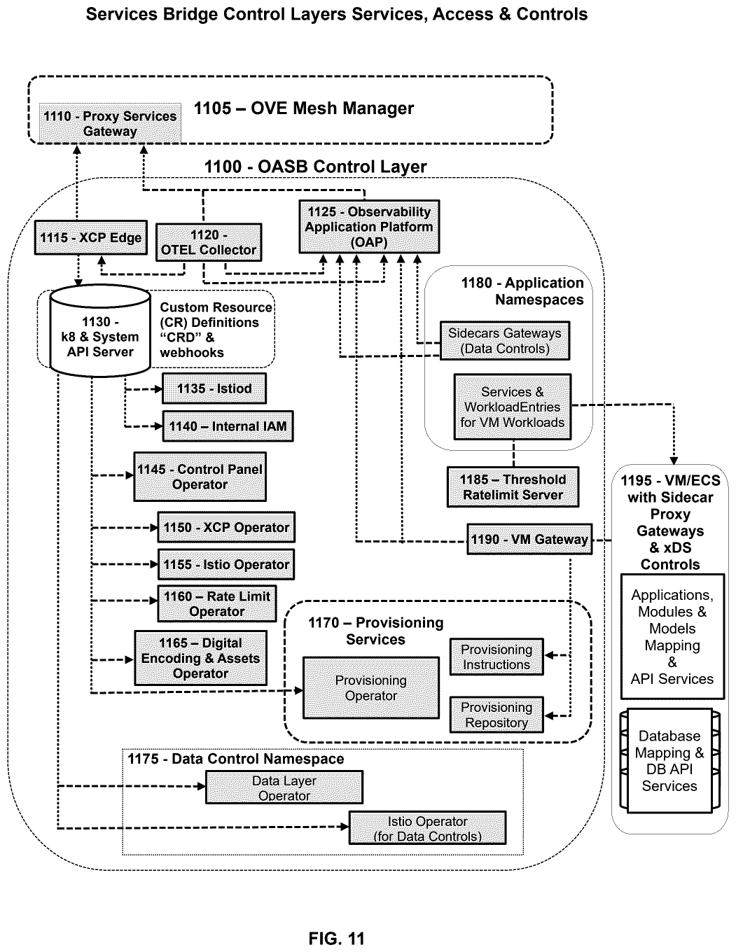

Referring to FIG. 11, is a simplified diagram of the Services Bridge Control Layers Services, Access & Controls components of the invention in accordance with various embodiments described herein.

This embodiment is an ISTIO, XCP Platform for Services & Components of the services bridge Control Layers Services & Components of the OVE Mesh & services bridge System. The controls and types of frameworks available are limited only by the needs of the Users.

The services bridge Control Layer includes provisioning of a Shared Datastore and Computing Environment (SDCE). This provides a platform for the User and ISAP Agent Product or Service to interact with the user devices (service bridge devices) Wearable or Environmental devices. The core Proxy Sidecar xDS Threshold Rate Limiting provides the controls for the tracking and recording of activity within the services bridge Platform and validation of ownership rights and authenticity.

The Istio, XCP and ServiceEntry framework with Proxy Sidecar Data Layers provides the OVE services bridge Mesh platform with the flexibility to deliver OVE and services bridge services in real time and scale microservices seamlessly with simplified architecture for flow of updates on a scalable mesh.

The services bridge Control Layer 1100 consists of an parent OVE Mesh Manager 1105 with a Proxy Services Gateway 1110 to the XCP Edge 1115 which receives configurations from OVE Mesh XCP Central and translate to Istio configurations. It also sends updates to XCP Central on config status and cluster inventory and is managed by the XCP Edge Operator.

The OTEL Collector 1120 scrapes metrics from different services bridge components and exports metrics to Prometheus exporter with the OTEL collector via the Front Proxy. The Observability Application Platform 1125 receives access logs and traces from all of the Istio sidecar proxies and gateways in the cluster. It biological classification database these access logs and generates metrics. Metrics and traces are sent to the Search Database 1130. A Horizontal Pod Autoscaling HPA: provides an external metrics adapter from which the Kubernetes Horizontal Pod Autoscaling (HPA) OVE Account can retrieve metrics.

A k8 (Kubernetes) & System API Server provides Custom Resource (CR) Definitions “CRD” & webhooks 1130. The Istiod 1135 component provides service discovery, configuration distribution to sidecar proxies and workload management. It is managed by Istio Operator 1155.

The Internal IAM 1140 provides OVE and cert-management for internal services bridge components for purposes like webhook certificates and VM's. The Rate Limit Operator 1160 provides threshold controls, variables and metrics for the OVE Mesh and services bridge UI.

The Digital Encoding & Assets Operator 1165 provides tracking and mapping controls for encoding OVE (bio-origin) validated object digital asset storage.

The Provisioning Services|Provisioning Operator|Provisioning Instructions|Provisioning Repository 1170 is an Agent in the VM to connect external mesh workloads and provisioning instructions using the Provisioning Operator 1170 for creation and activation of new clusters or clusters with virtual machines (VM) in the OVE services bridge Mesh. The Provisioning Repository uses an HTTP server to deliver DEB and RPM packages of the Provisioning Agent and Istio Sidecar.

### The Data Control Namespace|Data Layer Operator|Istio Operator (for Data Controls)

The Data Control Namespace 1175 is comprised of two components.

OVE services bridge data plane operator: to manage lifecycle of OVE services bridge data plane components.

### Istio Operator: To Manage Lifecycle of Istio Gateways Based on Gateway CR Specified in Data Plane Install API

The Application Namespaces|Sidecar Gateway (Data Controls)|Services & WorkloadEntries for VM Workloads 1180 provide custom application, modules, models and other programming services and storage for the Istio XCP and VM layers.

The Threshold Rate Limit Server 1185 provides built-in ratelimiting capability for all data, applications and services. It is used within the user devices (service bridge devices) validation of ownership system.

The VM Gateway 1190 provides connection to Istiod and OAP from sidecar proxies running in VM and the VM/ECS with Sidecar Gateways & xDS Controls Applications, Modules & Models Mapping & API Services|Database Mapping & DB API Services 1195.

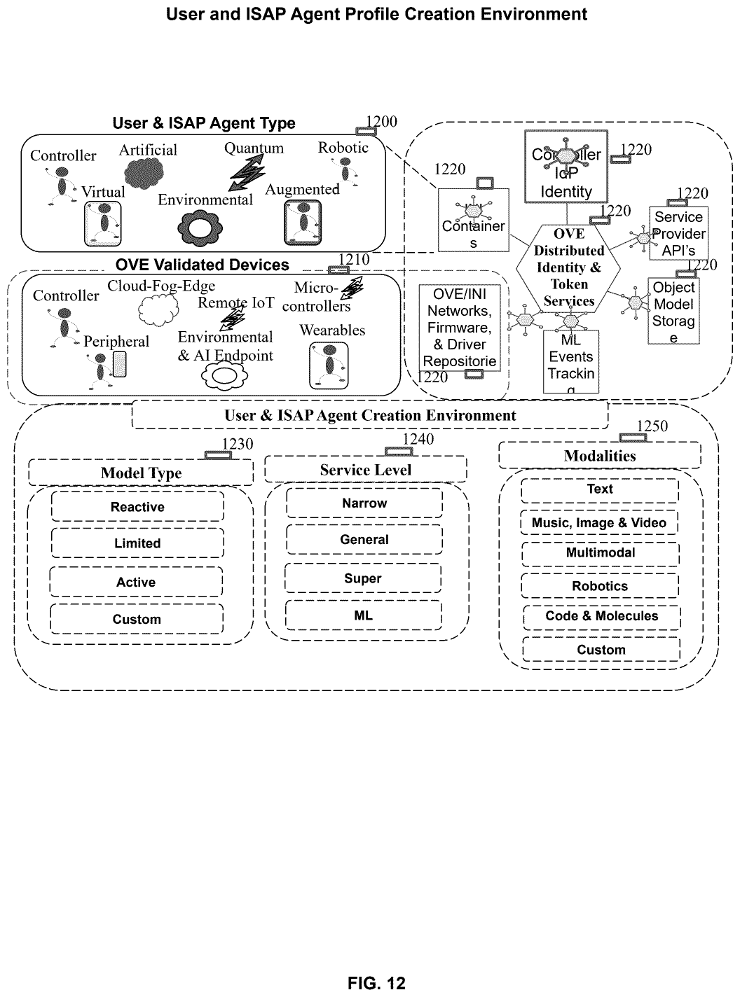

Referring to FIG. 12 is a simplified diagram of the User and ISAP Agent Profile Creation Environment of the invention in accordance with various embodiments described herein.

The Multi OVE (bio-origin) Validated User Profiles “User Agent” Creation Environment provide a model for Real Human User and ISAP Accounts to connect with physical, virtual, augmented and hybrid agents or agent profiles to deliver products and services. The use of the services bridge services bridge to receive and provide Intelligent Services expands the scope of Agents beyond software to hardware such as robotics.

Devices listed are not exhaustive and can be assigned individually or as a group to each User or ISAP. These types include but are not limited to: OVE Account; Peripheral; Cloud-Fog-Edge; Remote IoT; Environmental & AI EndPoint; MicroOVE Accounts; and Wearables 1210.

The OVE Mesh Distributed Identity & Token Services; INI OVE Accounts; User/ISAP Networks, Firmware & Driver Repositories; ML Events Tracking; Service Provider API's; OVE (bio-origin) Validated Object Storage & DCE 1220 represents the Identity services and secure distributed repositories with OVE Authentication of the OVE INI network. It utilizes the INI Neural and Network Interface and Services Bridge for session and access control as well creation and provisioning of the ISAP Agents modules for integration with service bridge devices services.

Three basic building blocks create the AI profile of the ISAP are as follows:
1. Model Type 1230—Reactive, Limited, Active, Custom (type of service of device)
2. Service Level 1240—Narrow, General, Super, ML (type of service needed to operate the ISAP Agent)
3. Modalities 1250—Text natural language biological classification Database, machine translation, and natural language generation; Code: natural language text, large language models trained for programming language text, allowing them to generate source code for new computer programs such as OpenAI Codex; Image systems trained on sets of images with text captions using text-to-image generation and neural style transfer; Molecules where Generative AI systems are trained on sequences of amino acids or molecular representations such as SMILES representing DNA or proteins; Music where Generative AI systems such as MusicLM can be trained on the audio waveforms of recorded music along with text annotations, in order to generate new musical samples based on text descriptions; Video where Generative AI annotated video can generate temporally-coherent video clips; Robotis actions where Generative AI is trained on the motions of a robotic system to generate new trajectories for motion planning.

Template Account Profiles 1200 are provided as an example and would be customized by the ISAP.
1. OVE Account
2. Virtual
3. Artificial
4. Environmental
5. Augmented
6. Robotic

Simple examples of User and ISAP Agent Profiles are service bridge devices to Generative, service bridge devices to Robotics and others for nonverbal multi-input and feedback devices such as VR and AR. Interfaced devices with OVE IdP authentication 1220 with a vocabulary module API 1250 and others.

The OVE (bio-origin) validated object & Token with API gateway 1220 allows the Agent to communicate with the INI & services bridge which may be used to store OVE DDFS cloud data 1260 and OVE validated user (bio-origin) tracking and recording of real human OVE validated user (bio-origin) and User Agent events.

The INI 1210 may send permissioned data back to an services bridge ISAP 1220 through the services bridge OVE 1220 module, which may act as a gateway to ensure security and content authorization 1220.

User and ISAP Agent Profile Creation Environment in this embodiment generates Agent profiles based on the type. These Agents interacts with a user devices (service bridge devices) Wearable or Environmental Device whether a service or another device.

As you can see from this description the ISAP Service Provider Agent can deliver an almost unlimited form of products or services with a plurality of outcomes and output.

These User and ISAP Agents are registered under an OVE Validated Human User Account prior to creating an Agent for the services bridge Platform.

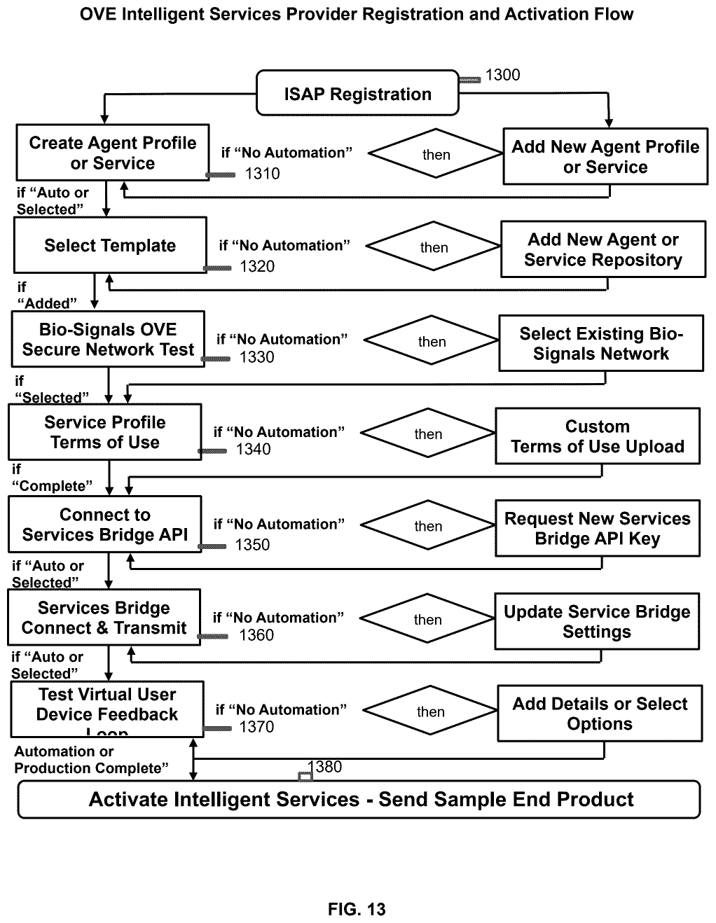

Referring to FIG. 13 a simplified diagram of the OVE Intelligent Services Provider Registration and Activation Flow of the invention in accordance with various embodiments described herein.

### ISAP Registration Page Flow for Product and Services Agents 1300

Create Agent Profile or Service→if “No Automation” then Add New Agent Profile or Service 1310 if “Auto or Selected”
Select Profile→if “No Automation” then Add New Service Code Repository 1320 if “Added”
Biometric Signals OVE Secure Network Test if “No Automation” then Select Existing biometric signals Network 1330 if “Selected”
Service Profile Terms of Use→if “No Automation” then Custom Terms of Use Upload 1340 if “Complete”
Connect to Services Bridge Service API→if “No Automation” then Request New services bridge API Key 1350 if “Auto or Selected”
Services Bridge Connect & Transmit→if “No Automation” then Update Service Bridge Settings 1360 if “Auto or Selected”
Test Virtual Service Bridge User Device Feedback Loop→if “No Automation” then Add Details of Select Options 1370 Automation or Production Complete
Activate Intelligent Services 1380 Send Sample End Product.

The End Product can be almost anything that delivers a product or service for the User including with an intelligent service. It can be in almost any delivery method or model including physical, augmented, virtual or a hybrid. The possibilities are endless with the use of this technology which has been disclosed to assist in the growth of this OVE validated user (bio-origin) OVE industry and technologies.

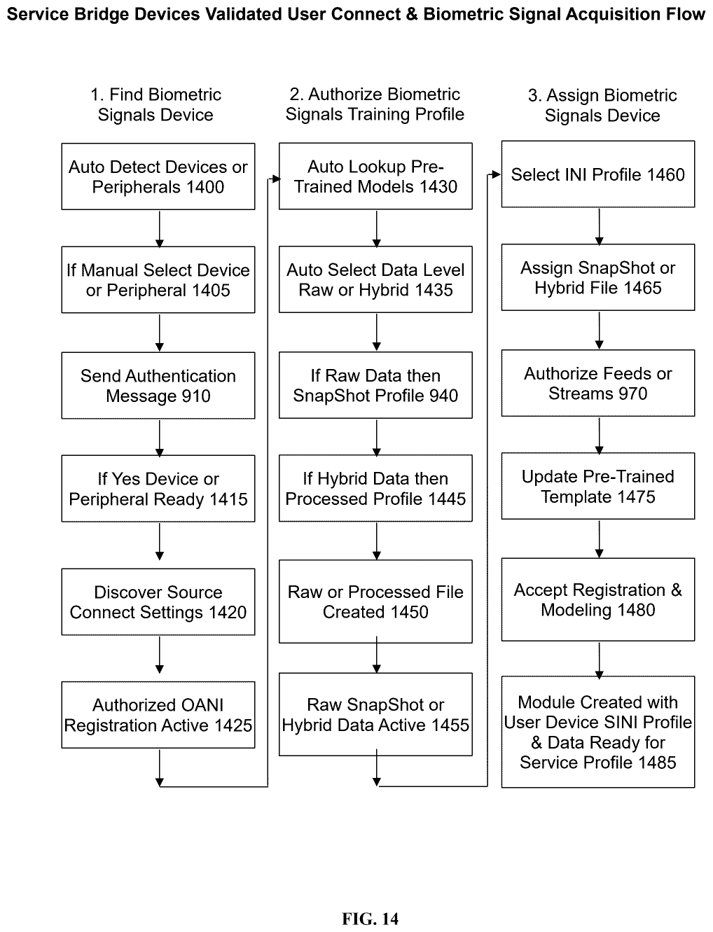

Referring to FIG. 14 is a Generalized Diagram of the Service Bridge Devices OVE (bio-origin) Validated User Connect & Biometric Signal Acquisition Flow of the invention in accordance with various embodiments described herein.

The steps for setup of the Service Bridge Devices OVE Validated User (bio-origin) Profile and Stream Discovery includes: a Created Profile and Assignment of Feed or Stream to the Service Bridge Devices OVE Validated User OVE (bio-origin) Profile. A secure connection combined with OVE secure network provides the method to sync and utilize Service Bridge Devices Biometric Signals.

Find biometric signals Device or Peripheral (autonomous activation allows the system to automate almost all steps that do not include “Auto” or “allow” in their description)

First step is activating Auto Discovery 1400; then Select Device(s) or Peripheral(s) 1405 as Primary Biometric Signal Device; activate the Autonomous Biometric Signals Detection & Registration 1410 to create a Multimodal OVE Validated User (bio-origin) Profile accept Autonomous Creation of INI and Services Bridge 1415; allow Creation of a Biometric Service Bridge Devices and ML Graphs Data Core 920; Accept Autonomous Creation of INI for Authorized Registration Active (completed) 1425.

### Authenticate Bio Signals Data Feeds & Streams

Auto Lookup Pre-Trained Models & Approve Devices 1430; the system activates Reading of Biometric Signals; Analyzing Biometric Signals; Mapping to Biometric Signals INI Bridge 1445; then Recording & Updating Bio & Meta Data to OVE INI and OANS Graph Data Stores 1450; then Updating Privacy-Protected Shared DCE Partition 1455.

### Create OVE (Bio-Origin) Validated Profiles & OVE (Bio-Origin) Validated Object Models & Modules

The User Selects the OVE Profile Type 1460; allows Assign Biometric Signals Feeds & Streams 1465 allows or Selects Value Model Module Template 1470; Tests Biometric Signals Value Model Profiles 1475; Accepts Registration & Modeling 1480; activates Module Created with INI OVE Profile & Data Ready for Service Profile 1485.

User Agent Biometric Signal Stream Profiles includes but are not limited to: Real-Time Autonomous Privacy-Preserved Biometric Signals Meta and Data Feeds and Streams; Real-time Autonomous Privacy-Preserved Value Models, Applications, Datasets, Relationships, Infrastructure, and other products and services.

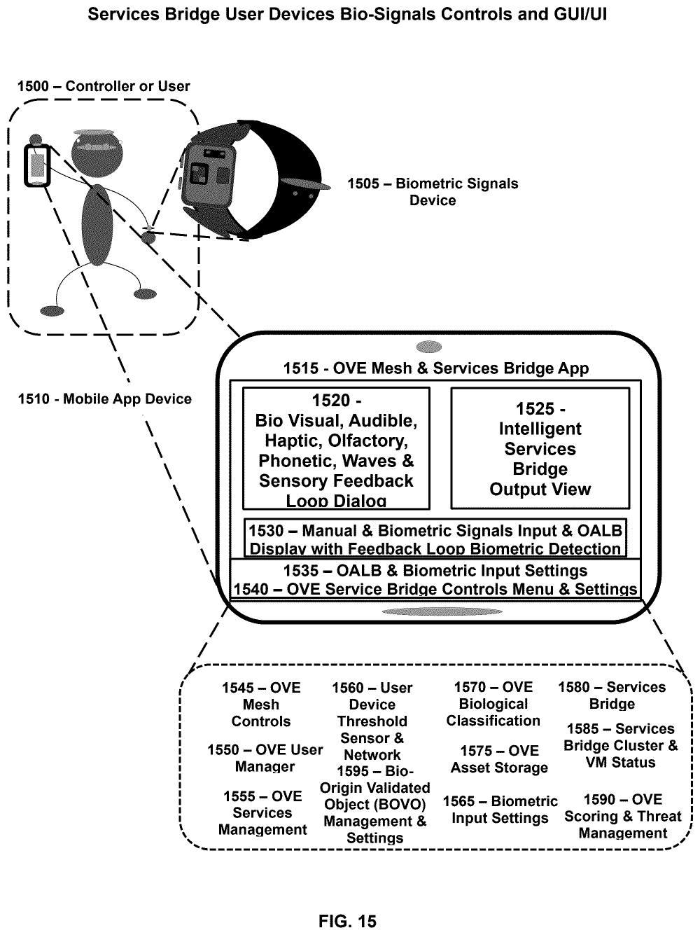

Referring to FIG. 15, the simplified overview of the Services Bridge User Devices Bio-Signals Controls and GUI/UI components of the invention in accordance with various embodiments described herein.

This embodiment is an Services Bridge User Devices Bio-Signals Controls and GUI/UI. The controls available are limited only by the needs of the Users and ca be custom developed using the services bridge IDE and INI services bridge API's.

An OVE Mesh Manager connects with the OVE authentication and validation system for access to the OVE services and authorized objects including API's. A User designated as the OVE Account 1500 uses the Origin Awareness Services Bridge “services bridge” to create new Clusters and Virtual Machines “VM” for services, assets and applications. This OVE Account has been validated using the OVE Mesh platform Origin Validation Engine (OVE) with Bio Awareness Access Control (BAAC) 1500 provides Bio-Authentication 1505, Bio-Validation 1510, Bio-Authorization 1515 and Bio Awareness Access Control 1520 services. This includes a Secure Distributed & Fragmented Bio-Data & Bio-Assets Storage 2025 system with OVE IdP, STS, CA & Content ID Services 1530.

A Biometric Signals Device 1505 can be any wearable, peripheral, IoT or cloud device which is authenticate and authorized by the OVE user and can detect and collect biometric data. The Mobile App Device 1510 provides the easily accessible method to enroll or login to the Mesh OVE. This mobile app provides access 1515 to the UI or User Interface for management of the OVE Mesh and services bridge.

A Multi-Modal Biometric Visual, Audible, Haptic, Olfactory, Phonetic, Waves & Sensory Feedback Loop Dialog 1520 Display provides interactive functions for the OVE Account or User. The Intelligent Services Bridge Output View 1525 provides display of the combined OVE Account services bridge and Intelligent Agent Service Provider end product or status. Combined with the Manual & biometric signals Input & OALB Display with Feedback Loop Biometric Detection 1530 and Origin Awareness Language Bridge (OALB) & Biometric Input Settings 1535 the UI provides comprehensive settings for preferences including multi-modal response types and OALB display of response profiles.

The OVE Mesh Service Bridge (services bridge) Menu Controls & Settings 1540 include:

OVE Mesh Controls 1545 including OVE validated user (bio-origin) Profile Management and OVE Authorization and Authentication in the OVE Mesh; the OVE User Manager with services bridge IQ+ 1550 includes provisioning for adding biological classification Database and storage for enhancing user profile services and capabilities; the OVE Services Management 1555 includes observability and metrics for all OVE Mesh service accounts; the service bridge devices Threshold Sensor & Network Controls 1560 provides comprehensive tracking and logging of production events with end product records of usage and ownership; the Biometric Input Settings 1565 provide complete control over the types and priority of biometric input including selection of default biometric controls; the OVE validated user (bio-origin) Classification Profiles 1570 use biological classification database and BAAC Scoring & Threat Management 1590 to analyze and determine OVE validated user (bio-origin) taxonomy and phenotype.

A OVE (bio-origin) Validated User Object Smart Asset Storage 1575 secures all digital assets including OVE (bio-origin) Validated Object including using the OVE DLT Units blockchain. OVE (bio-origin) Validated Object Management & Settings 1595 include selection of consideration models and exchange types including fiat and digital;

Services Bridge Controls 1580 and Services Bridge Cluster & VM Status 1585 combine with INI to monitor and protect OVE Mesh assets.

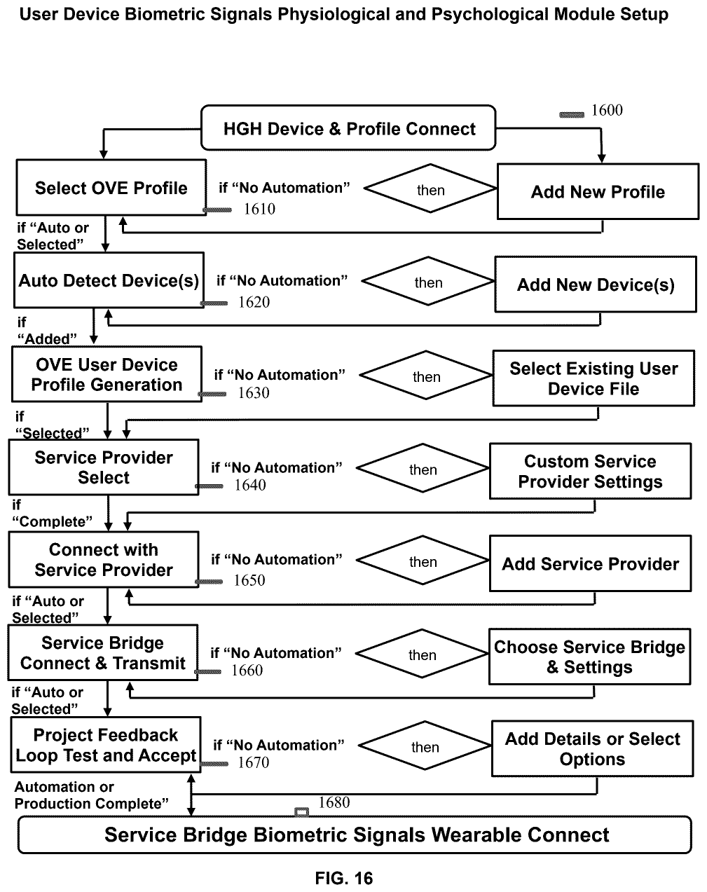

Referring to FIG. 16 a simplified diagram of the OVE INI Intelligent Services Activation Flow Diagram of the invention in accordance with various embodiments described herein.

service bridge devices Activation

Select Service Bridge User Devices Profile or Service→if “No Automation” then Add New Profile 1610 if “Auto or Selected”

The default Service Bridge User Devices Profile a wearable sports watch or similar device with an open API that is programmable and will transmit biometric signals to a local device and anonymize when transmitting to a services bridge (services bridge).

Auto Detect Device(s)→if “No Automation” then Add New Device(s) 1620 if “Added”

The Auto Detection is a component of the INI Circuit and includes advanced signaling modeling. Auto Detection is part of the local device application and has many forms and programmable detection protocols including those within wireless technologies such as bluetooth.

OVE (bio-origin) Validated User Profile Generation if “No Automation” then Select Existing OVE (bio-origin) Validated User File 1630 if “Selected”

The OVE (bio-origin) Validated User Profile is held by the OVE Account in the DDFS file system for recovery to new device and in the event the local device is no longer in use.

Service Provider Select→if “No Automation” then Customer Service Provider Settings 1640 if “Complete”

The Service Provider is any product or service that generates an outcome or output the User wishes to interact. It includes a plurality of modalities and types of models.

Connect with Service Provider→if “No Automation” then Add Service Provider 1350 if “Auto or Selected”

OVE (bio-origin) Validated User Services Bridge Connect & Transmit→if “No Automation” then Choose Origin Services Bridge & Settings 1660 if “Auto or Selected”

The OVE (bio-origin) Validated User Bridge Connect & Transmit tests the connection for integrity and protection of the User. If the device is using bluetooth it looks for a secure bluetooth version and protocol and then connect the local device and memory storage for the raw biometric signals. It then creates an anonymized biometric signal profile and records this slice or time based profile into the User's OVE Account. This time bases slice may be used by the User to set physiological and psychological fingerprints such as emotions based alerts based on activity within the services bridge.

Project Feedback Loop Accept→if “No Automation” then Add Details or Select Options 1670 Automation or Production Complete

The Project Feedback Loop Test and Accept sends a biometric signals test time slice of service bridge user devices biometric signals in time and asks the User to accept on the service bridge devices UI/GUI to confirm the system is working and ready for interaction with the Service Provider's Agent.

### Service Bridge Biometric Signals Wearable Connect 1680.

The service bridge devices include biometric signals devices that delivers raw or conditioned biometric signals with or without psychological and advanced physiological processing.

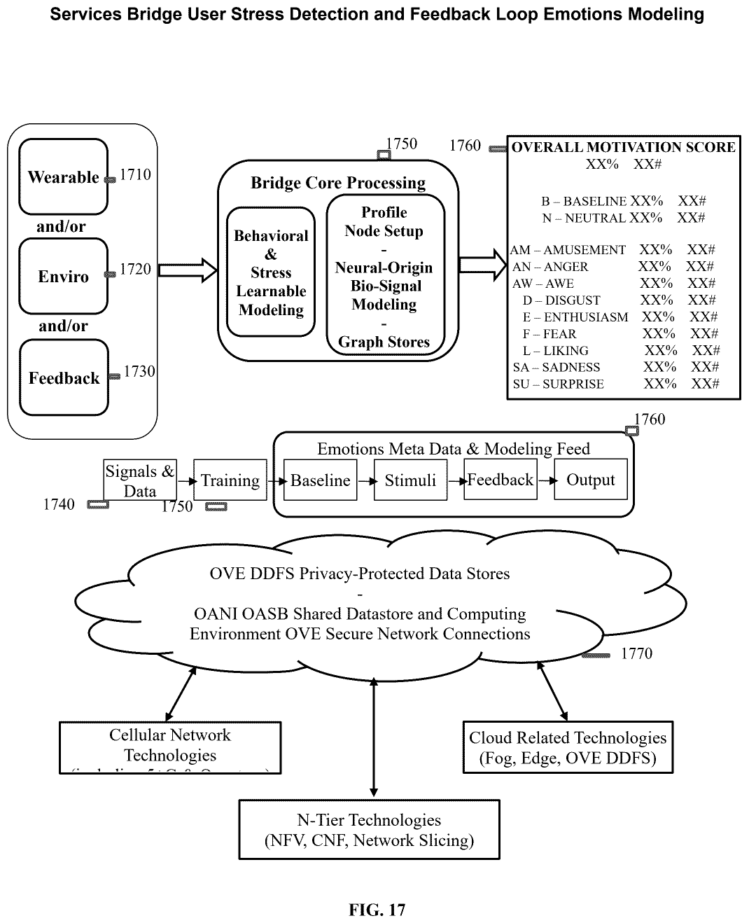

Referencing to FIG. 17 is a simplified diagram of the Services Bridge User Stress Detection and Feedback Loop Emotions Modeling of the invention in accordance with various embodiments described herein.

The OVE (bio-origin) Validated User Services Bridge and INI Stress Detection & Emotion Modeling Biometric Signals Modeling including: Wearable 1710, Environmental 1720, and Feedback Stimuli and Input 1730.

The Bridge Core Biological Classification Database and Datastore 1750 uses: Behavioral & Stress Learnable Modeling; OVE DDFS Graph Learning; OVE Graph Inception of Data; ML Learning and Training Data Pool.

The system provides an Overall Motivation Score using a XX % of the time based slice profile with manual trained modeling and a scoring XX #based on User average inputs:
EMOTIONS % Results #Scoring
   BASELINE XX % XX #;
   NEUTRAL XX % XX #;
   AMUSEMENT XX % XX #;
   ANGER XX % XX #;
   AWE XX % XX #;
   ANGER XX % XX #;
   DISGUST XX % XX #;
   ENTHUSIASM XX % XX #;
   FEAR XX % XX #;
   LIKING XX % XX #;
   SADNESS XX % XX #;
   SURPRISE XX % XX #.

This is an example of the data table and uses the statistical average. Underlying data including modeling of average percentage each emotion is present and scoring of accuracy is used including with machine learning to optimize detection of biometric signal states with the use of INI and services bridge biometric signal slicing and time based fingerprinting based on manual and automated feedback loops.

Emotions Meta Data & Modeling Feed System receives; Signals and Data 1740; Creating Training Data 1750; Creating a Baseline; Assessing Stimuli; Providing Feedback; and then Biological classification Database Output 1760.

OVE DDFS Privacy-Protected Data Stores 1770 & INI services bridge Shared Datastore and Computing Environment OVE Secure Network Connections 1770 to Cellular, Cloud, Fog, Edge & OVE DDFS DataStores.

INI N-Tier Technologies (NFV, CNF, Network Slicing) is included for Universal Access to OVE and INI Services.

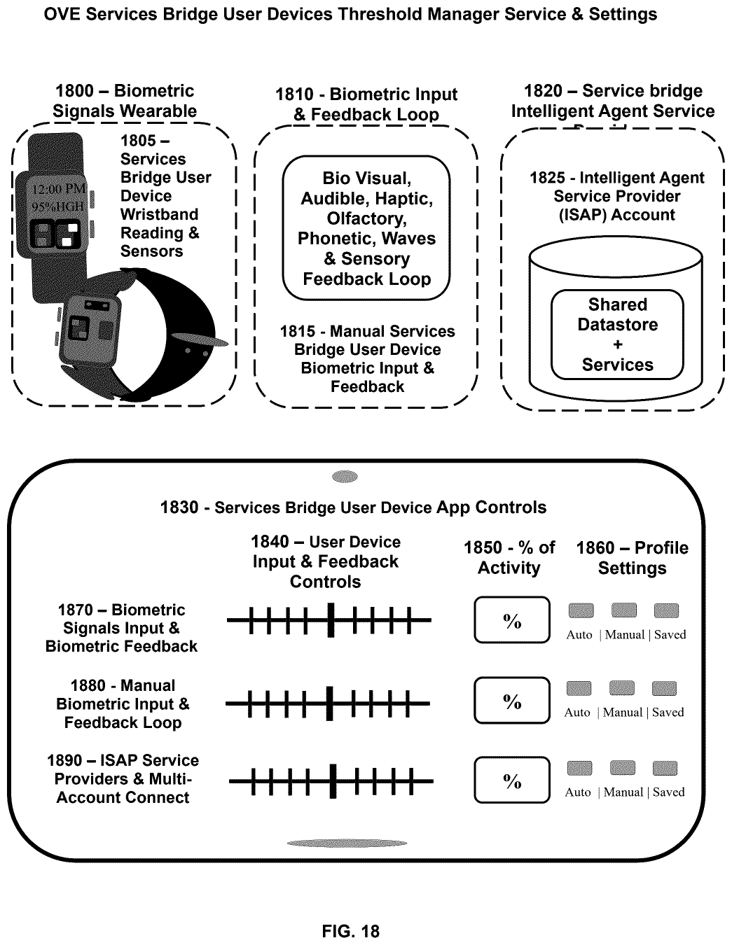

Referring to FIG. 18, the simplified overview of the OVE Services Bridge User Devices Threshold Manager Services & Settings components of the invention in accordance with various embodiments described herein.

This embodiment is an OVE Services Bridge User Devices Threshold Manager Services Settings & Controls Architecture & Framework for Services & Components of the OVE Mesh and Services Bridge Management System. The controls available are limited only by the needs of the Users.

Based on required metrics from systems the Sidecar Proxy utilizes Envoy xDS API's.

The Envoy Sidecar Proxy provides the service bridge devices Threshold System with general and granular settings. The OVE Mesh Istio XCP platform provides the service bridge devices Threshold System with metrics for display of “% of Activity” 1850 with Profile Settings 1860 including auto, manual or saved.

A Physiological & Psychological Biometric Signals Integration & Bridge Core Modules API with OVE validated user (bio-origin) Time Based Slice Fingerprint and Signature creation 1815.

The OVE Mesh with INI provides a comprehensive model for tracking and analyzing service bridge devices activity.

An service bridge devices biometric signals Market Wristband with psychological and physiological tracker and multi-directional biometric signals streams to and from OVE services bridge service can be used for service bridge devices biometric signals Input from a OVE Account or User. These service bridge devices can include: blood volume pulse and signature; changes in electrical properties; motion based activity; infrared readings and other biometric sensors and controls.

The following are some of the functions that can be implemented within the service bridge devices default wearable with the OVE App and services bridge Service Bridge Connect 1830 for the service bridge devices Threshold System:
PPG Sensor measuring Blood Volume Pulse (BVP) for heart rate variability and signature
Infrared Thermopile reads peripheral skin temperature
EDA Sensor (GSR Sensor) measuring the changes in electrical properties of the skin
Internal Real-Time Clock 5 ppm high accuracy time reference
3-Axis Accelerometer for motion based activity
service bridge devices biometric signals Events Mark Button to Tag events and link them to physiological biometric signals

These service bridge devices Modules can include Multi User & Device Services Bridge Profiles with OVE Validation using the service bridge devices Connect and Streaming Service and Settings.

These service bridge devices can include Offline Data Storage for download of learning and training data when connected.

Some of the services active during the service bridge devices system operation include:
Detect & Validate
Connect
Biometric Signals Storage
Cloud

The user devices (service bridge devices) detection and monitoring system includes Wearable Devices 1800 with Wireless Connect to service bridge devices Service Bridge App 1805, Biometric Input & Feedback Loop Dialog 1810 with Multi-Modal Biometrics 1815:
Bio Visual
Audible
Olfactory
Phonetic
Waves
Sensory Feedback
Feedback Loop Dialog

and Services Bridge Intelligent Agent Service Providers 1820 with Intelligent Agent Service Provider (ISAP) Account with Shared Datastore and Services 1825.

The Service Bridge Devices Threshold Detection and Management App Controls 1830 are integrated into the OVE Mesh Istio XCP platform utilizing Python and Sidecar Proxy Controls.

Variable based settings 1840 can be made to each service including:
Service Bridge Devices Service Bridge App 1870
Biometric Signals Input & Feedback Loop Dialog 1880
Service Bridge Devices & ISAP Output View 1890

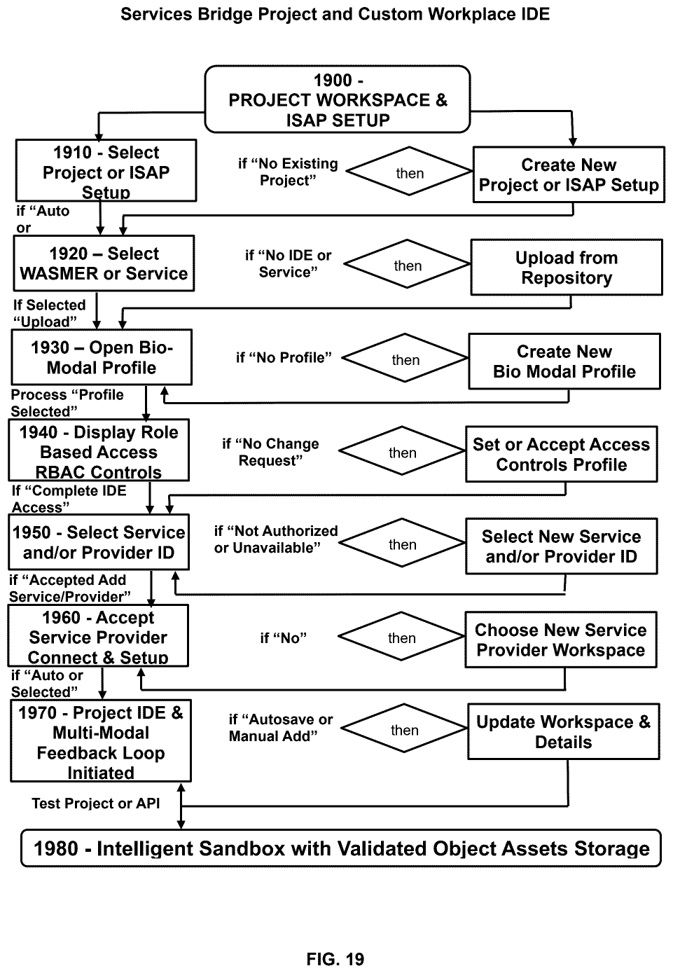

Referring to FIG. 19, the simplified overview of the Services Bridge Project and Custom Workplace Independent Development Environment (IDE) components of the invention in accordance with various embodiments described herein.

This embodiment is an services bridge IDE, Project & Workspace Setup Manager & Services Controls Architecture & Framework for Services & Components of the OVE Mesh and services bridge Management System. The controls available are limited only by the needs of the Users.

The OVE Mesh platform includes an API' for an Independent Development Environment (IDE) for developers with API Publishing, with default WASM or WASMER tools with universal integration with coding services and repositories.

As an example the WASMER service provides integration with Python, Tensor and other coding environments a Run, Publish & Deploy code anywhere architecture. The WASM extension resource allows defining custom WASM extensions that are packaged in OCI images. The resource allows specifying extension metadata.

The coding can provide custom applications for multi-modal biometric input and feedback loops 1915 including:
Bio Visual
Audible
Olfactory
Phonetic
Waves
Sensory Feedback
Feedback Loop Dialog

The extensions can be referenced in Sidecar Proxy Ingress and Egress Gateways and Security Groups so that traffic is captured and biological classification databasessed by the extension as outlined in the program, Python module or TensorFlow models.

An example of setup and sandbox of an project build is as follows:

### Services Bridge Project Workspace & ISAP Setup 1900

### Select Project or ISAP Setup

if “No Existing Project” then Create New Project or ISAP Setup 1910
if “Auto or Selected” Activate IDE, Coding Service
if “No IDE or Service” then Upload from Repository 1920
if Selected “Upload” Open Bio-Modal Profile
if “No Profile” then Create New Bio-Modal Profile 1930
Biological classification databases “Profile Selected” & Display Role Based Access & Controls
if No Change Request” then Accept Access Controls Profile 1940
If “Complete IDE Access” Select Service & Provider ID Terms & Conditions then
if “Not Authorized of Unavailable” Select Service & Provider ID 1950
if “accepted Add Service/Provider” Accept Services Bridge Connect & Setup Workspace
if “No” then Choose New Services Bridge Workspace & Settings 1960
if “Auto or Selected” Project IDE & Multi-Modal Feedback Loop Initiated
if “Autosave or Manual Add” then update Workspace & Details Loop 1970

Test Project or API to Intelligent Sandbox|Services Bridge Project and Custom Workplace Independent Development Environment (IDE) 1980.

This IDE and Workspace provides all developers including Service Providers with unlimited possible applications and services. For access of the OVE (bio-origin) validated object Objects using outside code it would need to be validated by OVE therefore review for any code or compliance issues with an OVE certificate issued for those IDE objects.

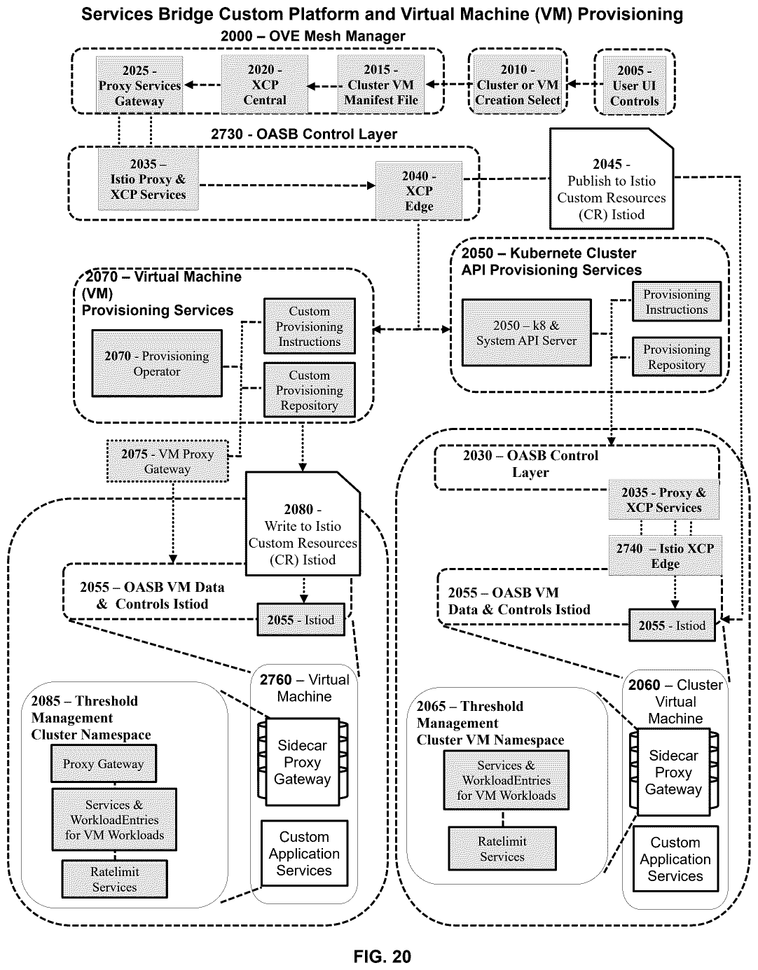

Referencing FIG. 20, the simplified diagram of the OVE Cluster & services bridge Virtual Machine (VM) Install & Control components of the invention in accordance with various embodiments described herein.

This embodiment is an OVE Cluster & services bridge Virtual Machine Provisioning Services & Components for the OVE Mesh and services bridge Control System. The controls and types of frameworks available are limited only by the needs of the Users.

The IstioOperator API is used to install the OVE Mesh. The steps for the OVE Mesh services bridge install are as follows:
1. OIDC OpenID Connect
2. Install OVE services bridge's Mesh Management
3. Onboard Clusters that Host Applications
4. Deploy and Configure Ingress Proxies
5. Setup ImagePullSecrets for OVE services bridge Images stored in private remote repository (ovemesh.co)
6. GitOps with the Service Mesh

The OVE Mesh and services bridge architecture provides simplified provisioning of new clusters and VM's. The components, services and biological classification database includes: OVE Mesh Manager 2000; User UI Controls 2005; Cluster or VM Select 2010; Cluster VM Manifest File 2015; XCP Central 2020; Proxy Services Gateway 2025; services bridge VM Data Controls Istiod 2030; Istio XCP Services 2035; XCP Edge 2040; Publish to IStio Custum Resources (CR) Istiod 2045; Kubernetes Cluster API Provisioning Services 2050 k8 API Server; services bridge VM Data & Conrtrols Istiod 2055; Cluster Virtual Machine (VM) with Sidecar Proxy Gateway & Custom Application Services 2060; Threshold Management Cluster VM Namespace 2065; Virtual Machine (VM) Provisioning Services with Custsom Provisioning Operator, Intructions & Repositories; 2070; VM Proxy Gateway 2075; Write to Istio Custom Resources (CR) Istiod 2780; and Threshold Management Cluster Namespace 2785.

services bridge Control Layer and Git (ovemesh.co)

OVE services bridge GitOps flow:

Receiving configuration from a CI/CD system.

OVE services bridge Mesh Manager 2005 checking configuration in to git that your existing CI/CD system deploys into each cluster.

The flow from Git to the Edge.

OVE services bridge API Server stores the data in its datastore

OVE services bridge pushes configuration to XCP Central 855

OVE services bridge Central pushes configuration to XCP Edge 2015 instances

OVE services bridge Edge stores incoming objects in the control plane's namespace 2080 (istio-system by default)

OVE services bridge Edge subscribes to updates in control planes namespace and publishes native Istio objects when those resources change

Istio biological classification database the configuration and pushes it to Proxys just like normal

Out of band of user configuration, service discovery information is collected and distributed by XCP Central 855 across XCP Edge 2015 instances:

OVE services bridge Edge sends updates to XCP Central 855 about exposed Services

OVE services bridge Central 880 distributes this cluster state to each of the XCP Edges 2015

OVE services bridge Edge 2015 updates configurations in the multi-cluster namespace 2090 (xcp-multicluster) if necessary

OVE services bridge Edge subscribes to updates in the multi-cluster namespace 2090 and publishes native Istio objects when those resources change

Istio biological classification database the configuration and pushes it to Proxys just like normal.

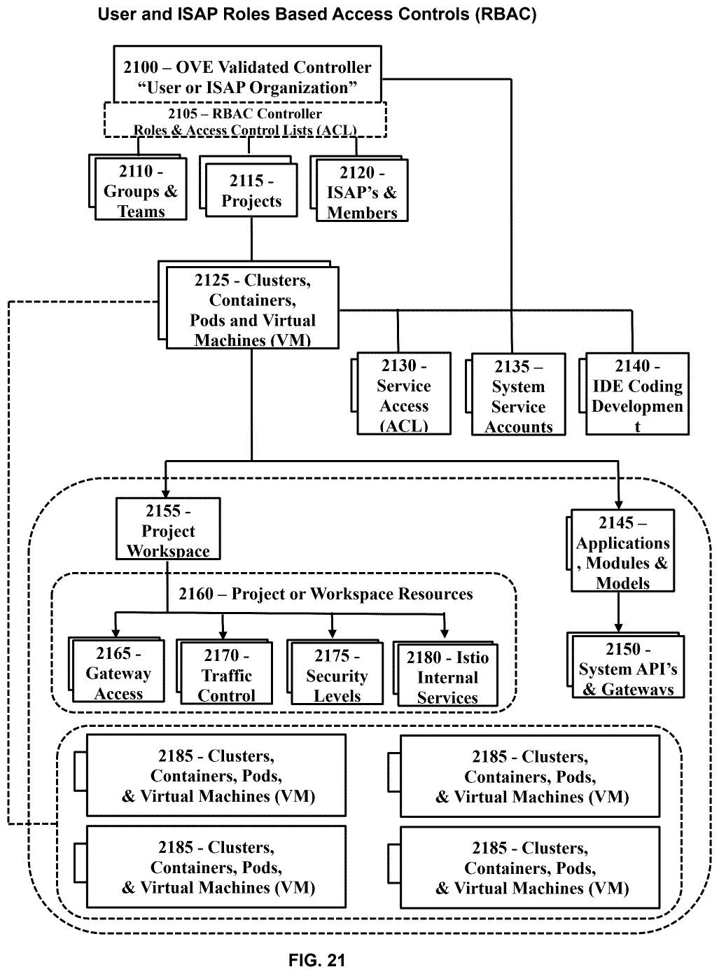

Referring to FIG. 21, the simplified diagram of the services bridge Roles & Permissions (RBAC) Access Controls components of the invention in accordance with various embodiments described herein.

This embodiment is a Roles & Permissions Access Control (RBAC) System Services & Components for the OVE Mesh and services bridge system. The controls and types of frameworks available are limited only by the needs of the Users.

### Services Bridge Roles & Permissions (RBAC) Controls

The OVE Manager is the primary access point to everything for the OVE User or ISAP Organization for user management, project controls, networking, security, and observability using the OVE or services bridge UI. A centralized control in a Multi Cluster or Virtual Machine (VM) service structure uses the mesh architecture.

The services bridge Control Panel & XCP is part of the OVE Manager. It provides mesh-managed services for the services bridge system as a whole, and manages and controls the state of the entire OVE and services bridge ecosystem. It provides multi-cluster features on top of the different services bridge Control Panels.

Services Bridge Control Services use an Istio service mesh that is deployed in every cluster to create isolated failure domains between clusters. It allows services bridge to make use of all the features of Istio, including enforcing mTLS between applications, as well as making intelligent networking and traffic routing decisions between microservices within each cluster.

The OVE & Services Bridge Data Framework enables data transfer between services using Sidecar Proxies that control access to OVE and services bridge services and mesh microservices. The proxy framework provides secure granular data and intelligent routing control on behalf of applications and modules.

The sidecar proxy is used for access to applications and modules as part of the mesh. They intercept all traffic into and out of the containers and clusters including applications and modules. This framework allows the service to implements user management, application and module access, traffic, security, and observability control features in the OVE platform and ecosystem.

### The OVE Manager

The OVE Manager is the primary access point for the services bridge. It uses the Istio open source service mesh framework and architecture to provide a transparent language-independent way to flexibly and easily automate application network functions. Istio sidecar L7 proxy and communications system is used as a form a transparent communication mesh in which each application sends and receives messages to and from localhost and is unaware of the network topology.

It manages the OVE services bridge ecosystem and services to deliver a full stack bio validation platform with OVE validated user (bio-origin) Awareness authentication and authorization.

The XPC service registry is a central operator point. The proxy gateway is a primary access point that accepts incoming traffic to services bridge components, such as API calls. The Observability Application Platform (OAP) and Application Performance Monitor (APM) include distributed tracing, service mesh telemetry analysis and metrics aggregation for real time data tracking and analysis from the OVE and services bridge service mesh.

### The OVE Services Bridge

Also utilizes the Istio service mesh architecture to build compute platforms for teams and projects. It provides automated services to create pods, containers and virtual machines for integration with Intelligent Services Agent Providers. It can also become part of an ISAP Organization with an OVE validated user as the OVE Manager OVE Account.

### RBAC and Roles

Access Bindings are used to bind Roles to a set of users or teams.

Below is a list of primary permissions available:
Read: Allows reading the resource.
Write: Allows updating the resource.
Create: Allows creating child resources.
Delete: Allows deleting the resource.
SetPolicy: Allows delegating control of the resource to other users.

Both User and ISAP Organization roles give full control to the OVE services bridge platform.

Access Binding objects define the binding between a set of roles to a set of users or teams for a specific OVE services bridge resource.

Platform Team Members act as Supervisors. They can create Projects, Workspaces, Config Groups, and grant access to these resources to specific teams

App Team Members are able to configure their applications that run in specific namespaces. Specifically, they own a specific Traffic Group in the Project or Workspace that they work on.

Security Team Members are able to read everything under a Cluster or Project, and configure Security Group settings in the Project or Workspaces.

2100—OVE Validated OVE Account “User or ISAP Organization”

The OVE Validated OVE Account “OVE Account” has access to the OVE Mesh infrastructure. The OVE Account manages all user including Intelligent Service Agent Providers (ISAP) and Organizations within that account and cluster.

2115—Projects

A Project represents a workspace of shared resources, and common access with specific privileges (including read, write).

2155—Project Workspace

A Project Workspace is a zone where Project Teams manage exclusively-owned Workspaces. All service related configurations associated with that team's workspaces are delivered by the Project Workplace RBAC managed by the OVE Manager.

2130—Service Access (ACL)

A network servable/addressable destination for service independently authenticated within the OVE services bridge platform by RBAC.

2135—System Service Account

An service access point with access binding for roles and permissions with service independently authenticated within the OVE services bridge platform.

2140—IDE Coding Development Environment

An independent coding environment for the platform with API access.

2160—Project or Workspace Resources

Resources with roles and permission access control under a Project Workspace. Services such as: INI Gateway Access; 2170 Traffic Control; 2175 Security Levels; and 2180 Istio/Istiod Internal.

2145—Applications, Modules and Models

Application, Modules and Models “Applications” expose a set of APIs that can be used by the Developer or API Publisher including in the Project Workplace with Project Teams. Applications are configured based on user roles and permissions. The Project Workplace is developer-centric for the User, ISAP and other Project Members.

2150—System API's & Gateway

The Application, Modules & Models APIs provide developer-centric Application Ingress Gateways including OpenAPI. The framework is designed to be agnostic of the infrastructure so ISAP and Developers can leverage their applications, modules and services without details exposed to underlying compute and networking technologies.

2120—ISAP's & Member Models

Users or ISAP and Member models in services bridge include both human and a non-person such as Intelligent Services. They can be grouped into Project Teams controlled by an OVE validated User. Users can be assigned access to resources with OVE Roles Based Access Control API's. You can create and manage Users in OVE and services bridge manually and invite or sync new Project Workplace Team Members.

2110—Groups & Teams

A Project Team is a group of User or ISAP's that are assigned access to resources within the OVE Manager and services bridge Control Panel. Groups can consist of either Users, Services of Devices controlled by the Istio XCP OVE Mesh or services bridge.

2185—Failover and Load Balancing

A load balancing gateway includes the edge of a mesh receiving incoming or outgoing HTTP/TCP connections. In a multi-cluster services bridge ecosystem the gateways:

Application Edge Gateway (also called a “Tier 1 Gateway”) distributes traffic across one or more ingress gateways in other clusters over Istio mTLS.

Application Ingress Gateway (also called a “Tier 2 Gateway”) distributes traffic to one or more workloads (business application services) running in the cluster.
an Edge Gateway: communicating over Istio mTLS. Then the mesh started at that Edge Gateway.
a Client on the internet (outside OVE services bridge).
a service running on another cluster in OVE services bridge.

EastWest Gateway provides a gateway services routing and failover across multiple clusters. EastWest gateways are quick and simple to configure, and provide high-availability for services without explicit service configuration. Services in one cluster send traffic to remote cluster service using Istio mTLS through EastWest Gateway.

Egress Gateway provides a gateway for traffic originating from one or more project workloads (business application services) running in the cluster to external services outside the mesh.

VM Gateway provides a gateway for traffic originating from provisioned VMs to route correctly to other mesh workloads.

All aspects of the ISTIO and XCP Mesh provide OVE with End-to-End Observability and Telemetry with Logs and Tracking to validate OVE Validated Users and Objects ONLY within the OVE Secure Network.

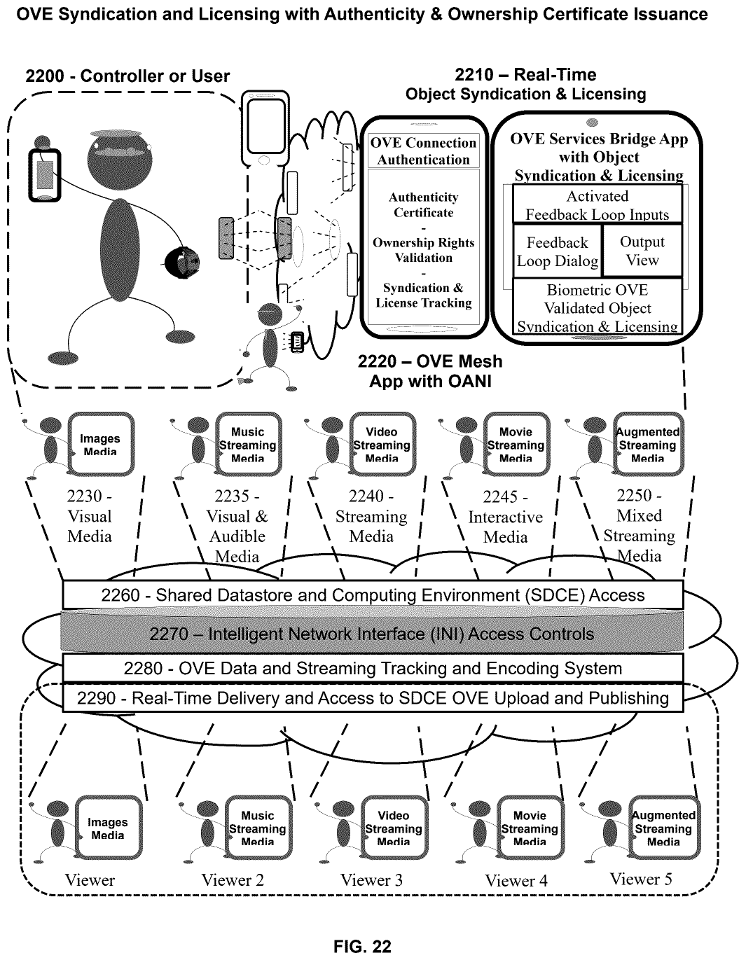

Referring to FIG. 22, is a simplified overview of the a Real Time OVE validated user (bio-origin) Licensing & Syndication Platform using Authenticity & Ownership Certificate Issuance components of the invention in accordance with various embodiments described herein.

This embodiment is an Authenticity & Ownership Certificate Issuance provides OVE Users with Real Time OVE validated user (bio-origin) Licensing & Syndication including integration within Services & Components of the OVE Mesh and Services Bridge Management System. The controls available are limited only by the needs of the Users.

This default platform is an example of what can be designed and implemented with the IDE and Workspace functions within the OVE ecosystem.

The User in this example has already received an Authenticity Certificate and Ownership Rights Validation 2220 from OVE and service bridge devices Threshold data.

The OVE Account or User 2200 is the primary manager of the licensing and syndication settings and management.

A Real Time OVE (bio-origin) Validated Object Syndication & Licensing 2210 and Authenticator App 2220 provide authorization to a plurality of methods to syndicate and track licensing and authorization including for:
Visual Media—2230
Visual & Audible Media—2235
Streaming Media—2240
Interactive Media—2245
Mixed Streaming Media—2250

The OVE Origin & Validation for User Registered Data Store Access 2260 provides control including granular RBAC for licensing and syndication. The INI with OVE Access Controls 2270 provides network wide daemons, tracking and monitoring. The OVE with INI Data and Streaming Tracking and Encoding System 2280 provides ID encoding of digital assets. The Real-Time Delivery and Access to the Shared Datastore and Computing Environment (SDCE) automatically uploads and publishes the OVE (bio-origin) Validated Object with products or services when the product or service outcomes or output is validated by OVE as authentic and with ownership rights 2290 is used to control access to digital assets.

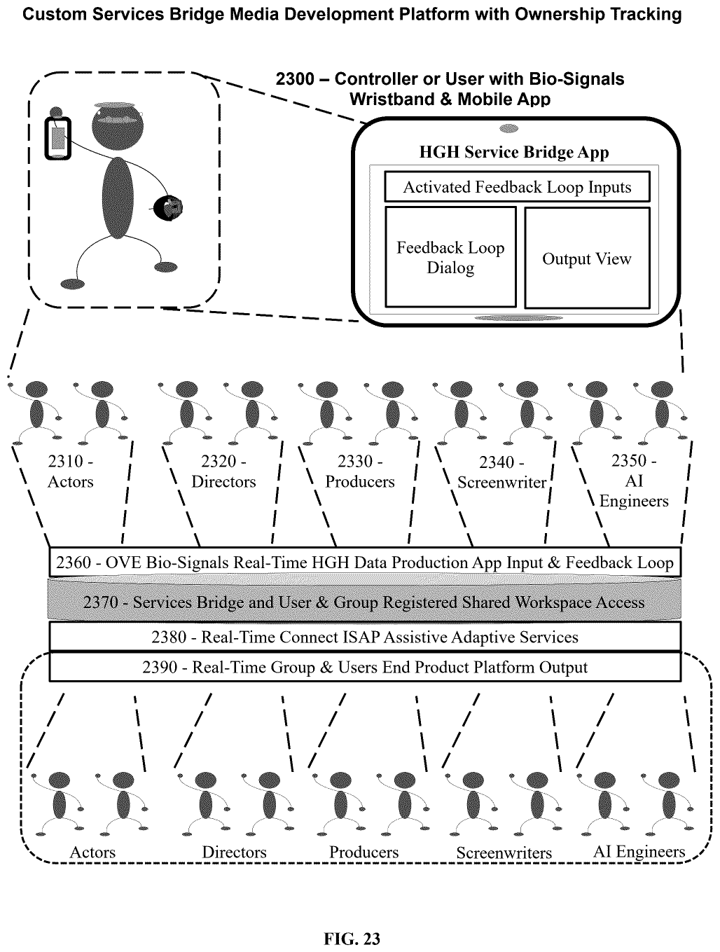

Referring to FIG. 23, the simplified overview of the Multi-User Services Bridge Streaming Media Production components of the invention in accordance with various embodiments described herein.

This embodiment is an Multi-User Services Bridge Streaming Media Production Services & Components of the OVE Mesh and Services Bridge Management System. The controls available are limited only by the needs of the Users.

The use of the IDE and Development Environment can create almost any platform and model for the use of OVE, INI and services bridge. This example uses the service bridge devices Wearable and Environmental Devices with a Multi-User Multi-Device Multimodal services bridge Environment.

### Multi-User Multi-Device Multi-User Services Bridge Streaming Media Production & Services

The OVE Account or User with the service bridge devices biometric signals Wristband & OVE Mesh with services bridge Services Mobile App—2300 manages a group of OVE validated:
Actors—2310
Directors—2320
Producers—2330
Screenwriters—2340
AI Engineers—2350

The OVE Biometric Signals Real-Time Service Bridge Devices Data Production App Input & Feedback Loop 2360 provides a User Interface (UI) for settings, adjustments and input of content and services for the production.

The Services Bridge User & Group Registered Shared Workspace Access 2370 provides the platform for the group shared end product view of production.

The Real-Time Connect ISAP Services Assistive Adaptive Services 2380 provide service bridge devices and other settings and adjustments to ownership of content and end product.

The Real-Time End Product Group & ISAP Platform Output 2390 is the end product storage point for syndication and distribution.

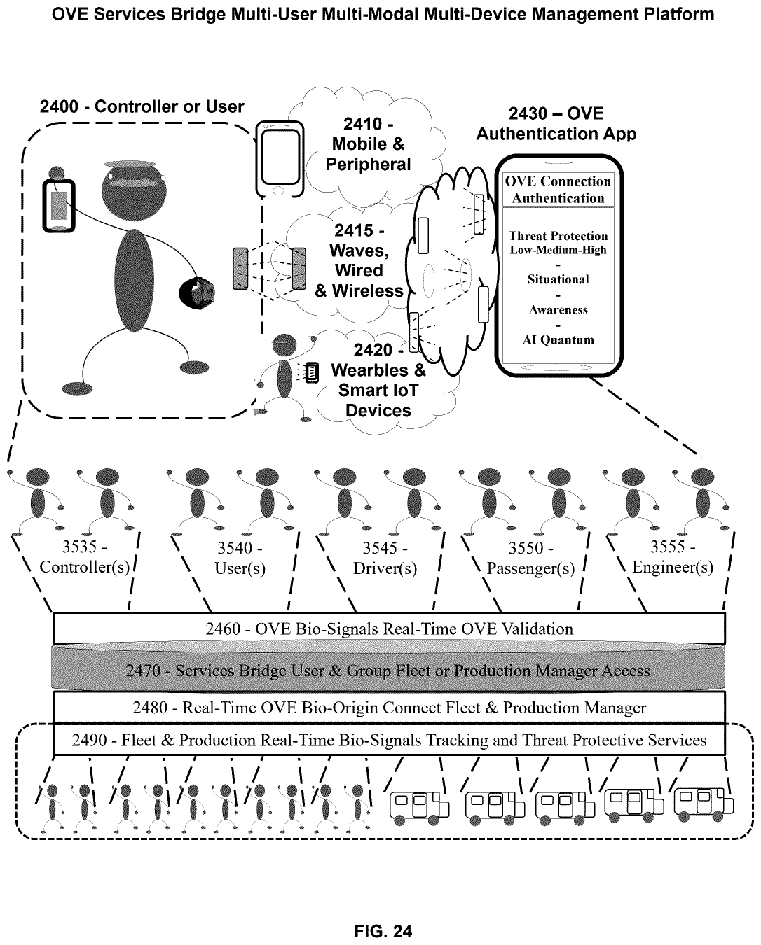

Referring to FIG. 24, the simplified overview of the OVE Mesh services bridge Threat & Device Protection components of the invention in accordance with various embodiments described herein.

This embodiment is an OVE Mesh services bridge Threat & Device Protection for Services & Components of the OVE Mesh and Services Bridge Management System. The controls available are limited only by the needs of the Users.

Services Bridge Multi User ISAP Cluster (Intelligent Service Agent Provider services bridge OVE User Integration)

This is a custom services bridge platform that utilizes many aspects of the OVE ecosystem to deliver its product and service. The use of the OVE Validated Users Secure Network, INI Session and Access Controls, OVE validated user (bio-origin) Validated Objects Only, OVE validated user (bio-origin) Validated Systems and Devices, BAAC Bio Awareness Access Controls and ML and Neural Protection Algorithms provide a comprehensive Intrusion Detection (IDS) and Prevention (IDP) for device based management platforms.

The OVE Account or User 2400 is the primary manager of the protective intelligent services.

A plurality of methods can be used to connect in the security and management platform including:
Mobile or Peripheral—2410
Waves, Wired & Wireless—2415
Wearables & Smart IoT Devices—2420

OVE Authentication App—2430 can be used to further protect devices and proximity of users. The app can be used by:
OVE Account(s)—2435
User(s)—2440
Driver(s)—2445
Passengers(s)—2450
Engineers(s)—2455

OVE Biometric Signals Real-Time OVE Validation 2460 is used to validate real human users. A Services Bridge User & Group Fleet or Production Manager Access 3570 control is used to protect and manage the devices and users. A Real-Time Connect AI Fleet or Production Manager 3580 provides an application for management of security, fleet and production services. Fleet or Production Real-Time biometric signals Tracking and Threat Protective Services 3590 use network wide daemons and OVE Accounts to protect against malicious threats and for traffic management.

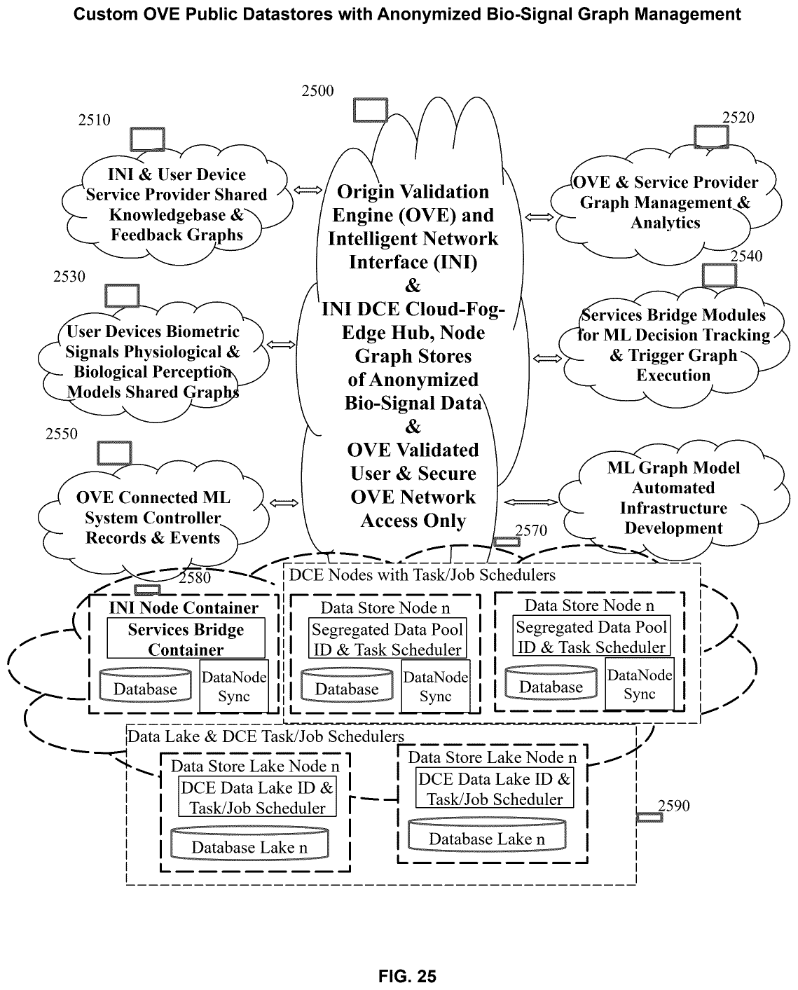

Referencing to FIG. 25 is a simplified diagram of the Custom OVE services bridge Platform Anonymized Biometric Signal Graph Management and Programming System of the invention in accordance with various embodiments described herein.

This use of a public OVE Validated Users Only Anonymized biometric signals Platform provides a unique opportunity for Personalized Medical Applications. Combined with the IDE Workspace the products and services possible are almost limitless in scope.

This is only one of a plurality of potential use cases that benefit Users of the OVE ecosystem and the use of anonymized biometric signals data.

This OVE Classification system utilizes several Graph Programming Models within the Default Primary Graph Programming and Storage Framework.

An Origin Validation Engine (OVE) and Origin Awareness Neural System (OANS) Shared INI DCE Cloud-Fog-Edge Hub, Node Graph Stores 2500 includes: an OVE & Service Provider Shared Knowledgebase and Feedback Graphs 2510 for ML Training and Learning Datastores; an OVE & Service Provider Graph Management & Analytics 2520 for analytics used for triggering graph events; a biometric signals Physiological & Psychological Perception Models Shared Graphs 2530 for broader understanding and optimization of biometric feedback and stress emotion tracking and detection for real time biometric signal feeds and monetization; INI Modules for ML Decision Tracking & Trigger Graph Execution 2540; an OVE & AONS Connected ML System OVE Account Records & Events 2550 for optimization of OVE Validation Events; and an OVE service bridge devices Graph Model Automated Infrastructure Development 2560 store for models and code for autonomous expansion of the OVE and INI network and system.

The biometric signals ML Models include Local and Network DCE Managers. The OVE and INI classification system also provides critical data necessary for creation of biometric signals raw biometric source models or OVE (bio-origin) Validated User real time biometric signals biological classification techniques and protocols development.

The graph system uses several programmable techniques to develop and optimize data for developing new models and protocols including:

biometric signal Physiological and Biological Environmental Real Time Insights using Parallel Breadth-First Search (BFS) or traverses a tree data structure by fanning out to explore the nearest neighbors and then their sub-level neighbors and GPS to pinpoint nearby locations and services for biometric signal or physiological purpose within a specific distance.

biometric signal Parallel Depth-First Search (DFS) to target biometric signal and origin endpoints using a gaming simulations technique where each choice or action leads to another, expanding into a tree-shaped graph of possibilities. This is also part of INI and Services Bridge automated feedback development. This method will traverse the choice tree until it discovers an optimal solution path to achieve its goals.

OVE (bio-origin) Validated User Single-Source Shortest Path (SSSP) calculates a path between a node and all other nodes whose summed value (weight of relationships such as cost, distance, time or capacity) to all other nodes are minimal to automatically obtain bio signal locations for least-cost network routing.

Bio All-Pairs Shortest Path (APSP) calculates the shortest path forest (group) containing all shortest paths between the nodes in the graph. Commonly used for understanding alternate routing when the shortest route is blocked or becomes sub-optimal key in logical routing to offer multiple paths for network routing alternatives. This can optimize INI and OVE network efficiency and costs of OVE network operations.

Micro OVE Account Minimum Weight Spanning Tree (MWST) calculates the paths along a connected tree structure with the smallest value (weight of the relationship such as cost, time or capacity) widely for network designs and efficient usage of micro OVE Account and circuit designs and routing. It uses real-time applications with rolling optimizations.

Bio Influencers Centrality Algorithms are used to estimate importance such as rank or rating which estimates a current node's importance from its linked neighbors and then again from their neighbors. An node's rank is derived from the number and quality of its transitive links to estimate influence and a way of detecting bio influential nodes in any network and for general sentiment analysis.

Biometric Signal Modeled for Machine Learning to identify the most influential features for Biometric Signal Signature Extraction using physiological and biological ontology.

Biometric Signals Degree Centrality is used to measures the number of Biometric Signal Relationships in a node (or an entire graph) has. It's broken into indegree (flowing in) and outdegree (flowing out) where biometric signal relationships are directed. It looks at immediate connectedness for OVE validated user (bio-origin) uses. It is used to estimate popularity and outdegree including for emotion detection and rating.

Bio Influencer Closeness Centrality measures how central a node is to all its neighbors within its cluster. Nodes with the shortest paths to all other nodes are assumed to be able to reach the entire group the fastest and is applicable in a number of resources, communication and behavioral analysis, especially when interaction speed is significant for faster dissemination or syndication of service providers products or services information.

Betweenness Centrality measures the number of shortest paths (first found with Breadth-First Search) that pass through a node. Nodes that most frequently lie on shortest paths have higher betweenness centrality scores and are the bridges between different clusters. It is also used to identify associated control over the flow of resources and information and pinpoint bottlenecks or likely attack targets in communication and transportation networks.

### Biometric Signals Community Detection Algorithms Known as Clustering Algorithms or Partitioning Algorithms Include:

Categorization and Classification Label Propagation which spreads biometric signals labels based on neighborhood majorities as a means of inferring clusters. This extremely fast graph partitioning requires little prior information. It also has diverse applications for understanding consensus formation in bio influencers communities including physiological and biological characteristics in a biological classification databases (functional modules) such as the biometric feedback system. It's used for semi- and unsupervised machine learning as an initial prebiological classification Database step to locates groups of INI nodes where each INI node is reachable from every other node in the same group following the direction of bio-influencer relationships. It's applied from a depth-first search.

Bio Influencer and OVE Validated User (bio-origin) Strongly Connected enables running algorithms independently on an identified categorization and classification cluster algorithms. As a prebiological classification Database step for directed and triggered graphs, it helps quickly identify disconnected INI groups.

Bio Influencer and OVE validated user (bio-origin) Union-Find/Connected Components/Weakly Connected for detecting groups of INI nodes where each node is reachable from any other node in the same group, regardless of the direction of relationships. It provides near constant-time operations (independent of input size) to determine whether two INI nodes are in the same group. It is used in conjunction with other algorithms, especially for OVE validated user (bio-origin) bio-spoofing threat detection.

OVE (bio-origin) Validated User Louvain Modularity measures the quality (i.e., presumed accuracy) of a community grouping by comparing its relationship density to a suitably defined random network. It's often used to evaluate the organization of complex networks and community hierarchies in particular biometric signals connections. It's also useful for initial data biological classification database in unsupervised machine learning. It's also used for biometric signals and OVE (bio-origin) Validated User bio-spoofing and fraud analytics to evaluate whether a group has just a few bad behaviors or is acting as a fraud ring that would be indicated by a higher relationship density than average.

Local Clustering Coefficient/Node Clustering Coefficient for a particular node, quantifies how close neighbors are to a clique (every node is directly connected to every other node).

OVE validated user (bio-origin) Triangle-Count and Average Clustering Coefficient measuring how many nodes have triangles and the degree to which nodes tend to cluster together.

These and other graph programming and management algorithms are used to create a stable and strong OVE and OANS network for the INI. Storing OVE and OANS graph optimization models and opportunities as well sharing with service providers offers increased value for all participants in the OVE system.

The graph modeling is a fundamental building block for developing the knowledgebase and feedback system. The OVE database management system provides the context for searching new module technology and services and accelerating growth.

The system is a dynamic system using the knowledgebases as an intelligent information extraction and retrieval system. The categorization and classification system takes into consideration not only semantic but also schematic requirements. The combination of semantic and with real time categorization and classification provides real time system and data optimization and competitive growth.

A URI system with core and sub-properties ontology for the OVE and OANS graph lookup and access system is a model that is accepted and adopted by industry providing service providers with a broader range of know technology with a real time source and value of biometric signal data and OVE technology.

The ability to understand and deliver solutions based on a categorization and classification system is a traditional approach to a complex condition. The model can include any form of graph property, including ontology associated with a graph biometric signal asset property including physiology and biological data. It is a simple structure that provides unlimited definitions. A combination of graph logic resource description framework (RDF) Schema with URI graph naming provides public systems with search and discovery.

The combination of existing semantic and RDF Schema with a new world categorization and classification graph URI system provides the OVE and INI options and flexibility of a structured yet ad hoc polymorphic customizable platform.

The OVE components represent the recording and lookup databases for categorization and classification management of graphs, graph biometric signal assets, graph OVE validated user (bio-origin) assets properties, and graph service provider OVE stores.

The INI Node and INI Nodes Identification (ID) database uses URI locator biological classification database to index extracted and retrieval information. There are two forms of graph holders in this index: INI BOP Node, which is a single BOP INI graph holder; and Hubs, which is a graph holder with multiple ONAI graphs. Either can be recorded in both formats with the same Node/Nodes ID or Hub/Node(s) ID.

The system can use a plurality of database configurations including mapping system for information extraction and retrieval system Spark and MapReduce as well a plurality of database graph programming and algorithm architecture. The ad hoc polymorphic model provides an organic developing source of learning and training data. It also optimizes the delivery of OVE system services.

The OVE system can use a plurality of configurations. OVE is platform and OS independent. Those skilled in the art of full stack architecture and system including Istio and XCP mesh, microOVE Accounts and microservices, cross-compiled OS, universal OS data and network stacks, N-tier architecture, software engineering, electrical engineering, machine and deep learning neural networks, CNN, RNN, GNN, and power spectral density analysis (PSDA), GLMS and LSTM GRU with metric testing, LLMnatural language modeling, next generation network (NGN) engineering, next generation access controls (NGAC), IdP authentication, roles & permission access controls (RBAC), API management, polyglot ad hoc and ad hoc polymorphic database provisioning including database graph and algorithm modeling, IPFS DID distributed datatore file system (DDFS), database and data privacy controls, multimodal bio signatures and recognition modeling, multi modal biometric verification and authentication, multi-modal biometric input and feedback, OVE validated user (bio-origin) classification, phenotype and taxonomy, physiological and biological bio signals modeling, emotional and psychological profiling, quantum mechanics and computing, quantum waves, DLT or distributed ledger technology, abstract financial modeling, and related practices will understand the components of this invention can operate within almost unlimited scope, types, structures and architecture including those discovered during the operation of this invention.

I claim:

1. An Origin Validation Engine OVE validator system including a biological classification engine, an intelligent network interface and a services bridge, and OVE validated object and token encoding, the system comprising:
a token validation or validator system;
a biological classification system;
an intelligent network interface and circuit system;
a service bridge system;
a token status and end product encoding system;
a network and storage object encoding system;
a privacy-protected token and key store;
a privacy-protected token and key store controller;
a distributed protected datastore;
a distributed end product token and status datastore and directory;
a distributed intelligent network and bio origin signature and certificate validation and datastore;
a intelligent network and bio origin signature validation for bio-origin certificate issuance;
an artificial or intelligence service by which an end product is created;
a intelligent network interface and services bridge biometric signals tracking and logging;
a intelligent network interface and service bridge for dynamic and interactive biometric signal services;
an intelligent network interface and service bridge for dynamic and interactive streaming content and services;
a intelligent network interface and service bridge with validation controllers and stores;
a intelligent network interface and service bridge with dynamic pluggable and programmable modules;
a intelligent network interface and service bridge for dynamic and interactive biometric signals development;
a privacy protected intelligent network interface and service bridge with OVE ownership and authenticity rights and validation stores;
a distributed OVE user ownership and authenticity validation and datastore;
an OVE ownership and authenticity certificate issuance service and server;
a privacy protected intelligent network interface and service bridge with dynamic pluggable and programmable service gateways;
an OVE API for integration of authentication and authorization services into systems or services with or without a physical intelligent network interface;
an intelligent network interface and service bridge container and device ID;
a token validation of end products access and use rules with terms and parameters for new users of the end products including functions of services thereof;
a biometric app for authentication and login to OVE;
a recording of device ID data including GPS and other local and global modalities and interconnected devices;
a multi-modal multi-device multi-profile (MMDP) OVE authentication and authorization with or without a physical intelligent network interface.

2. The OVE system of claim 1 wherein the intelligent network interface and services bridge uses a validated network or storage object which can store and manage data in any size and format including data, metadata, with unique identifiers which can include methods such as parameters of use with an encoded name which can also include instructions of operation and arguments of network actions such as routing and terms of use.

3. The OVE biological classification system of claim 2 wherein a database categorization and classification of taxonomy and user device and behavior metrics is used to verify validated and registered profiles of users with protected datastores comprising of:
universal taxonomy definitions database and datastore;
categorization and classification indexing of phenotype profiles and definition of a real human as default profile;
a bio-origins lookup and validation protocol for biometric signature verification;
a bio-signals lookup and validation protocol for biometric signature verification;
a datastore of biometric definitions and detection protocols;
a software module controlling a plurality of biological definitions and processing protocols;
an intelligent network circuit board controlling a plurality of biometric signatures and signals;
a distributed computing environment DCE with virtual network functions VNF for validated users service bridge content;
a biometric detection device biometric signals detection function communication link;
biometric connections to detect biometric signals generated as a bi-directional transceiver, a sensor, a microprocessor programmed for processing biometric signals including but not limited wired and wireless bi-directional data communication links for each sensors device;
bio-signals data streams;
microprocessor programmed process to detect and acquire particular bio-signals detected by a device or device sensor;
biometric sensors in predetermined positions arranged to detect different biometric signals generated in the body;
control circuit or software providing a wire, wireless bi-directional data communications for further processing;
control software or circuit providing an unclonable physical security function;
a quantum circuit for acceleration and biometric detection.

4. The OVE system of claim 3 of wherein the intelligent network interface and services bridge of the OVE network and object or token controller refuses to issue a valid access or end product object or token if the privacy-protection intelligent network interface access token is not current or object or token state is invalid or blocked, and wherein the method comprises:
checking end product object or token status;
requesting a current bio-origin and/or access object or token from a privacy-protection controller and OVE validation system or device based code generation or privacy token;
generating and installing the requested valid token in the privacy-protection token and object key store;
receiving the valid object or token, the access being valid and active;
updating the object or token state in datastore and token sub claims or objects data;
updating the end product object or token in datastore with valid ownership and use rights;
passing anonymized OVE biometric object or token by OVE or device based code generation to an OVE connected device for authorization or authentication;
reading a machine readable end product encoding to confirm access terms and parameters are valid;
object and token validation of end products access and use rules with terms and parameters for new users of the end products including functions of services thereof,
as authorized and validated by OVE and validated by device ID, biological classification and combinations thereof,
multimodal, multi-user, multi-device MMDP OVE accounts or any combination thereof.

5. The intelligent network interface and services bridge of claim 4 wherein integration of a services bridge intelligent with intelligent network interface produces an end product in a particular manner, comprising:
a service bridge comprising one or more computing formats providing, but not limited to, at least one or more biometric signals and feedback channels of a visual, audible, haptic, olfactory and other modes and modalities in communication with a printed circuit board or software interface or bridge:
multimodal biometric signaling including but not limited to: visual; audible; haptic; olfactory; phonetic; signals; waves; and other sensory validation of any OVE validated type;
container or device including but not limited to: network objects, storage objects, computing environments that hold application code and dependencies such as binary code, libraries, and configuration files for easy deployment across different computing environments;
containers including but are not limited to: docker; kubernetes rktlet; runc and containerd which is a daemon for cloud native computing and can be used within the intelligent network interface.
a multithreaded processing of simultaneous signaling data from multiple sources concurrently may be used thereof;
a multithreaded processing of multiple simultaneous devices and multiple sources concurrently may be used thereof:
simulated Quantum signaling and processing of simultaneous biometric network data from multiple sources concurrently may be used thereof;
the intelligent network interface or services bridge modules include and are not limited to applications or other control instructions using software on chip (SoC) and ABI applications thereof;
a network, wired, wireless, haptic, or waves interface transmitting and receiving signals to and from peripheral as well as environmental devices, wherein at least one or more of stored, passed through, and processed, by the intelligent network interface and/or a services bridge thereof,
an onboard storage, remote storage or edge controller with enough memory to store, process and retrieve the intelligent network interface and/or a services bridge data thereof;
an OVE session and access system using a privacy-protected key store and object or token for origin validation for at least one or more datastores within the system, and combinations thereof,
an origin controller privacy-protected object or token key store can reside in one or more datastores thereof,
an OVE controller and privacy-protected object and token key store can access the service bridge and send and receive access data to one or more datastores within the system, and any combinations thereof,
module(s) and application(s) of at least one or more peripheral and environmental biometric signals and feedback systems of the intelligent network interface and/or services bridge provides connection conditions and rules thereof,
a polymorphic ad hoc, graph and vector database datastore provides ad hoc programming models and modules for datastores;
an operational datastore provides polyglot, polymorphic ad hoc models and schemas;
module(s) and application(s) of at least one or more peripheral and environmental biometric or biometric signals and feedback systems of the intelligent network interface and services bridge provides meta-data and signaling modalities thereof,
a intelligent network interface and/or services bridge API is provided for interactive control and management of user services and user agents;
an intelligent services end product management API is provided for interactive control and management of user services and user agents;
the intelligent network interface includes an agnostic mesh n-tier platform architecture for OVE access and validation thereof,
real time data tracking and encoding system provides real time detection of User ownership with terms and conditions including updated User data stores and logs;
a intelligent network interface and/or service bridge hardware, software or API service authentication and authorization platforms for operation of OVE thereof,
GPU processing of simultaneous signaling data from multiple sources concurrently may be used thereof,
one or more control chips and processor functions thereof,
a system clock;
and combinations thereof.

6. The intelligent network interface and service bridge of claim 5, wherein the services bridge provides an encoding system configured by the services bridge and services gateways applications and modules to manage visual, audible, phonetic and waves signal input for model data, media and data streams within OVE validated objects to:
encode network and storage objects;
media streams encoding and slicing;
real time encoding executing on a computing system;
inspecting the objects to locate streams and slicing marks;
creating an index of media content;
creating a metadata descriptor;
creating media metadata descriptors with image size, bit rate, sample rate, number segments, frame rate, size and bio-origin signatures data;
data or steaming media encoding on the server computing system in real time;
locate key descriptor frames without decoding data or media content;
creating an index of key descriptor segments or layers of the data or media content;
readable storage encoding index metadata descriptor of storage locations where data or media host, source or hostsource media objects are stored;
data or media encoded according to a different methods of production codecs for delivery of media or data streams;
a search to inspect object and media content;
an encoding service to decode or re-encode stored object media or data;
any combination with OVE thereof.

7. The intelligent network interface and services bridge of claim 6 wherein includes a bio-encoder, validation engine, intelligent network interface and a services bridge where a user requests an intelligent service or application to produce an end product in a particular manner with biometric signals integration and OVE encoding, the system comprising:
an object and token validation or validator system;
a bio-origin encoding and detection system with registry for categorization and classification of OVE;
an intelligent network interface and services bridge container and device ID system;
a distributed OVE user ownership and authenticity validation and datastore;
an OVE validation for user ownership and authenticity validation and datastore;
an OVE issuance of ownership and authenticity certificates;
an intelligence service by which an end product is created;
an intelligent network interface and services bridge events tracking and logging system;
an intelligent network interface and service bridge for dynamic and interactive biometric signal services.
an intelligent network interface with ownership rights validation controllers and stores;
an intelligent network interface with dynamic pluggable and programmable biometric signal modules;
a privacy protected service bridge with OVE rights and validation stores;
a privacy protected service bridge with dynamic pluggable and programmable service gateways;
an OVE API for integration of intelligent network interface and services bridge authentication and authorization systems or services with or without a physical interface;
any combination with OVE thereof.

8. The intelligent network interface and service bridge user devices of claim 7, the intelligent network interface, services bridge and API can or are configured to:
multi-modal biometric bi-directional signaling including but not limited to: visual;
audible; haptic; olfactory; phonetic; signals; waves; and other sensory validation of any OVE registered types;
generate at least one of visual, audible, haptic, olfactory and other neural or haptic biometric signals types and modalities feedback;
process detectable biometric signals and waves variance in frequencies facilitating mapping or capturing or signatures of biometric feedback signals;
alter the biometric signal data with metadata from other sensors and data sources;
alter the feedback with the metadata from the other sensors and data sources;
synchronize bio-signals from multiple sensors with a real-time clock;
stimulate user's bio feedback wherein the stimulating includes bio feedback confirmation;
optimize graph and vector database ad hoc polymorphic datastores programming modes and models for biometric signals interactive feedback data;
optimize polyglot and polymorphic ad hoc models and schemas;
access OVE system, user and service provider models, modules and templates in a distributed computing environment (“DCE”) or distributed data file system (“DDFS”) datastore;
enable interactive user agent signaling and articulator feedback with multi-channel modalities;
secure wearable, IoT, and cloud communications in any form including peripheral cellular; bluetooth; Wifi; and NFC;
secure wearable, IoT, and cloud biometric send and receive OVE validation in any form including cellular; bluetooth; Wifi; and NFC;
secure OVE network communications in any form or type including but not limited to: cellular; bluetooth; Wifi; and NFC;
secure OVE cellular; bluetooth; Wifi; and NFC biometric send and receive validation;
any combination with OVE thereof.

9. The intelligent network interface and services bridge of claim 8, wherein the services bridge user devices use threshold metrics comprising of:
multi-modal input and output;
bio-signals feedback loops;
biometric signal settings;
service bridge settings;
output view and interactive multi-modal display;
data points attributes and metrics including but not limited to:
timestamp in the data point of indexes with default searchable at second-by-second, sub or milli, nanosecond precision with additional value based on host, source, and sourcetype;
metric name, numeric value, measurement, dimensions and metadata fields that provide information about the measurements of host, source, and sourcetype;
application-specific metrics including but not limited to: timers that measure performance of a function, service or application;
a collection framework to ingest high-volume metrics including but not limited to: network daemons, APIs and any agent to deliver service or output;
a method to transform event data into metric data at indexing time using but not limited to ingestion pipeline to transform data at indexing protocols for structured metrics including log-to-metrics functionality for event data into metrics data as it is ingested and indexed to conform but limited to dynamic and programmable: cloud-fog-node IoT networks; virtual networks functions; source, hosts and network daemons.
A method to search and report commands to filter, aggregate and report metrics data;
a framework to convert event data into metric data at search and system query time including streaming events;
visualization functions to display interactive output;
interference functions to display interactive output;
a framework to measuring services for hosts, networks, devices and sensors; system components, wireless and wired data and traffic.
any combination with OVE thereof.

10. The intelligent network interface and services bridge of claim 9, wherein the interactive biometric signals and feedback systems provide autonomous feedback and adjustment of creative and productive work using dynamic and programmable physiological and psychological biometric signals assistive and user input feedback adjustment biometric signals to registered time data biometric slices of time and store for local learning and training including in shared data and computing store for the integration of intelligent services and user biometric signals.

11. The intelligent network interface and services bridge user device apparatus of claim 10, wherein augmented outcome or output is derived from the shared datastore and computing environment interaction including user and service provider combine with learning and training data within the knowledge base circuit or cloud based storage containers of one or more devices used to generate individualized executable categorized classifier biometric signal streams updates onto at least one or more intelligent network interface or service bridge remote storage, or the mobile computing device via at least one or more of wireless connection and a wired connection between the network and a interface or bridge storage for online and offline usage with or without network dependencies including for ad hoc polymorphic graph or vector database optimization.

12. The intelligent network interface and services bridge of claim 11 wherein one or more processors of bio-signal feedback channels use a visual, audible, haptic, olfactory and other biometric signal types from multiple sources to deliver dynamic interactive biometric data for services to users and user agents.

13. The intelligent network interface and service bridge of claim 12 wherein the application or module by which the service is requested and processed uses a intelligent network interface, services bridge or authentication and authorization API service integration and gateway thereof.

14. The intelligent network interface and service bridge of claim 13 wherein multiple dynamic modules and applications are managing multiple biometric bio-signal channels and types from multiple sources including peripheral, IoT, phonetic, waves and other forms including biometric networks thereof.

15. The intelligent network interface and service bridge of claim 14, wherein the intelligent network interface, services bridge or API can or is configured by the services bridge and services gateways applications and modules to:
generate an OVE biometric origin timestamp recorded profile and update in the protected datastores of OVE upon device and biometric signal capture;
utilize a biometric signal auto-tuning dynamic noise reducer, signature extractor, and categorizer including for ad hoc polymorphic graph and vector database optimization such as signal or data conditioning;
utilize a bio-signal auto-tuning dynamic noise reducer, a biometric signature extractor, and a categorizer including polyglot polymorphic and ad hoc polymorphic database optimization;
create a pipeline for training data input into the service providers knowledgebase;
deliver a service bridge evaluation process for recognizing biometric signal patterns that are leveraged and shared with the service bridge stores and knowledgebases for user device biometric signals service in the service bridge shared datastore and computing environment;
deliver personalized and optimized neural bio-signals and services data for resource constrained devices (RCDs);
provide interactive sensor signaling and articulator feedback modalities for user agents including artificial, virtual, robotic, environmental, quantum, and AI;
utilize machine learning storage models for shared pattern recognition, classification and personalization that operates while the intelligent network interface and services bridge are not connected to a network, with machine learning acting as one or more of an auto-tuning dynamic noise reducer, a biometric signature extractor and a categorizer and classifier including for graph or vector database optimization;
utilize machine learning storage models for shared pattern recognition, classification and personalization that records events and activity in the shared datastore and computing environment while the intelligent network interface and services bridge are connected to a network, with machine learning acting as one or more of an auto-tuning dynamic noise reducer, a biometric signature extractor and a categorizer and classifier including for polyglot and ad hoc graph or vector database optimization;
use registered service bridge data store and registered devices for training and learning data with biometric signal integration
use machine learning training data applied when the intelligent network interface and service bridge is connected to the network to create an individualized categorization and classifier for shared data and computing environments including for polyglot and ad hoc graph and vector database optimization;
use derived outputs of an machine learning training being stored in a shared knowledge base and cloud storage or on a mobile computing device having at least one of a wireless connection and a wired connection and within wireless network range including for ad hoc polymorphic graph or vector database optimization;
any combination with OVE thereof.

16. The OVE validated object of claim 2 wherein OVE with or without the intelligent network interface and services bridge services can be configured for content with services including but not limited to:
OVE validated and authenticated intelligent OVE validated objects for OVE operational models and modules;
OVE validated objects is an intelligent model architecture of modules for network or storage containers and intelligent service types;
multi-modal biometric validations including but not limited to: visual; audible; haptic; olfactory; phonetic; signals; waves; and other sensory validation of any OVE registered type;
descriptive framework for special OVE validation objects or tokens definitions including content type and terms of use;
intelligent model definition and macros for any type of micro, macro, corporate or enterprise system;
protected scripts and models storage within OVE Distributed Datastore File System (DDFS) using unique CID identifiers;
DDFS links to special objects content or token claims;
macros or scripts for but not limited to: Intelligent Service Agent Providers (ISAP); Software as a Service (SaaS); Platform as a Service (PaaS); Infrastructure as a Service (IaaS) and other service and service provider models;
coding or intelligence models including but are not limited to: applications; script; extensions; custom IDE; custom SDK; custom API; algorithms and other coding models and environments including automated AI.
OVE validated and authenticated OVE validated objects for OVE operational models and modules;
OVE validated and authenticated objects with DLT registration;
any combination with OVE thereof.

17. An intelligent network interface session and access controls of claim 4 comprising of:
OVE validated users only in OVE secure networks;
OVE validated systems and devices only in OVE secure networks;
multi-modal multi-profile multi-device capabilities;
biological classification and taxonomy analysis with phenotype;
processing and transport detection;
signaling and detection phenomena directories;
scoring and threat protection;
threats attributes knowledgebase and classification engine;
shared threat detection databases;
secure wearable, IoT, and cloud communications in any form including peripheral cellular; bluetooth; Wifi; and NFC;
secure wearable, IoT, and cloud biometric send and receive OVE validation in any form including cellular; bluetooth; Wifi; and NFC;
secure OVE network communications in any form or type including but not limited to: cellular; bluetooth; Wifi; and NFC;
secure OVE cellular; bluetooth; Wifi; and NFC biometric send and receive validation;
any combination with OVE thereof.
